(19) United States
(12) Patent Application Publication
(10) Pub. No.: US 2008/0162377 A1
(43) Pub. Date: Jul. 3, 2008

(54) System and method of managing cash and suggesting transactions in a multi-strategy portfolio

(75) Inventor: Gad Pinkas, Ganei Tikva (IL)

Correspondence Address: OLIFF & BERRIDGE, PLC, P.O. BOX 320850, ALEXANDRIA, VA, 22320-4850, US

(73) Assignee: VESTWISE LLC, Chesterfield, MO (US)

(21) Appl. No.: 12/003,030

(22) Filed: Dec. 19, 2007

Related U.S. Application Data
(63) Continuation-in-part of application No. PCT/IL2006/001461, filed on Dec. 19, 2006.
(60) Provisional application No. 60/751,402, filed on Dec. 19, 2005.

(51) Int. Cl. G06Q 40/00

(52) U.S. Cl. 705/36 R

(57) ABSTRACT

According to some embodiments of the present invention, there is provided a system for managing an investment portfolio that is associated with at least two investment strategies, at least one of the investment strategies providing a strategy change in respect of a non-cash position by explicitly or implicitly specifying a recommended change value for the non-cash position, the system comprising: a portfolio management processor, the portfolio management processor is responsive to the strategy change in respect of the non-cash position for calculating a cash allocation for a cash position of an investment strategy providing the change, wherein the cash allocation is based upon: a recommended relative weight for the cash position, the relative weight is provided explicitly or implicitly by the investment strategy providing the change, a relative weight of at least one other cash position, the relative weight is provided explicitly or implicitly by at least one other investment strategy with which the investment portfolio is associated, a specified proportion between the two or more investment strategies with which the investment portfolio is associated, and a value of a cash holding within the investment portfolio; and the portfolio management processor is further responsive to the investment strategy providing the change for calculating a suggested transaction based upon the change value specified explicitly or implicitly by the strategy providing the change in respect of the non-cash position, and based upon the cash allocation calculated for the cash position of the investment strategy providing the change.

### CROSS REFERENCE TO RELATED APPLICATIONS

The invention is a Continuation in Part of PCT application IL2006/01461 which claims the benefit of U.S. Provisional Patent Application Ser. No. 60/751,402, filed Dec. 19, 2005, entitled “An automated personalized money manager”, which are hereby incorporated by reference.

### FIELD OF THE INVENTION

This invention relates to a personalized system and method of computerized management of multi-strategy investment portfolios.

### BACKGROUND OF THE INVENTION

Currently the process of delivering personalized and holistic investment advice to individual investors is not fully automated and frequently requires the assistance of human professionals. Therefore, the process is typically costly and thus unaffordable to many. In addition, methods for managing portfolios of assets using multiple investment strategies (e.g. strategies issued by multiple experts) tend to become imbalanced over time and may require periodic adjustments or rebalancing to keep relative proportions of strategies or experts and position weights as required or as requested. Imbalances related to actual holdings kept in a portfolio and ideal position or strategy weights which are recommended may develop as the market value of certain assets positions changes and becomes different from the recommended values for those positions. Similarly the proportion among market values actually allocated to certain strategies may differ from the recommended ideal proportions for those strategies. Such portfolio imbalances that may develop over time, may interfere with an investor's goals and objectives and affect the portfolio risk to its detriment. The required rebalancing actions may be complex and costly. In addition, current systems which support portfolios with multiple experts' advice or multiple model portfolios do not handle cash intelligently and are largely not adapted to optimize realistic and common scenarios where cash is either scarce or in abundance and where several cash positions are recommended by more than one strategy. This includes for example, the automatic allocation of cash for the purpose of opening a position or adding to it, the generation of cash upon certain criteria and the use of certain cash amounts for re-investing.

The use of investment strategies is common in today's world of financial management. Specifically, investment advisory publications such as newsletters, research publications and investment alert services, provide impersonalized investment recommendations. Investors typically subscribe to these services and are updated from time to time regarding new recommendations and changes to previously recommended positions. Some of these services provide model portfolios that contain specific securities and recommended weights, while some provide their advice in a form that may be translated into such a model portfolio. Others may be ambiguous and lack clarity on how to interpret the recommendation.

Examples of well-known such publications include “Value Line Investment Survey” (by Value Line, Inc., New York, N.Y.), “The Chartist Newsletter” (By Chartist, Inc., Seal Beach, Calif.) and others. Certain strategies are based on an algorithm and use a computerized system that generates “Buy” and “Sell” recommendations (sometimes referred to as signals or alerts); yet, they provide a similar function to non-algorithmic strategies. There are several web-sites which publish model portfolios provided by professional and non-professional individuals and institutions.

Some strategies have provided good and consistent risk-adjusted performance over many years; yet, they are not at all personalized, their risk is typically not fully disclosed, and their recommendations may be unclear and imprecise. In addition, there is the problem of how to plan the use of such strategies, how to interpret their recommendations in respect of the investor's financial status, goals and existing positions, how to work with several strategies at the same time (possibly in the same account or across several accounts) and how to implement a recommendation in a cost-effective way, across multiple accounts, multiple financial institutions, while considering taxes, fees, commissions, other implemented strategies, multiple cash recommendations, etc.

Certain advice publishers (mainly alert services for options and futures) provide their advice directly to certain brokerage institutions. An investor gives permission to an institution to trade according to the publisher recommendation and provides some instructions as to the dollar value or number of units each transaction should use. This feature is typically called “auto-trading” and is subject to most of the problems discussed previously. Mainly, the shortcomings include lack of “true” personalization, interaction with more than one strategy, imbalances evolving over time, and lack of a system or method to intelligently allocate or generate cash for the recommended transactions or for dealing with various cash availability scenarios.

Certain service providers (e.g. FOLIOfn, Inc., Vienna, Va.) provide a service that allows buying or selling an entire basket of securities as if it were a mutual find. When purchasing a basket, an amount of money is allocated by the investor for the purchase. The securities in the model portfolio of the basket are bought in proportions that roughly match the weights of the positions in the model portfolio of the basket. Basket management is done in a way that is unrelated to other baskets within the portfolio. As a result, proportions among baskets and among positions within a basket may change significantly over time and investors may be required to adjust their portfolios to keep proportions as required. Basket management systems typically do not implement a “holistic” perspective over the many aspects of a portfolio, do not intelligently allocate or generate cash for coping with various cash availability scenarios, need periodic re-adjustments (e.g., when basket proportions or position proportions are to be kept) and in general are automatic to a substantially limited degree, if at all.

A few other systems (e.g. Schwab Managed Portfolios—by Charles Schwab & co, Inc, San Francisco, Calif.), go beyond planning of asset allocation and suggest an implementation to support the planned asset allocation by purchasing certain investment products (e.g. mutual/index funds, or ETFs). These tools do not support multiple proportional strategies, nor do they support “active” recommendations for buying or selling of securities.

US Patent Application Publication No. 2004/0128219 to Hilton discloses a computer implemented method, a program product and a system which determine a plan for disposing of assets in a given asset portfolio using a genetic algorithm which operates to satisfy certain objectives, including generation of a cash amount. Further according to Hilton, a genome population including a number of vectors is generated. The genome population is modified using a genetic algorithm, until at least one vector represents a change in the percentage of each asset such that the disposition of each asset in accordance with the vector most nearly satisfies one or more objectives. Hilton recognizes the enormous size of the search space while suggesting a solution that is based on a genetic algorithm.

### SUMMARY OF THE INVENTION

According to some embodiments of the present invention, there is provided a system for managing an investment portfolio that is associated with at least two investment strategies, at least one of said investment strategies providing a strategy change in respect of a non-cash position by explicitly or implicitly specifying a recommended change value for the non-cash position, said system comprising:
a portfolio management processor, said portfolio management processor is responsive to said strategy change in respect of said non-cash position for calculating a cash allocation for a cash position of an investment strategy providing said change, wherein said cash allocation is based upon:
   a recommended relative weight for said cash position, said relative weight is provided explicitly or implicitly by said investment strategy providing said change,
   a relative weight of at least one other cash position, said relative weight is provided explicitly or implicitly by at least one other investment strategy with which said investment portfolio is associated,
   a specified proportion between said two or more investment strategies with which said investment portfolio is associated, and
   a value of a cash holding within said investment portfolio; and
said portfolio management processor is further responsive to said investment strategy providing said change for calculating a suggested transaction based upon said change value specified explicitly or implicitly by said strategy providing said change in respect of said non-cash position, and based upon said cash allocation calculated for said cash position of said investment strategy providing said change.

According to some embodiments of the present invention, there is further provided a method of managing an investment portfolio that is associated with at least two investment strategies, at least one of said investment strategies providing a strategy change in respect of a non-cash position by explicitly or implicitly specifying a recommended change value for the non-cash position, said method comprising:
receiving a notification regarding said strategy change;
calculating a cash allocation for a cash position of an investment strategy providing said change, wherein said cash allocation is based upon:
   a recommended relative weight for said cash position, said relative weight is provided explicitly or implicitly by said investment strategy providing said change,
   a relative weight of at least one other cash position, said relative weight is provided explicitly or implicitly by at least one other investment strategy with which said investment portfolio is associated,
   a specified proportion between said two or more investment strategies with which said investment portfolio is associated, and
   a value of a cash holding within said investment portfolio; and
calculating a suggested transaction based upon said change value specified explicitly or implicitly by said strategy providing said change in respect of said non-cash position, and based upon said cash allocation calculated for said cash position of said investment strategy providing said change.

According to some embodiments of the present invention, there is still further provided a program storage device readable by machine, tangibly embodying a program of instructions executable by the machine to perform a method of managing an investment portfolio that is associated with at least two investment strategies, at least one of said investment strategies providing a strategy change in respect of a non-cash position by explicitly or implicitly specifying a recommended change value for the non-cash position, said method comprising:
receiving a notification regarding said strategy change;
calculating a cash allocation for a cash position of an investment strategy providing said change, wherein said cash allocation is based upon:
   a recommended relative weight for said cash position, said relative weight is provided explicitly or implicitly by said investment strategy providing said change,
   a relative weight of at least one other cash position, said relative weight is provided explicitly or implicitly by at least one other investment strategy with which said investment portfolio is associated,
   a specified proportion between said two or more investment strategies with which said investment portfolio is associated, and
   a value of a cash holding within said investment portfolio; and
calculating a suggested transaction based upon said change value specified explicitly or implicitly by said strategy providing said change in respect of said non-cash position, and based upon said cash allocation calculated for said cash position of said investment strategy providing said change.

According to some embodiments of the present invention, there is still further provided a computer program product comprising a computer useable medium having computer readable program code embodied therein of managing an investment portfolio that is associated with at least two investment strategies, at least one of said investment strategies providing a strategy change in respect of a non-cash position by explicitly or implicitly specifying a recommended change value for the non-cash position, said computer program product comprising:
computer readable program code for causing the computer to receive a notification regarding said strategy change;
computer readable program code for causing the computer to calculate a cash allocation for a cash position of an investment strategy providing said change, wherein said cash allocation is based upon:
   a recommended relative weight for said cash position, said relative weight is provided explicitly or implicitly by said investment strategy providing said change,
   a relative weight of at least one other cash position, said relative weight is provided explicitly or implicitly by at least one other investment strategy with which said investment portfolio is associated,
   a specified proportion between said two or more investment strategies with which said investment portfolio is associated, and
   a value of a cash holding within said investment portfolio; and
computer readable program code for causing the computer to calculate a suggested transaction based upon said change value specified explicitly or implicitly by said strategy providing said change in respect of said non-cash position, and based upon said cash allocation calculated for said cash position of said investment strategy providing said change.

According to some embodiments of the present invention, there is further provided a computer system for determining an optimal asset selling or buying vector in respect of assets within an investment portfolio that is associated with a plurality of investment strategies according to a predefined proportion between the strategies, and each one of the plurality investment strategies providing explicitly or implicitly a recommended relative weight with respect to cash and/or non-cash positions, said system comprising:
a cash generating or reinvesting module adapted to obtain each one of the following:
   an ideal value for each one of a plurality of positions recommended by at least one of said plurality of strategies, said ideal value is calculated based upon: a recommended relative weight for its respective position as provided explicitly or implicitly by at least one of said plurality of strategies and said predefined proportion between said plurality of strategies;
   a needed cash amount for either cash generation or reinvesting;
      an optimizer adapted to:
provide an objective function for scoring an asset selling or buying vector, said objective function is sensitive to a degree by which selling or buying transactions denoted by an asset selling or buying vector affect differences between actual values of a plurality of positions recommended by at least one of said plurality of strategies and corresponding ideal values of said plurality of positions, said objective function inducing an order relation which denotes a relationship between a set of possible asset selling or buying vectors according to their corresponding scores;
generate according to a predefined vector generation procedure one or more asset selling or buying vectors, each denoting one or more selling or buying transactions that if executed are estimated to generate or expend a total amount of cash which approximately matches said needed cash amount;
implement with respect of each generated asset selling or buying vector, a vector scoring and evaluation sequence, comprising:
   calculate effects of selling or buying transactions denoted by said vector on asset holdings within said portfolio, to thereby provide an updated estimated value for said asset holdings;
   compute an estimated actual value for each one of a plurality of positions recommended by at least one of said plurality of strategies, said estimated actual value for each one of said plurality of said plurality of positions is based at least on an estimated value for an asset holding associated with said position;
   compute differences between said actual values of said plurality of positions and corresponding ideal values of said plurality of positions;
   compute an overall score for that vector based on said predefined objective function;
   determine according to said order relation whether that vector is better than any previously generated vector, and if that vector is better than any
      previously generated vector designate that vector and its overall score as best; and
said optimizer is adapted to determine whether a stop criterion is met, wherein in case said stop criterion is met, data related to an asset selling or buying vector designated as best is provided as output, and in case said stop criterion is not met, said optimizer is adapted to generate at least one more new asset selling or buying vector according to said predefined vector generation procedure and to repeat said vector scoring and evaluation sequence with respect to said new vector.

According to some embodiments of the present invention, there is even further provided a method of determining an optimal asset selling or buying vector in respect of assets within an investment portfolio that is associated with a plurality of investment strategies according to a predefined proportion between the strategies, and each one of the plurality investment strategies providing explicitly or implicitly a recommended relative weight with respect to cash and/or non-cash positions, said method comprising:
obtaining each one of the following:
   an ideal value for each one of a plurality of positions recommended by at least one of said plurality of strategies, said ideal value is calculated based upon: a recommended relative weight for its respective position as provided explicitly or implicitly by at least one of said plurality of strategies and said predefined proportion between said plurality of strategies;
   a needed cash amount for either cash generation or reinvesting;
providing an objective function for scoring an asset selling or buying vector, said objective function is sensitive to a degree by which selling or buying transactions denoted by an asset selling or buying vector affect differences between actual values of a plurality of positions recommended by at least one of said plurality of strategies and corresponding ideal values of said plurality of positions, said objective function inducing an order relation which denotes a relationship between a set of possible asset selling or buying vectors according to their corresponding scores;
   generating according to a predefined vector generation procedure one or more asset selling or buying vectors, each denoting one or more selling or buying transactions that if executed are estimated to generate or expend a total amount of cash which approximately matches said needed cash amount;
implementing with respect of each generated asset selling or buying vector, a vector scoring and evaluation sequence, comprising:
   calculating effects of selling or buying transactions denoted by said vector on asset holdings within said portfolio, to thereby provide an updated estimated value for said asset holdings;
   computing an estimated actual value for each one of a plurality of positions recommended by at least one of said plurality of strategies, said estimated actual value for each one of said plurality of said plurality of positions is based at least on an estimated value for an asset holding associated with said position;
   computing differences between said actual values of said plurality of positions and corresponding ideal values of said plurality of positions;
   computing an overall score for that vector based on said predefined objective function;
   determining according to said order relation whether that vector is better than any previously generated vector, and if that vector is better than any previously generated vector designate that vector and its overall score as best; and
determining whether a stop criterion is met, wherein in case said stop criterion is met, providing data related to an asset selling or buying vector designated as best as output, and in case said stop criterion is not met, generating at least one more new asset selling or buying vector according to said predefined vector generation procedure and repeating said vector scoring and evaluation sequence with respect to said new vector.

According to some embodiments of the present invention, there is still further provided a program storage device readable by machine, tangibly embodying a program of instructions executable by the machine to perform a method of determining an optimal asset selling or buying vector in respect of assets within an investment portfolio that is associated with a plurality of investment strategies according to a predefined proportion between the strategies, and each one of the plurality investment strategies providing explicitly or implicitly a recommended relative weight with respect to cash and/or non-cash positions, said method comprising:
obtaining each one of the following:
   an ideal value for each one of a plurality of positions recommended by at least one of said plurality of strategies, said ideal value is calculated based upon: a recommended relative weight for its respective position as provided explicitly or implicitly by at least one of said plurality of strategies and said predefined proportion between said plurality of strategies;
   a needed cash amount for either cash generation or reinvesting;
providing an objective function for scoring an asset selling or buying vector, said objective function is sensitive to a degree by which selling or buying transactions denoted by an asset selling or buying vector affect differences between actual values of a plurality of positions recommended by at least one of said plurality of strategies and corresponding ideal values of said plurality of positions, said objective function inducing an order relation which denotes a relationship between a set of possible asset selling or buying vectors according to their corresponding scores;
generating according to a predefined vector generation procedure one or more asset selling or buying vectors, each denoting one or more selling or buying transactions that if executed are estimated to generate or expend a total amount of cash which approximately matches said needed cash amount;
implementing with respect of each generated asset selling or buying vector, a vector scoring and evaluation sequence, comprising:
   calculating effects of selling or buying transactions denoted by said vector on asset holdings within said portfolio, to thereby provide an updated estimated value for said asset holdings;
   computing an estimated actual value for each one of a plurality of positions recommended by at least one of said plurality of strategies, said estimated
      actual value for each one of said plurality of said plurality of positions is based at least on an estimated value for an asset holding associated with said position;
computing differences between said actual values of said plurality of positions and corresponding ideal values of said plurality of positions;
computing an overall score for that vector based on said predefined objective function;
determining according to said order relation whether that vector is better than any previously generated vector, and if that vector is better than any previously generated vector designate that vector and its overall score as best; and
determining whether a stop criterion is met, wherein in case said stop criterion is met, providing data related to an asset selling or buying vector designated as best as output, and in case said stop criterion is not met, generating at least one more new asset selling or buying vector according to said predefined vector generation procedure and repeating said vector scoring and evaluation sequence with respect to said new vector.

According to some embodiments of the present invention, there is still further provided a computer program product comprising a computer useable medium having computer readable program code embodied therein of determining an optimal asset selling or buying vector in respect of assets within an investment portfolio that is associated with a plurality of investment strategies according to a predefined proportion between the strategies, and each one of the plurality investment strategies providing explicitly or implicitly a recommended relative weight with respect to cash and/or non-cash positions, said computer program product comprising:
computer readable program code for causing the computer to obtain each one of the following:
   an ideal value for each one of a plurality of positions recommended by at least one of said plurality of strategies, said ideal value is calculated based upon: a recommended relative weight for its respective position as provided explicitly or implicitly by at least one of said plurality of strategies and said predefined proportion between said plurality of strategies;
   a needed cash amount for either cash generation or reinvesting; computer readable program code for causing the computer to provide an objective function for scoring an asset selling or buying vector, said objective function is sensitive to a degree by which selling or buying transactions denoted by an asset selling or buying vector affect differences between actual values of a plurality of positions recommended by at least one of said plurality of strategies and corresponding ideal values of said plurality of positions, said objective function inducing an order relation which denotes a relationship between a set of possible asset selling or buying vectors according to their corresponding scores;
computer readable program code for causing the computer to generate according to a predefined vector generation procedure one or more asset selling or buying vectors, each denoting one or more selling or buying transactions that if executed are estimated to generate or expend a total amount of cash which approximately matches said needed cash amount;
computer readable program code for causing the computer to implement with respect of each generated asset selling or buying vector, a vector scoring and evaluation sequence, comprising:
   computer readable program code for causing the computer to calculate effects of selling or buying transactions denoted by said vector on asset holdings within said portfolio, to thereby provide an updated estimated value for said asset holdings;
   computer readable program code for causing the computer to compute an estimated actual value for each one of a plurality of positions recommended by at least one of said plurality of strategies, said estimated actual value for each one of said plurality of said plurality of positions is based at least on an estimated value for an asset holding associated with said position;
   computer readable program code for causing the computer to compute differences between said actual values of said plurality of positions and corresponding ideal values of said plurality of positions;
   computer readable program code for causing the computer to compute an overall score for that vector based on said predefined objective function;
   computer readable program code for causing the computer to determine according to said order relation whether that vector is better than any previously generated vector, and if that vector is better than any previously generated vector designate that vector and its overall score as best; and
computer readable program code for causing the computer to determine whether a stop criterion is met, wherein in case said stop criterion is met, providing data related to an asset selling or buying vector designated as best as output, and in case said stop criterion is not met, generating at least one more new asset selling or buying vector according to said predefined vector generation procedure and repeating said vector scoring and evaluation sequence with respect to said new vector.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic representation of the Multi-Strategy Portfolio Management System, according to some embodiments of the invention;

FIG. 2 is a flow chart illustration of a method of allocating cash and providing a suggested transaction within a multi-strategy (two or more) investment portfolio(s), wherein a change in respect of a non-cash position provided by at least one of the strategies, includes implicitly or explicitly specifying a recommended relative weight for the non-cash position;

FIG. 3 is a flow chart illustration of a method of allocating cash and providing a suggested transaction within a multi-strategy (two or more) investment portfolio(s), wherein a change at least in respect of a non-cash position provided by at least one of the strategies, includes, explicitly or implicitly, specifying a portion of available cash that is to be used for buying the non-cash position;

FIG. 4 is a flowchart illustration of a method of providing a suggested transaction in a multi-strategy (two or more strategies) investment portfolio, each strategy providing recommended cash and non-cash positions and wherein a change provided by at least one of the strategies provides explicit or implicit relative weights in respect of non-cash positions which are consistent at least with a recommendation to sell a first non-cash position and with a recommendation to buy a second non-cash position;

FIG. 5 is a flowchart illustration of some aspects of a method of providing a suggested transaction for a multi-strategy investment portfolio wherein at least one of the positions is defined as being a reinvestment (hereinafter also “RI”) position;

FIG. 6 is a flow diagram illustration of a method of calculating an actual value of a first non-cash position in a multi-strategy portfolio, when there is at least a second non-cash position which relates to the same asset as the first non-cash position;

FIG. 7 is a block diagram illustration of a system for determining an asset selling vector in respect of an investment portfolio which is associated, according to a predefined proportion, with a plurality of investment strategies, and wherein each investment strategy provides explicitly or implicitly a recommended relative weight with respect to cash and/or non-cash positions, according to some embodiments of the invention;

FIG. 8 which is a flowchart illustration of a method of determining an asset selling (or buying) vector with respect to an investment portfolio which is associated with one or more investment strategies according to a predefined proportion between the strategies (in the case of plurality of strategies), each investment strategy providing explicitly or implicitly a recommended relative weight with respect to cash and/or non-cash positions, according to some embodiments of the invention;

FIG. 9 is a flowchart illustration of process of determining whether an amount of cash available in a portfolio is sufficient to carry out a suggested transaction, calculating the needed amount of cash and determining an asset selling vector denoting transactions that generates the needed cash, according to some embodiments of the invention;

FIG. 10 is a block diagram illustration of a cash generation or reinvestment optimizer for determining an optimal asset selling or buying vector, according to some embodiments of the invention; and

FIG. 11 a flow chart illustration of a local repair technique which may be implemented as part of an optimization method of determining an asset selling or buying vector for cash generation or for reinvestment with respect to an investment portfolio, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EXEMPLARY EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “generating”, “deciding”, “assigning” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Throughout the description, percentages are used to describe weights and proportions (terms which are discussed in detail below). It would be appreciated that unless explicitly stated otherwise, or if it is otherwise apparent from the text, the use of percentage, specifically with respect to weights and proportions, is made for convenience purposes. Any positive or negative numbers or figures may be used as a measure of, for example, weights and proportions, and the proportions among these numbers or figures may provide a measure which is substantially equivalent to percentages.

Throughout the description and the claims reference is made to the terms “sell” or “sell transaction” and “buy” or “buy transaction” and the like. It should be appreciated that the term “sell” or “sell transactions” may include short selling and the term “buy” or “buy transaction” may include buy to cover a short position. Furthermore, sometimes (depending on the context), the term “buy” may be used to mean opening of a new position (e.g. buy into a long position or short selling to open a new short position). Still further, in the same contexts, “sell” or “sell transactions” may be used in the meaning of closing a position (as in selling a long position or buying to cover a short position).

Some embodiments of the present invention relate to a method and system for computing a cash allocation and providing a suggested transaction in an investment portfolio that is associated with at least two investment strategies. According to the present invention, each of the strategies associated with the portfolio may provide explicitly or implicitly recommended cash and non-cash positions. According to some aspects of the invention, at least one of the strategies may provide a change in respect of a non-cash position by explicitly or implicitly specifying a recommended relative weight for the non-cash position. According to further aspects of the invention, at least one of the strategies may provide a change at least in respect of a non-cash position by explicitly or implicitly specifying a portion of available cash that is to be used for buying the non-cash position. According to still further embodiments of the invention, at least one of the strategies may provide recommendation at least in respect of a non-cash position by explicitly or implicitly specifying a portion of a strategy (or portion of a model portfolio) that is to be used for buying the non-cash position.

According to some aspects of the invention, under certain conditions, a needed cash amount may be calculated and transactions may be determined for the purpose of generating the needed amount of cash. Similarly, according to some aspects of the invention under certain conditions, a needed cash amount for reinvestment may be calculated and transactions may be determined for the purpose of re-investing or expending (consuming) a specific amount of cash (or an amount of cash that is substantially close to some other, specified explicitly or implicitly, amount of cash).

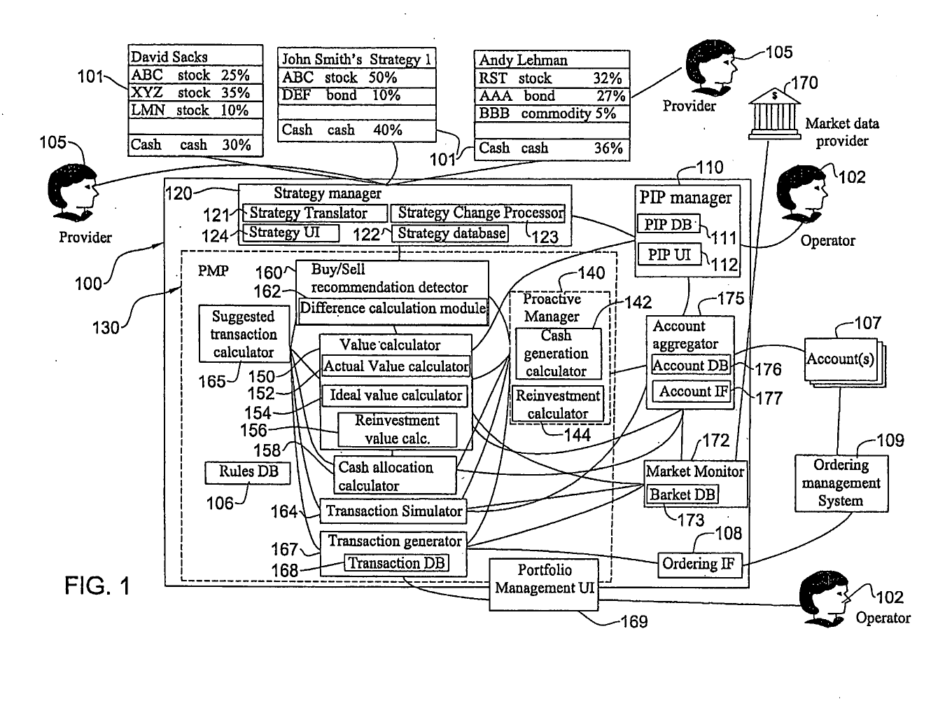

As mentioned above, the present invention relates to a Multi-Strategy Portfolio Management System (MSPMS). FIG. 1 is a schematic representation of the Multi-Strategy Portfolio Management system according to some embodiments of the invention.

The following are some definitions and concepts which are related to the present invention:

The system: the terms “the system” or MSPMS as specified herein refer to the Multi-Strategy Portfolio Management System.

Investment strategy or strategy: The term as used herein relates to a source of recommendations, typically impersonalized, for maintaining a portfolio or some portion of a portfolio. A strategy may provide explicitly or implicitly a recommendation for holding a certain position in respect of a certain asset. A strategy may also provide, explicitly or implicitly, recommendations for buying or selling a position in an asset or some portion thereof. Changes provided by or induced from a strategy are received by MSPMS and are processed to determine whether they are consistent with recommendations to buy or sell a position and may be further processed to suggest one or more transactions that implement the change. A strategy may issue a recommendation automatically, based on an algorithm, or based on human/expert decision making. A strategy may explicitly or implicitly recommend to buy or sell positions in an asset or some portion thereof or alternatively provide explicitly or implicitly a modified model portfolio (short: MP) consisting of a weighted list of positions in assets (or other strategies). These positions are sometimes referred to as being “associated with the strategy” or “provided explicitly or implicitly by the strategy”. New recommendations may be issued in a variety of forms and formats. The following are non-limiting examples of strategy changes and recommendations which may be induced explicitly or implicitly from a change in respect of a strategy (stock symbols such as IBM and specific percentages are provided as an illustration only):
1. Change the weight of IBM to 20%, use a limit of 30 when buying
2. Buy IBM using 20% of cash; target price is 30 and stop loss is 25
3. Add to IBM weight 10% of total portfolio
4. Sell 20% of the holdings in IBM, use a limit of 29
5. New Model Portfolio weights are: IBM: 300; DOX: 500, Cash: 700
6. New Model Portfolio: IBM 100 shares @ 70, DOX 200 shares @ 31
7. New portfolio holdings: IBM 1000 shares; DIS 8100 shares
8. Short IBM using 30% of portfolio but at least USD 5,000 (USD or $ are used herein to denote US Dollars)
9. Cover 50% of short position in IBM
10. Write 10 contracts of IBM-Dec2007 30C, limit USD 1.2
11. Hedge 20% of IBM position by buying IBM-Jan2008 Put with strike:30, limit USD 1.2
12. Buy IBM
13. Buy Either IBM or SUN using 10% of the portfolio
14. Buy 1000 shares of IBM
15. Sell 500 shares of IBM with a limit of 29
16. Hold 100% the EEM ETF (in the asset class of Emerging Markets)
17. Hold 20% TLT, 40% IVV and 10% EFA and 30% EEM; wherein EEM, TLT, IVV, EFA are examples of symbols of Exchange Traded funds (ETFs).

There is now provided a short description of some particular non-limiting examples of strategy types:
1. Model Portfolio (MP) Strategies: provide a list of assets with their relative weights. Certain MP strategies may express the relative weights by using percentage, number of shares or number of shares and a related price (e.g. historical purchased price) for each asset in the MP. As an example, real implemented investment portfolios may be used as model portfolios, where the number of units held, the cost of buying or the current market value of each asset position held may be used as a relative weight of that asset. Executed transactions, trade orders to buy or sell, and weight changes may be interpreted as changes to the model portfolio provided by the strategy.
2. Transactional Strategy: Provide changes in the form of transactions. As non-limiting examples: buy a certain asset using a portion of cash; buy an asset using a portion of the strategy/portfolio; sell a portion of a certain position.
3. Strategies of other strategies: A strategy of strategies recommends positions in other strategies. For example, a strategy may recommend a 20% position in strategy S1, a 10% position in strategy S2 and 70% position in cash. This is not to be confused with a portfolio that is associated with several strategies and their corresponding proportions. A strategy of strategies may be managed according to some embodiments as a regular strategy (e.g. Model Portfolio, transactional) which recommends positions provides changes and with which some model portfolio may be associated together with other strategies and in accordance with some proportion among the strategies.
4. Cash strategies: A cash strategy specifically recommends holding cash. It may issue recommendations for certain cash assets (e.g., money market instruments and/or products). A Cash strategy may assume the use of default cash equivalent instruments used within certain financial institutions.
5. Passive strategies: Passive strategies are strategies that recommend certain holdings and either rarely or never change them. This is in contrast to Active strategies which actively change their recommended positions. For example, each of the asset classes in an asset allocation based portfolio may be managed as a passive strategy which recommends holding positions in one or more assets (e.g., ETFs, index funds). In another example, a single strategy may recommend multiple proportional asset classes strategies wherein each asset class strategy recommends positions related to one or more such assets classes. It should be appreciated that all the above strategy types may be converted into a Model Portfolio (MP) by a person knowledgeable in the art.

Strategy provider: The term as used herein relates to an entity (e.g. person, company, computer software) which owns or publishes or manages a strategy. A strategy provider may issue changes or recommendations in respect of one or more strategies. Newsletters publishers, research institutions and investment alert services are well known examples of strategy providers. Other examples may be Registered Investment Advisors, investment gurus/experts, as well as non-professional individuals who may create, manage or publish a strategy and therefore are also considered strategy providers. A strategy provider may be an institution, an expert such as a professional asset/investment manager or an amateur. A strategy provider may or may not get compensation for their strategy recommendations/changes. Any user of MSPMS may decide to manage a self-strategy (or several of them), and become a strategy provider. Any strategy provider may use the strategy management services for herself/himself or may offer the services to others. A strategy provider may not be directly involved with managing recommendations using the Multi-Strategy Portfolio Management System (MSPMS) of the present invention. In this case, recommendations may be published independently and then converted to MSPMS formats by a human operator of the system or automatically using MSPMS computerized tools.

Investment Account (in short: account): An account is where a portfolio's holdings in assets are kept or tracked. As non-limiting examples, an account may be a bank account, a broker investment account, a checking account or a virtual account (holding a virtual portfolio and virtual cash). As a non-limiting example, an account has an account ID, actual holdings (cash and non-cash) and in some cases a log or data base of historical transactions which may be related to trades, cash movements, etc. An investor may have one or more accounts maintained in one or more financial institutions (e.g. broker/dealers, custodians). Some accounts are virtual entities that may hold assets and are possibly unrelated to any financial institute (e.g., an account holding a real estate property, an art collection, or collectable items). Each portfolio that is managed by the system may be associated with one or more accounts that may keep track of the asset holdings of the portfolio.

Investment portfolio: (in short: portfolio): According to the present invention a portfolio is a set of asset holdings by which one or several associated strategies may be bound together for the purpose of the coordinated management of the strategies in respect to predefined proportion (or weights) given to the different strategies with which the portfolio is associated. In some embodiments, a portfolio may also be associated with one or more investment accounts.

Assets: Goods or any item of value or commodity for which there exists a market (even small) for trading such goods. Assets typically may be evaluated for their market value. An asset includes but is not limited to any financial product or instrument (e.g. securities, equity, bonds, currencies, derivatives, mutual funds, index finds, Exchange-Traded Funds or notes (ETFs, ETNs), mortgages, insurance contracts/policies, loans, debts, real estate trusts, rights, structured products, etc.). An asset may also include non-instruments (e.g. an antique, art work, collectable items, real estate, energy capacity, telecommunication bandwidth, time sharing rights, club credits, club memberships, tickets, airline mileage, airline reservations, etc.). Buying or selling an asset includes opening a position in that asset or closing at least a part of that position. This includes opening a short position and closing part or the whole of that position.

Cash: The term as used herein, relates to a particular type of asset including cash or cash equivalent. Cash equivalents are low risk liquid assets that may be converted to cash in a relatively short period of time (e.g. Money Markets). In certain contexts, cash is also used herein as the available “Buying power”, which may be calculated based on some formula which may include for example: margin, credit, loans, cash and non-cash assets or collaterals of any kind, etc. “Buying power” may include marginal or non-marginal buying power.

Account holdings: Assets and their quantities which are held or tracked within an account. In some embodiments, information may be obtained for each such holding, including data that may be used to obtain or calculate the number of units (e.g. shares, contacts, pieces of art, etc . . . ) related to a holding, the market value of a unit held within the account and/or the market value of a holding.

Asset holding: (in short: holding): This term relates to a holding in a specific cash or non-cash asset which is included within an investment portfolio or recommended to be included within a portfolio. Typically, the asset holdings within a portfolio are derived, calculated or obtained from one or more account holdings that relate to the same asset and which are held in investment accounts with which the portfolio is associated. The (market) value of an asset holding is, according to some embodiments, calculated or obtained from the amount of units that correspond with the asset holding and the market value of each unit. The term portfolio holding is sometimes used as an equivalent to asset holding. Holdings within the context of a multi-account portfolio may be calculated in some embodiments by totaling of account holdings that correspond to the same asset across one or more accounts which are associated with a portfolio. A zero asset holding may be associated with a recommended position that has no related account holding.

Personal Investment Policy (PIP): The term as used herein, relates to a set of one or more strategies with pre-defined proportions with which a portfolio is associated. In an equivalent way, such strategies are sometimes described herein as being associated with a portfolio. Typically, the PIP is assigned by a user or advisor or alternatively is planned automatically or semi-automatically. Proportions are the relative values (e.g. percentage) corresponding to the strategies with which a portfolio is associated. Proportions represent the portion of the portfolio which is allocated for each strategy. As non-limiting examples, proportions may be expressed in the form of percentages (assigned to each strategy with which the portfolio is associated), ratio or relative weights. The PIP may contain in some embodiments, other personal information; for (non-limiting) example: the desired portfolio risk, (or investor's risk tolerance), financial goals, forecasts of expenses and income, expected retirement date, desired style of investment; preferred industries/sectors; industries, sectors or companies to exclude from the portfolio, etc.

Suggested Transactions (in short: transactions): Instructions made by MSPMS for buying or selling specific assets and their portions thereof. Some embodiments of the invention relate to the process of calculating at least one suggested transaction. The suggested transactions are issued after the portfolio has been analyzed in view of the PIP, position recommendations provided by strategies and the portfolio/account holdings. In some embodiments, suggested transactions are generated for the purpose of following or tracking recommendations and changes provided by one or more strategies. In some embodiments, suggested transactions are generated for the purpose of generating cash that is needed or for the purpose of re-investment of a certain cash amount in certain recommended positions. In some cases, suggested transactions may be executed as trades in an exchange or over the counter (OTC) or directly with market participants. Non-limiting examples of Suggested Transactions include (but are not limited to) security trading, buying, selling, short selling and buying to cover short positions, conditional transactions, and transactions scheduled for the future.

Operator/User: The term relates to any person who is authorized to use the system (i.e. MSPMS). The system may enable more than one operator/user for each portfolio or account. Typically the user is the investor or representative of the investor. The operator/user may also be an advisor or a portfolio or wealth manager who uses the system in tandem with or on behalf of the investor. In certain cases, the operator/user may be a computerized agent with abilities to act automatically as required from an operator/user. An operator/user may also be an administrator or a customer service representative.

### System Overview

Turning now to FIG. 1, there is shown a schematic representation of the Multi-Strategy Portfolio Management System, according to some embodiments of the invention. According to some embodiments, the Multi-Strategy Portfolio Management System (MSPMS) 100 of the present invention is a system for multi-strategy, portfolio management service. The system suggests personalized transactions for managing a portfolio, associated with one or more strategies, by processing the current actual portfolio holdings, the recommendations issued by the various investment strategies, market data and the Investor's Personal Investment Policy (PIP). It should be appreciated that in certain aspects of the present invention the MSPMS may be implemented in respect of a multi-strategy portfolio. A multi strategy portfolio is a portfolio which is associated with two or more strategies each may provide cash and non-cash recommended positions.

A strategy 101, on an on-going basis may issue strategy changes in respect of the strategy's cash or non-cash positions. According to some aspects of the invention a strategy change may provide at least one recommendation to buy or sell a position by, explicitly or implicitly, specifying modified recommended relative weights for the non-cash positions of the strategy 101. According to another aspect of the invention, a strategy change may provide at least one recommendation to buy a position by, explicitly or implicitly, designating a portion of the cash position for the recommended transaction, or provide at least one recommendation to sell a position by explicitly or implicitly designating a portion of the position for the recommended transaction. According to further aspects of the invention a strategy change may provide a recommendation to buy a position by explicitly or implicitly, specifying a portion of a strategy (in respect to its proportion in the portfolio) to be used in the transaction or provide a recommendation to sell an asset by explicitly or implicitly designating a portion of the position for the recommended transaction. In certain embodiments, a strategy may issue ambiguous recommendations which may be disambiguated by the system using disambiguating rules.

Based on the PIP, portfolio holdings, and market data and also based on the recommended positions received from the strategy or strategy providers 105, MSPMS 100 in its personalization process generates ongoing, suggested transactions, which in some embodiments are displayed for the convenience of the user. In certain embodiments, the suggested transactions are automatically sent for execution, while in other embodiments the suggested transactions are sent for execution after the explicit approval of the user. A change provided by a strategy, with which a portfolio is associated via the PIP, alerts MSPMS 100, and is analyzed to determine whether the change in strategy is consistent with a recommendation to buy or sell a portion of the holdings of the portfolio.

Triggered by a change in a strategy recommended position, MSPMS 100 personalizes the change by looking at the PIP information and considering changed and unchanged strategies with which the same portfolio is associated. In some embodiments of the present invention, the execution of the suggested transactions reduces the imbalances between recommended ideal positions and actual holdings; in some embodiments, MSPMS 100 allocates cash for transactions by considering recommended positions as calculated from the PIP and the strategy recommendations.

In certain embodiments, the MSPMS 100 does not only react to strategy recommendation changes; it also proactively generates suggested transactions such as for cash generating trades for obtaining a needed cash amount or reinvestment trades in order to consume cash that is allocated for re-investment. More specifically, in some embodiments MSPMS 100 suggests “sell” transactions so that the amount of cash in the portfolio (or in specific accounts) increases. As a non-limiting example, this additional cash may be needed for implementing a strategy recommendation (when cash is scarce), or as a way of generating monthly income upon retirement or to serve a specific user request for cash needed for certain expenditures. Similarly “buy” transactions are suggested while reducing (consuming, expending) a cash amount that is allocated for re-investing.

It should be appreciated that in some embodiments, the system supervises multiple (more than one) portfolios simultaneously. Each of the multiple portfolios may be associated with a PIP and also with one or more accounts 107. A PIP may be shared by several portfolios, but each portfolio is associated with only one PIP. In some embodiments of the invention, when a strategy change is detected, MSPMS searches for all portfolios associated with that strategy (according to the PIP associated with the portfolio) and applies the process of generating suggested transactions for each such portfolio based on its PIP. According to some embodiments the system may support multiple operators (i.e., users) 102 with multiple portfolios, providing each one with the full capacity of the system. In certain embodiments, multiple portfolios which typically belong to multiple users are maintained and stored in a data base 176, 111. As a non limiting example, the PIP Data Base (111) which stores strategies with which each portfolio is associated (in some embodiments, also the proportion between these strategies), is used by MSPMS for retrieving a portfolio which needs to be processed when an associated strategy provides a change. For clarity, the description detailed below mainly refers to embodiments implementing the system with one portfolio; however other embodiments using several portfolios may also be implemented.

According to certain embodiments of the invention, a change issued by one of the strategies associated with the investor's PIP alerts the Strategy Manager (SM) module 120. The SM 120 interfaces with the recommendation delivering media, transforms the recommendation into a uniform format (through Strategy translator 121), removes ambiguities if such exist using rules, updates the strategy DB 122 (through Strategy Change Processor 123) and alerts the Portfolio Management Processor (PMP) 130 for further processing of portfolios associated with the changed strategy by retrieving data from the PIP data base (111).

In certain embodiments, Strategy Providers 105 or Administrators may enter new recommendations by storing changes in the Strategy DB 122 (e.g., via a Strategy UI 124 component designed to view and/or change a model portfolio or to enter a new buy/sell recommendation, or via an Application Programmable interface—API). The SM 120 monitors various sources of strategy changes which may come in some embodiments through other communication channels (e.g. emails/messages from Strategy Providers 105; Strategy Web-sites; SMS, Instant Messaging, files, Data Bases, reports, etc.). In order to support various channels and formats, according to some embodiments of the invention, the SM 120 also contains a Strategy Translator (ST) 121 which translates various forms of a recommendation into a uniform representation which can then be further processed; e.g., the ST 121 may automatically analyze the syntax of certain formats of email messages that contain a recommendation and translates the message from its original format and syntax into a uniform form.

In certain embodiments of the invention, the SM 120 contains a Strategy Change Processor (SCP) 123 that calculates the effect of strategy changes on current recommendations, and updates the strategy DB 122 with the changes and their effect. By way of non-limiting example, an original email message may contain the text: “Enter a long Position on IBM using 20% of cash”. This message may be translated into another format: “Increase the weight of IBM by 10%” based on the position's previously stored relative weights. This translated recommendation may be used to further update the new relative weights in the strategy DB 122 (e.g. IBM 50%→60; Cash 50%→40%). It should be appreciated that the processing done by the SCP 123 does not regard the recommendation in view of the actual portfolio but rather considers the change in strategy in a way that is relevant to any portfolio. It should be appreciated that in some embodiments of the invention, the format obtained possibly after processing of the original change provided by a strategy is referred sometimes in this invention as “a change which is explicitly or implicitly provided by the strategy”. Similarly, the value (or values) associated with such a change (e.g., new weights, a portion of cash, a portion of a model portfolio, a portion of a strategy, etc.) is sometimes referred to herein as a “recommended change value” and such “recommended change value” may be explicitly or implicitly specified (or provided) by a strategy providing a strategy change.

It should be appreciated that in some embodiments of the invention, for convenience, a strategy is sometimes assumed to recommend (implicitly) a zero weight position to assets (e.g. securities) that are not explicitly recommended by it.

According to some embodiments of the invention, certain ambiguous recommendations become disambiguated by SCP 123 using certain rules. For example, when a recommendation may not be specific or clear regarding the percentage or weight of a new position; a disambiguating rule may assign a specific percentage (e.g., 10%) of available cash in the portfolio to such a new position. Another non-limiting example is when the recommendation provides several alternatives to assets bought. Disambiguating rules in some embodiments may involve taking the first choice or a random choice. In other embodiments, disambiguation may be done by a user or an administrator who is presented with alternatives and who is requested to select one of the suggested options.

In some embodiments, the Strategy Change Processor 123 notifies the portfolio management processor (PMP) 130 of any change in the strategies by alerting the Buy/Sell recommendation detector 160. In certain embodiments, multiple portfolios, which are obtained or calculated from account information (stored in the PIP DB 111), are associated with a PIP that refers to a strategy that has been changed. In these embodiments, the Strategy Change Processor 123 retrieves from the PIP DB 111 all the relevant portfolios and alerts the Buy/Sell recommendation detector module 160 regarding each portfolio.

In certain embodiments of the invention the SM 120 includes a user interface 124 which enables authorized administrators to add strategies to the strategy catalogue change or delete existing strategies.

According to certain embodiments of the invention the Buy/Sell recommendation detector within the PMP 130 detects a strategy change in respect of a position recommended by the strategy (through the SM 120) related to a certain portfolio and PIP.

In certain embodiments, an update in market information through the market monitor component 172 (e.g., large increase in a security price) may also signal a change which may be detected by the proactive manager 140 and which may trigger a proactive action (e.g. re-investing, cash generation, re-balancing or strategy change follow-up).

The PM processor 130 identifies which Buys and/or Sells are implied from the change and then calculates Buy/Sell suggested transactions. In certain embodiments, the suggested transactions are stored in the transaction DB 168. In certain embodiments they are displayed on the user via the portfolio management UI component 169 and are submitted for execution with or without a user's approval.

According to certain embodiments of the invention the PMP 130 comprises the following modules:
1. Buy/Sell recommendation detector 160—this module analyzes a strategy change in view of the portfolio holdings and decides which positions need to be bought or sold. In one non-limiting example the difference between the ideal value of a non-cash position and the actual value of that non-cash position is calculated and a recommendation to buy or sell is decided according to the position difference (sometimes referred to as just difference). In another non-limiting example, positive (>0) weight changes (of a non-cash positions) are interpreted as “buys” and negative weight changes are interpreted as “sells” regardless of the position difference between the actual position value (or holding) and the ideal value of the position recommended explicitly or implicitly by the strategy.
2. Difference calculating module 162—this module calculates the position differences between the ideal value of a non-cash position provided and the actual value of the non-cash position. The module uses values calculated by the value calculator.
3. Value calculator 150—this module may calculate the actual value of cash and non-cash positions in the portfolio, ideal values of cash and non-cash positions and the actual portfolio value based on the holdings in the account DB. This module also calculates the ideal transaction value. In certain embodiments, the ideal transaction value is based upon a recommended change value related to the strategy providing the change. For example in some embodiments it is based upon the difference between ideal value and actual value of the changed position or based upon a portion specified out of cash position. In some embodiments, the module also calculates the Re-Investment (RI) value based on the differences between ideal and actual values of non-cash reinvesting (RI) positions.
   i. Ideal value calculator 152: In some embodiments, this module calculates an ideal value of a recommended position within a strategy, based upon the portfolio value (or holdings), the proportions of the associated strategies (in PIP) and also based on the weight of the position in the strategy DB as determined by the Strategy Change Processor. According to a non-limiting example, the module may use the formula: Ideal value=Actual Portfolio market value*strategy proportion*Position relative weight. It should be appreciated that in some embodiments, an ideal value of zero is calculated for one or more positions associated with (or related to) portfolio holdings which are not recommended explicitly by the strategy.
   ii. Actual Value Calculator 154: This module calculates the actual value of a position recommended within a strategy based on the portfolio holding of the asset referenced by the position. In some embodiments, when two or more recommended positions in at least two different strategies are associated with the portfolio and recommend the same asset, the actual value of a position is calculated using a calculated ratio or proportion of values that correspond to the recommended positions. In some embodiments the calculated ratio (or proportion) is based on the ideal values of the recommending positions. In other embodiments, the ratio that is used is computed based on amounts specified in historical transactions which are related to each position. According to a non-limiting example, if two recommended positions recommend the same asset, the ratio that is used is between the total number of asset units purchased (but not sold) by past transactions which are related to first position and the total number of units purchased (but not sold) by past transactions related to the second position. It should be appreciated that in some embodiments of the invention, actual values of positions that have no corresponding asset holdings within the portfolio are assumed to be zero; as in a non limiting example, the actual value for a new position recommended (where no holding of the asset exists within the portfolio) is assumed to be zero.
   iii. RI value calculator 156: The module calculates the reinvestment (RI) value which in some embodiments is allocated for re-investing transactions, by considering the differences between ideal values of certain (RI) positions and the actual values of those positions. In other embodiments, other ways of allocating the RI value may be used as is described below. The calculated RI value may be used in some embodiments for reinvesting in certain (RI) positions in order to reduce imbalances between the ideal and actual values of those positions.
4. Cash allocation calculator 158—In some embodiments, this module calculates the actual cash allocation for the cash position of the changed strategy taking into account other cash positions which are recommended by other strategies. According to some embodiments, the amount to be allocated for reinvestment (RI Value) in the portfolio is also calculated and is used for cash allocation. This is done in order to take into account the amount of cash that should be dedicated for re-investment in certain (RI) positions, which show a disparity between ideal values and actual values. The module calculates the allocation for the cash position of the changed strategy in some embodiments based on the portfolio cash holding (from account DB 176), the ideal values of cash positions in strategies associated with the portfolio (PIP) and possibly in certain embodiments, the RI values (which are calculated by the value calculator 150).
5. Suggested Transaction calculator 165—This module calculates buy or sell suggested transactions according to the decision of the Buy/Sell recommendation detector 160. The module calculates “Sell” suggested transactions consistent with the recommended non-cash positions which were identified as “sell” (by the Buy/Sell recommendation Detector 160). In some embodiments of the invention, the module may also activate the transaction simulator 164 for calculating the effects of (simulating) the execution of the suggested transactions. This simulation may be necessary when more than one suggested transaction is generated and when one suggested transaction is dependent on a holding (e.g., cash) which is an outcome of the execution of another suggested transaction. The module also calculates “Buy” suggested transactions consistent with the recommended non-cash positions which were identified as “Buy” (by the Buy/Sell recommendation Detector), by taking into account the amount of allocated cash. In certain embodiments, ideal transaction is calculated based on the difference between ideal and actual value of the recommended non-cash position; yet, the suggested transaction is the minimum between the ideal transaction and the allocated cash. In another embodiment, a positive weight change of a non-cash position is interpreted as a request to buy a certain asset using a portion (e.g. 50%) of the allocated cash. Therefore, the suggested transaction is based on that portion of cash (e.g. 50%) for buying the asset. In some embodiments, the Suggested Transactions generated (whether buy or sell) are further processed by the Transaction Generator 167.
6. Transaction Simulator 164—In some embodiments of the invention, this module simulates or calculates the effect of executing a suggested transaction. The module simulates the change of the portfolio holdings which is the result of the execution of the suggested transaction. In addition, the module may also calculate in some embodiments, the relative weight updates according to the strategy change which are induced by the simulated transaction. This is done in order to enable later transactions to be generated on the basis of the updated portfolio holdings and strategy weights which are the result of simulating the execution of the transaction.
7. Transaction Generator (TG) 167—In some embodiments, this module translates a suggested transaction (both buys and sells) into a valid format that is executable (e.g. by trade systems), relates to specific accounts and complies with certain constraints. In some embodiments, The TR may search in the account DB 176 for accounts where the transaction or part of it is executable (considering the buying power, cash availability, tax implication, etc.). The module may then divide the suggested transaction into several transactions executed each in different accounts. In some embodiments, the TR 167 module may also translate a value of a transaction into a number of shares/units based on market data. In certain embodiments, the module checks for certain constraints such as minimal transaction size, minimal holding or broker compliance rules. In some embodiments, the TR may change the transaction so that constraints are satisfied. In certain embodiments, the TR stores the generated suggested transaction in the Transaction DB 168. In certain embodiments the TR sends transactions for execution via Ordering Interface.
8. Proactive manager 140—In some embodiments, this module decides whether to suggest cash generating transactions or whether to suggest transactions for re-investing in RI positions with ideal value greater than actual value. In certain embodiments, the module is triggered when strategy change consistent with a recommendation to buy or sell is detected. In some embodiments the module is triggered as a result of an account change or a significant market change. In some embodiments, the module decides whether to perform cash generation (and the needed amount) or re-investing based on pre-defined conditions and/or rules from the Rules DB 106. In some embodiments, the Proactive manager 140 decides whether to perform proactive cash generation as in the following non-limiting examples:
   i. When the amount of cash holding (in the portfolio or in a specific account) is less than a certain amount
   ii. (user request) When the user requests a certain cash amount,
   iii. (periodic income generation) When, at the beginning of each month, the cash holding in a certain account is below a certain threshold.
   iv. When a strategy change consistent with a buy is detected and not enough cash may be allocated to the changed strategy cash position.
Similarly, in certain embodiments, the proactive manager may decide that upon certain triggers (e.g. account change, market change strategy change, etc.) and/or when certain conditions hold (e.g., RI value is above a certain threshold) the re-investment calculator should be triggered in order to suggest transactions such that if executed, will buy into one or more positions with positive differences.
9. Cash Generation calculator 142—In some embodiments, this module is triggered when there is a need for adding a certain amount of cash. The module generates suggested sell transactions that, when executed, will add to the portfolio a certain (needed) amount of cash. The module searches for sells that will generate the needed cash amount (calculated by the Proactive manager 140) while minimizing or maximizing some objective function and satisfying certain constraints. According to a non-limiting example, the objective function, which is minimized (or maximized), is a function which estimates the cost associated with the selling transactions including the cost/profit of increasing/reducing differences between ideal value and actual value of some positions. The objective function for minimization or maximization includes factored score components (score elements) to be subsequently described in detail.
10. Reinvestment (RI) calculator 144—In some embodiments, this module generates one or more suggested transactions such that, if executed, these transactions use (or consume or expend) a certain amount of cash which is reserved for re-investment. If executed, these suggested transactions (e.g. buys or short selling) reduce some imbalances between ideal and actual positions values. In a similar way to the cash generation calculator, in certain embodiments, the RI calculator 144 may also search for buys that will minimize some cost function while satisfying certain constraints.
11. Ordering Interface—In some embodiments, generated transactions are submitted for execution via an external ordering management system 109, or directly submitted to an execution system. The ordering interface module 108, interfaces with such external systems and is capable of translating the generated transaction into a format that is valid within the target ordering or execution system. In some embodiments, the Ordering Interface module 108 submits the suggested transaction to an Ordering management system 109 of a financial institution (or an exchange).
12. Portfolio Management UI component (PMUI) 169—In some embodiments, generated transactions are displayed or reported for view by a user via a User Interface (UI) or report. In further other embodiments, the user can view a transaction, approve (or disapprove) it and send it for execution. In some embodiments, the user may also edit and correct a transaction before it is sent for execution.
13. Transaction DB 168—generated transactions or suggested transactions are stored in the transaction DB. In some embodiments, the DB 168 may include various versions of the transactions (e.g., before and after editing, suggested, transactions, generated transactions, orders submitted for execution, executed transactions etc.) and various status conditions (e.g., approved, disapproved, edited, executed, rejected, partially filled, etc.)
14. Rules DB 106—In some embodiments this DB contains rules that govern certain decisions and/or actions. The following are some non-limiting examples: Rules for deciding when to perform proactive actions (cash generation, reinvesting); rules for calculating the needed amount for cash generation, rules for deciding how to induce and translate formats of strategy recommendations, rules for disambiguating strategy recommendations, rules for deciding the type of cash allocation needed, rules for enforcing certain constraints, rules for generating candidate vectors for an optimization process, etc.

According to certain embodiments of the invention the MSPMS 100 uses a Market Monitor (MM) 172 to monitor assets that are relevant to portfolios and strategies managed within the system. This module interfaces with market data sources (e.g., quote servers) 170 and may update a market DB 173 with up-to-date relevant information such as a non-limiting example, security prices, stock splits, dividends, etc. In certain embodiments of the present invention the MSPMS 100 implements an Account Aggregation module 175. This module interfaces in some embodiments with one or more investment accounts 107 (possibly in multiple institutions), retrieves data related to asset holdings (e.g., cash, securities) and in some embodiments, retrieves also the history of executed transactions and current market data. In some embodiments of the invention, the Account aggregator 175 updates an Account DB 176 with the most updated account information. Multiple interfaces 177 using various methods (e.g., screen scrapping methods) may be implemented within the account aggregator 175 for accessing various financial institutions and the data retrieved may be transformed into a uniform representation. In certain embodiments, the account aggregation and/or market monitor module 172 may alert the PMP 130 regarding a change in account holdings which may cause a proactive action.

According to certain embodiments of the invention the MSPMS 100 includes a Personal Investment Policy Manager (PIP Manager) 110. The PIP Manager is a module containing a PIP data base (DB) 111 and possibly a PIP user-interface (PIP UI) 112.

According to one embodiment the PIP data includes references to a set of strategies with which a portfolio is associated and their respective proportions. These proportions are the desired relative values of each strategy within the portfolio. The PIP data for all portfolios is stored in a PIP Data Base (DB) 111 and is managed by the PIP Manager 110. According to another embodiment the PIP also includes user profile information (e.g., information about the investor's financial status, accounts, assets, future objectives, estimates regarding future expenses and future income, risk tolerance, etc.). In certain embodiments of the invention, the PIP is constructed by the user 102; the user 102 selects one or more strategies 101 from a catalogue of strategies and provides proportion within the portfolio for each selected strategy (e.g., ideal proportions of the strategies within a portfolio). According to certain embodiments of the invention, the PIP manager 110 module includes a PIP user-interface (UI) 112 component that allows the user to change the PIP data (e.g. change the allocation for each of the strategies within the PIP). According to some embodiments, the PIP UI 112 component also allows the user to modify the list of referenced strategies by selecting new strategies from a strategy catalogue. According to yet another embodiment, the PIP UI 112 also allows the user to enter and/or modify profile information.

As mentioned above, the present invention relates to a method and system for computing a cash allocation and providing a suggested transaction in an investment portfolio that is associated with at least two investment strategies. According to the present invention, each of the strategies associated with the portfolio may provide recommended cash and non-cash positions. According to some aspects of the invention, at least one of the strategies may provide a change in respect of a non-cash position by explicitly or implicitly specifying a recommended relative weight for the non-cash position. According to further aspects of the invention, at least one of the strategies may provide a change at least in respect of a non-cash position by explicitly or implicitly specifying a portion of available cash that is to be used for buying the non-cash position. According to still further embodiments of the invention, at least one of the strategies may provide recommendation at least in respect of a non-cash position by explicitly or implicitly specifying a portion of a strategy (or a portion of a model portfolio) that is to be used for buying the non-cash position.

Before discussing the details of the process of computing a cash allocation and providing a suggested transaction according to the present invention, a discussion is provided regarding different forms of recommendation which may be used by a strategy to update the positions recommended by the strategy. The form of the recommendation (or the interpretation of it) that is eventually used to compute a cash allocation and a suggested transaction in connection with the recommendation may influence, in some embodiments, the process that is used for computing the cash allocation and the suggested transaction and may also affect the results of the process, as will be described in greater detail below. As is explained in further detail below, it should be noted that according to some embodiments of the invention, the original form of recommendation provided by a strategy may be translated to another form and the translated recommendation may be used for calculating the cash allocation and the suggested transaction, rather than the recommendation in its original form.

It would be appreciated, that since a portfolio as used herein is associated with two or more strategies, a recommendation provided by a strategy may be evaluated in the context of the recommending strategy. Thus, a recommendation made by a strategy may be regarded as relating to a portion of the portfolio (i.e. portion of the strategy or portion of the model portfolio) that is specified for the recommending strategy rather than to the entire amount of cash included within or associated with the multi-strategy portfolio as a whole. Further details in respect of the proportions between the strategies within the portfolio are provided below.

As mentioned above, according to some aspects of the invention, in a multi-strategy portfolio, at least one of the strategies may provide a change in respect of a non-cash position by explicitly or implicitly specifying a recommended modified relative weight for the non-cash position. For example, as part of a change in respect of a non-cash position, the strategy may explicitly or implicitly provide a relative weight for the non-cash position after the change.

Typically, a relative weight of a position is a value representing a certain fraction of a model portfolio provided by a strategy. An explicit relative weight is provided when the strategy explicitly sets forth the recommended portion of a model portfolio provided by the strategy that is to be allocated for the position. Thus, a recommended relative weight for a non-cash position is explicit when as part of the recommendation there is provided a specific portion of a model portfolio which is recommended for being allocated to the non-cash position after the change. The recommended relative weight for the non-cash position may be used to compute a cash allocation and a suggested transaction, as will be discussed in further detail below.

For example, referring to Example 1 below, strategy S2, which is one of two strategies associated with portfolio P1, provides a change in respect of a DOX position (non-cash position) by explicitly specifying that the recommended portion that is to be allocated for the DOX position is to change to 50% of a model portfolio provided by strategy S2.

### Example 1

P1

| S1 (40%): | S2 (60%): |
|---|---|
| IBM: 50% | DOX: 30%→50% |
| Cash: 50% | DIS: 50% |
| Buy IBM using 50% of cash | Cash: 20% |

According to some embodiments of the invention, an implicit relative weight may be provided when the strategy does not explicitly set forth the recommended portion of a model portfolio that is to be allocated for the position, but the recommendation provided by the strategy may be translated or converted from its original form so as to provide an explicit relative weight recommendation. It would be appreciated that, according to some embodiments of the invention, the original form of a recommendation in respect of the non-cash position, that is implicit in respect of a recommended relative weight for the non-cash position, is not significant in itself, as long as the recommendation is translated to provide a recommended (target) relative weight for the non-cash position (out of a model portfolio provided by the strategy).

It should also be appreciated that in some embodiments, assets whose relative weights are not explicitly mentioned by a strategy are implicitly assumed to have zero weight; thus S1 may be interpreted as implicitly recommending DOX, DIS and XLE to have zero weights.

In order to provide an example of an implicit relative weight recommendation reference is made to strategy S1 of Example 1. Strategy S1, which is one of two strategies associated with portfolio P1, provides a recommendation to buy an IBM position (non-cash position) using 50% of the available cash. According to some embodiments of the invention, the recommendation provided by strategy S1 is regarded as being an implicit relative weight recommendation. It should be appreciated that the percentage is used in this example and in other examples where percentage is used, for convenience purposes, and as an illustration of a measure of proportions and relative weights. It would be therefore appreciated, that this form of measure or representation may be used to provide proportions and relative weights. As will be discussed in detail below, the recommendation provided by strategy S1 may also be regarded, according to some embodiments, as an explicit recommendation to use a specified portion of the available cash to buy a non-cash position. Here however, it is assumed for illustration purposes that the recommendation in respect of the IBM position provides an implicit relative weight in respect of the IBM position, and it requires translation. Thus, since at the time of the recommendation is made, the relative weight of the cash position within a model portfolio provided by strategy S1 is 50%, the recommendation provided by strategy S1 may be translated to a recommendation to modify the relative weight of the IBM position to 75% (adding 50% of 50%—original relative weight of strategy S1 cash position). Thus, the implicit relative weight recommendation (buy an IBM position using 50% of the available cash) is translated to a relative weight recommendation according to which the IBM position is to be allocated with 75% of the model portfolio provided by strategy S1.

Additional examples of a change in respect of a non-cash position providing explicit or implicit recommended relative weights for the non-cash position include, but are not limited to:
A recommendation to buy a non-cash position using a certain currency (e.g. US Dollars) amount may be considered as providing an explicit relative weight, when the strategy provides a model portfolio which is provided using dollar amounts (the model portfolio being the accumulated sum of all the positions in the strategy). For example, strategy S2 of portfolio P1 may provide a model portfolio having a total value of USD 100. The USD 100 may be allocated amongst the positions in strategy S2 as follows: DOX: USD 30, DIS: USD 50 and Cash: USD 20. Strategy S2 may provide a recommendation to modify a relative weight of DOX position to USD 50 out of the USD 100 model portfolio. The recommendation provided by S2, in case it is used as is, is a recommendation in respect of a DOX (non-cash) position which explicitly provides a recommended relative weight (USD 50 out of USD 100) for the DOX position.
The positions recommended in S1 may be provided using number of shares rather than with a US Dollar amount and the US Dollar amounts may be calculated in a straightforward way by multiplying the number of shares by the current price of the asset.
In yet another implicit variation, for every non-cash position recommended by a strategy, the strategy may provide an historic purchase price in addition to the number of units which the strategy recommends to hold, and the USD value of each position may be calculated by multiplying the number of units by the purchase price.

The change provided by the strategy in respect of a non-cash cash position may include increasing the recommendation relative weight of the non-position or decreasing the relative weight of the non-cash position. As an example of decreasing a relative weight of a non-cash position, with reference to Example 1, strategy S2 may recommend that a relative weight of the DIS position is to be reduced to 25%. In accordance with another example, further with reference to Example 1, strategy S2 may recommend that a 50% of a DIS position be sold. This recommendation may be regarded as being an implicit relative weight recommendation. Accordingly, the recommendation is translated to a recommendation to reduce the relative weight of the model portfolio provided by strategy S2 so that the allocation for the DIS position is 25% (50% of the original 50% allocation for the DIS position).

In a model portfolio implemented by a strategy for recommending cash and non-cash positions, a new position may be added to the strategy by adding the appropriate position to the model portfolio and specifying the recommended relative weight for the new position. Similarly, a position may be removed from the portfolio by deleting it from the model portfolio or by setting its relative weight to zero. According to some embodiments of the invention, in case a portfolio includes holding in an asset which is not part (recommended by) of any strategy and is not included within any of the model portfolios, a position in that asset may be added to one of the strategies and may be allocated with a zero relative weight.

Having discussed a change in respect of a non-cash position which includes explicitly or implicitly specifying a recommended relative weight for the non-cash position, there is now provided a discussion in respect of a recommendation to buy a non-cash position by providing an explicit or implicit portion of available cash that is to be used for buying the non-cash position.

Further aspects of the invention relate to a multi-strategy portfolio, whereby at least one of the strategies provides a recommendation to buy a non-cash position by explicitly or implicitly specifying a portion of available cash that is to be used for buying the non-cash position. It would be appreciated, that since a portfolio as used herein is associated with two or more strategies, a recommendation provided by a strategy may be evaluated in the context of the recommending strategy. Thus, according to some embodiments of the invention, when a recommendation to buy a position using a specified portion of the cash available is received from one of the strategies associated with the portfolio, the recommendation may be regarded as relating to a specified portion of the cash that is allocated to the recommending strategy, rather than to the entire amount of cash included within or associated with the multi-strategy portfolio as a whole.

An explicit recommendation to buy a non-cash position using a specified portion of available cash, may include reference to the non-cash position that is recommended for being bought and to the portion of available cash that should be used for buying the non-cash position. It would be appreciated, as detailed below, that a recommendation by a strategy may include further details and additional instructions (e.g., limits, expiration dates, stoploss, and target price).

Referring now to Example 2 below, strategy S2, which is one of two strategies associated with portfolio P2, provides an explicit recommendation to buy DOX position using 100% of available cash.

### Example 2

P2

| S2 (60%): | S1 (40%): |
|---|---|
| DOX 30% | IBM 20%→60% |
| DIS 50% | |
| Buy DOX using 100% of available Cash | Cash 80%→40% |

According to some embodiments of the invention, an implicit recommendation to buy a non-cash position using a specified portion of the cash available may be provided when a strategy does not explicitly set forth the portion of available cash that is recommended for being used for buying the non-cash position, but the recommendation provided by the strategy may be translated or converted from its original form to a recommendation which specifies a certain portion of the available cash that is recommended for being used for buying the non-cash position. It would be appreciated that, according to some embodiments of the invention, the original form of a recommendation to buy a non-cash position, that is implicit in respect of a recommended portion of available cash that is to be used for buying the non-cash position, is not significant in itself, as long as the recommendation is translated to provide a recommended portion of available cash that is recommended for being used to buy the non-cash position.

In example 2 above, strategy S1 provides an updated model portfolio whereby a recommendation is provided to increase a relative weight of an IBM position from 20% to 60% of the model portfolio and to reduce the relative weight of the cash position in the model portfolio from 80% to 40%. According to some embodiments of the invention, the updated model portfolio provided by strategy S1 of portfolio P2 is regarded (interpreted) as being an implicit recommendation to buy an IBM position using a certain portion of the available cash. Thus, since at the time the recommendation is made, the relative weight of the cash position within the model portfolio provided by strategy S1 is 80% of the model portfolio and in accordance with the recommendation the weight of the cash position is to be reduced to 40% of the model portfolio (and since the recommendation is evaluated in respect of the recommending strategy only), the recommendation provided by strategy S1 may be translated to a recommendation to use 50% of the available cash to buy an IBM position (40 out of 80).

In a similar way, a strategy may provide a recommendation to sell a non-cash position by explicitly or implicitly specifying a recommended portion of the non-cash position that is to be sold. For example, with reference to Example 2, strategy S2 may explicitly recommend that a DIS position be sold by explicitly specifying that the 50% of a DIS position should be sold. In accordance with another example, further with reference to Example 2, strategy S2 may provide a recommendation in accordance with which the portion of the model portfolio provided by strategy S2 that is to be allocated for the DIS position is to be reduced to 25%. This recommendation may be regarded as being a recommendation to sell which implicitly specifies the portion of the non-cash position that is to be sold. Accordingly, the recommendation is translated to a recommendation to sell 50% of the DIS position (25% relative weight being 50% of the original 50% relative weight).

In addition to the relative weight recommendation and to the recommendation specifying a portion of available cash, and a recommendation to sell a portion of the position, still further aspects of the invention relate to a multi-strategy portfolio, whereby at least one of the strategies provides a recommendation to buy a non-cash position by explicitly or implicitly specifying a portion of strategy (or portion of a model portfolio or portion of a portfolio) that is to be used for buying the non-cash position. According to some embodiments of the invention, the strategy may recommend to buy the non-cash position by explicitly or implicitly specifying a portion of a model portfolio provided by the strategy (or a portion of the part of the whole portfolio allocated to the strategy) that is to be used for buying the non-cash position. Thus, the recommendation to buy the non-cash position may relate to a portion of a model portfolio that is itself associated with a portion (part) of the multi-strategy portfolio.

An explicit recommendation to buy a non-cash position using a specified portion of a strategy (or a model portfolio), may include reference to the non-cash position that is recommended for being bought and to the portion of the strategy (or model portfolio) that should be used for buying the non-cash position. It would be appreciated, as detailed below, that a recommendation by a strategy may include further details and additional instructions (e.g., limits, expiration dates, stop loss, and target price).

Referring now to Example 3 below, strategy S2, which is one of two strategies associated with portfolio P3, provides an explicit recommendation to buy DOX position using 10% of the strategy (or model portfolio, or portfolio). As mentioned above, the recommendation provided by strategy S2 is regarded as relating to the model portfolio recommended by the strategy; i.e., relating to the portion of the portfolio P3 which is associated with strategy S2.

### Example 3

P3

| S2 (60%): | S1 (40%): |
|---|---|
| DOX: 30% | IBM: 20%→60% |
| DIS: 50% | |
| Buy additional 10% of DOX (i.e., 10% | Cash: 80%→40% |
| of portfolio) | |

According to some embodiments of the invention, an implicit recommendation to buy a non-cash position using a specified portion of a strategy (or portion of a model portfolio) may be provided when a strategy does not explicitly set forth the portion of the strategy (or portion of the model portfolio) that is recommended for being used for buying the non-cash position, but the recommendation provided by the strategy may be translated or converted from its original form to a recommendation which specifies a certain portion of a strategy (or portion of a model portfolio associated with the strategy) that is recommended for being used for buying the non-cash position. It would be appreciated that, according to some embodiments of the invention, the original form of a recommendation to buy a non-cash position, that is implicit in respect of a recommended portion of the strategy (or model portfolio) that is to be used for buying the non-cash position, is not significant in itself, as long as the recommendation is translated to provide a recommended portion of a strategy (or model portfolio) that is recommended for being used to buy the non-cash position.

In example 3 above, strategy S1 provides an updated model portfolio whereby a recommendation is provided to increase a relative weight of an IBM position from 20% to 60% of the model portfolio and to reduce the relative weight of the cash position in the model portfolio from 80% to 40%. According to some embodiments of the invention, the updated model portfolio provided by strategy S1 of portfolio P3 is regarded as being an implicit recommendation to buy an IBM position using a certain portion of the strategy (or model portfolio). Thus, since at the time the recommendation is made, the relative weight of the IBM position within the model portfolio provided by strategy S1 is 20% of the model portfolio, and in accordance with the recommendation, the weight of the IBM position is to be increased to 60% of the model portfolio (and since the recommendation is evaluated in respect of the recommending strategy only), the recommendation provided by strategy S1 may be translated to a recommendation to buy an IBM position using 40% of the strategy (or model portfolio).

The discussion above presented several forms of recommendation in respect of non-cash position. As mentioned above, according to some embodiments of the invention a recommendation provided by a strategy may be translated from its original form to a different form. Furthermore, it should be appreciated that some embodiments of the present invention are compatible with other forms of recommending a position and with other approaches towards recommending changes in respect of a position. Any such recommendation may be converted to any of the recommendation forms to which the present invention relates.

It should also be appreciated, that a recommendation provided by a strategy may include in some embodiments additional information or instructions, such as instructions to use limits, stop loss, target price, expiration dates etc., The additional information may be recorded in respect of each position together with the recommendation and may be retrieved and consulted or implemented when generating a suggested transaction provided in accordance with the present invention, as will be described in greater detail below.

Having discussed the various forms of strategy recommendations to which certain aspects of the invention relate (and their interpretations), there is now provided a detailed discussion of a process of computing a cash allocation and a suggested transaction in a multi-strategy portfolio, according to some embodiments of the invention.

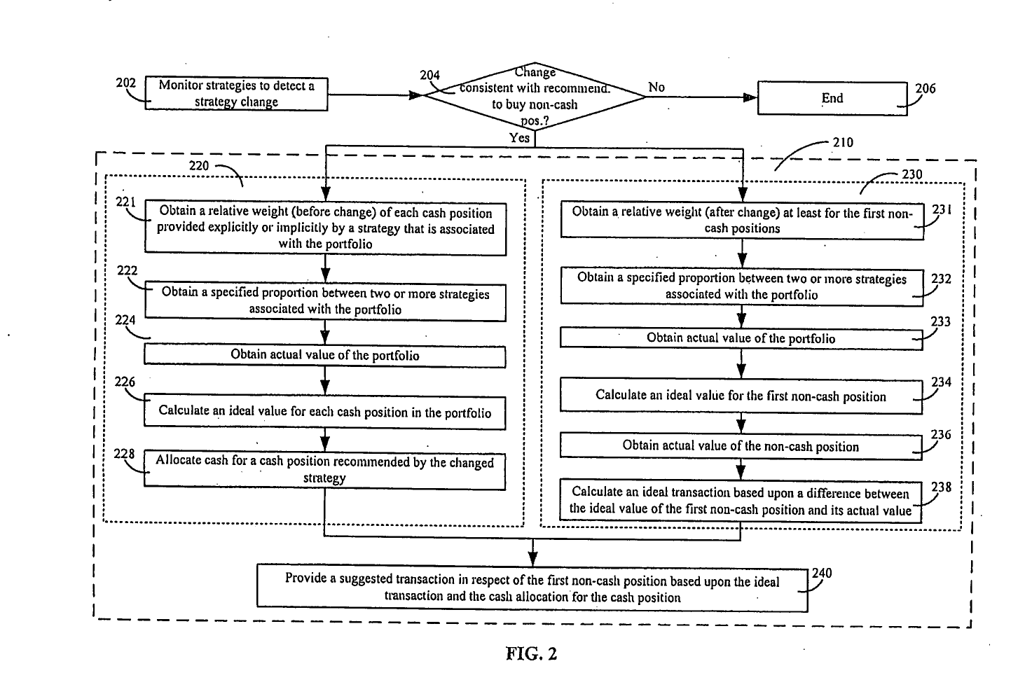

Turning to FIG. 2, there is shown a flow chart illustration of a method of allocating cash and providing a suggested transaction within a multi-strategy (two or more) investment portfolio, wherein in at least one of the strategies, a change in respect of a non-cash position, includes implicitly or explicitly specifying a recommended relative weight for the non-cash position. In accordance with some embodiments of the invention, a portfolio may be provided. The portfolio may be associated with at least two investment strategies, each providing recommended cash and non-cash positions. For convenience, we select that the two strategies with which the portfolio is associated provide recommendations in respect of the cash and non-cash positions using a model portfolio. Thus, each of the strategies may provide a change in respect of a non-cash position by explicitly or implicitly specifying a recommended modified relative weight for the non-cash position. To assist in the understanding of the embodiments of the invention illustrated by FIG. 2, the process illustrated by FIG. 2 shall be applied to a sample portfolio. It should be appreciated that the sample portfolio is one, non-limiting example of a portfolio, in respect of which the process illustrated by FIG. 2 may be implemented.

### Example 4

P4
S1 (40%):

| | |
|---|---|
| IBM | 20% |
| Cash | 80% |

S2 (60%):

| | |
|---|---|
| DOX | 30% |
| DIS | 50% |
| Cash | 20% |

As is shown in Example 4 above, sample portfolio P4 is associated with two investment strategies S1 and S2. Portfolio P4 is configured to relate to the two strategies associated therewith S1 and S2 in accordance with a 2 to 3 proportion respectively, or 40% 60% proportion respectively, as illustrated in Example 4.

Having described and illustrated a multi-strategy investment portfolio, there is now provided a description of an event which may trigger a process that is intended for allocating cash and for providing a suggested transaction within a multi-strategy portfolio, according to some embodiments of the invention. According to some embodiments of the invention, one or more of the strategies associated with the portfolio may be monitored so as to detect a strategy change (block 202). A strategy change with reference to the embodiments of the invention illustrated by FIG. 2 and discussion herein with reference to FIG. 2 includes any strategy change which provides explicitly or implicitly a modified relative weight in respect of a non-cash position. It is noted that a recommended relative weight for a non-cash position may be provided by explicitly or implicitly specifying the updated relative weight for the non-cash position (which is different from a previous explicit or implicit recommended relative weight for the non-cash position). It is also noted that an explicit or implicit recommended relative weight for a non-cash position may provide for the addition of a new position and the deletion of an existing position. For example, strategy S2 of portfolio P4 may be monitored and a strategy change may be detected in respect of strategy S2. In accordance with the strategy change, a model portfolio which is provided by strategy S2 is updated, so that a relative weight of a DOX position is increased from a previous relative weight of 30% to a relative weight 50%. This scenario is illustrated by Example 4 below.

### Example 4

P4

| S2 (60%): | S1 (40%): |
|---|---|
| DOX 30%→50% | IBM 20% |
| DIS 50% | |
| Cash 20% | Cash 80% |

According to some embodiments of the invention, when a strategy change is detected (block 202), an explicit or implicit recommended relative weight provided by the changed strategy in respect of a non-cash position may be processed and checked to determine whether it is consistent with a recommendation to buy the non-cash position (block 204).

According to some embodiments of the invention, a buy recommendation consistency test may be used to determine whether an explicit or implicit recommended relative weight provided by the changed strategy in respect of a non-cash position is consistent with a recommendation to buy the non-cash position. Provided below is a detailed discussion of some embodiments of the invention relating to the buy recommendation consistency test. The description of FIG. 2 is resumed following the discussions regarding the buy recommendation consistency test.

The buy recommendation consistency test may be applied in respect of a non-cash position whose relative weight was explicitly or implicitly updated (or changed) as part of the strategy change. For example, with reference to Example 4, once a strategy change is detected in respect of strategy S2, the non-cash position, whose relative weight is explicitly or implicitly updated, may be identified. In this case, it is identified that the recommended relative weight for the DOX position has been explicitly increased from a previous relative weight of 30% to the current relative weight of 50% of the model portfolio provided by strategy S2. Accordingly, the buy recommendation consistency test may be implemented in respect of the DOX position.

However, according to further embodiments of the invention, the buy recommendation consistency test may be implemented in respect of each non-cash position in the changed strategy for which (each of the non-cash positions) there is provided an explicit or implicit relative weight. Thus, for example, with reference to Example 4, the buy recommendation consistency test may be applied in respect of the changed DOX position but also in respect of the DIS position whose relative weight recommendation did not change (remained at 50% of the model portfolio). More details regarding the buy recommendation consistency test are provided below.

The buy recommendation consistency test may be implemented in order to determine whether a relative weight provided by a changed strategy is consistent with a recommendation to buy the non-cash position. According to some embodiments of the invention the buy recommendation consistency test may include computing an actual value of a non-cash position and an ideal value of the non-cash position and comparing the ideal value and the actual value of the non-cash position. A more detailed discussion in respect of each of “the actual value” of a position and an “ideal value” of a position is provided hereinbelow. Examples of calculating an actual value of a position and examples of computing an ideal value of a position are provided further below with reference to Example 4.

An actual value of a position is the value of a portfolio holding (in an asset) or part of it that is associated with the position. An actual value of a position may be calculated, for example, by obtaining the number of units, shares, stocks or the like which are associated with the position and which are actually held in the portfolio, and the market value or any other relevant value of each unit, and multiplying the number of units with the associated unit value (price).

It would be appreciated that in case a portfolio holding an asset is distributed across more than one account (some portion of the holding resides within each of a plurality of accounts), calculating the actual value of a position associated with the holding may involve aggregating the value (or other quantity; e.g. number of shares) of the holdings (sum of the individual account holdings).

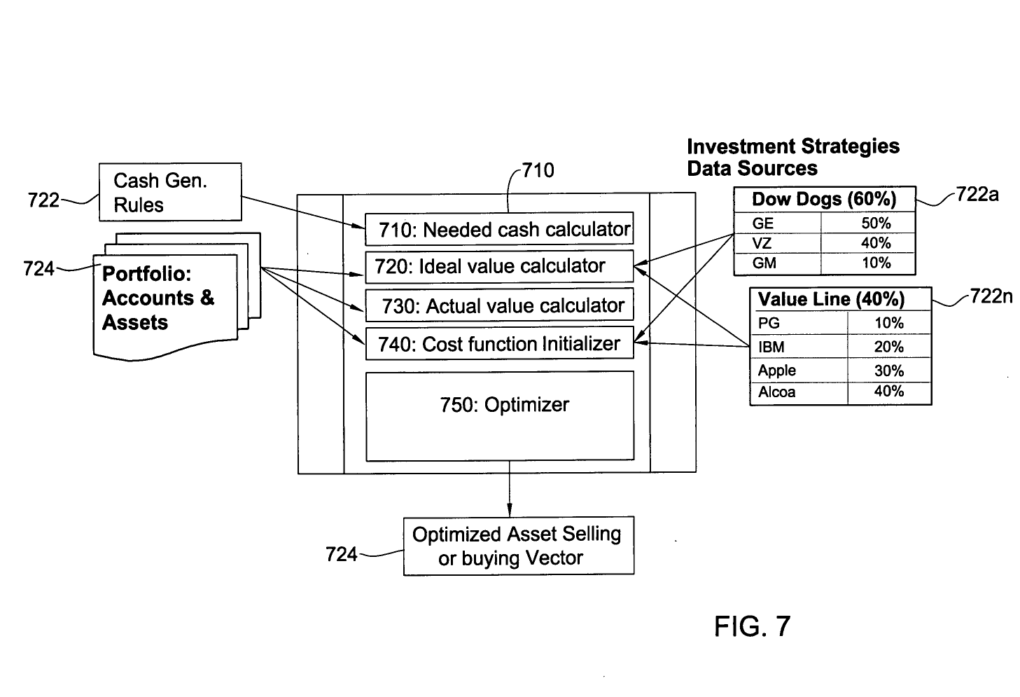

It would also be appreciated that in some cases two or more recommended positions may relate to a common asset. In such cases, the value of a portfolio holding in the asset may correspond to the sum of the actual values of all the positions relating to the common asset. Thus, as part of calculating an actual value of a particular one of the positions which relate to the common asset, the actual (market) value of the portfolio holding the asset may be divided amongst the two or more positions. In the following discussion we assume that each non-cash holding in a portfolio is associated with one non-cash recommended position. An example of obtaining an actual value for a non-cash position (assuming that the asset to which the non-cash position relates is associated with that position only) is provided below with reference to Example 4. A more detailed discussion of a scenario where two or more positions relate to (or are associated with) a common asset, including examples of calculating an actual value and an ideal value for each of the positions, shall be provided with reference to FIG. 7 below.

The other value which is used as part of the buy recommendation consistency test is the ideal position value. According to some embodiments of the invention, an ideal value of a position (having a relative weight), is based upon the following:
a position's relative weight as provided by (for example, when the recommended relative weight is explicit) or induced from (for example, when the recommended relative weight is implicit) the strategy recommending the position;
The proportion between the two or more strategies with which the portfolio is associated;
The actual (market) value of the portfolio.
   An example of calculating an ideal value of a position is provided below in respect of a position included in P4 of example 4.

The actual (market) value of the portfolio is sometimes referred to herein as: “the market value of the portfolio” or “the total value of the portfolio” or “the value of the portfolio”. The actual value of the portfolio may represent in some embodiments the total value of the portfolio at a certain point in time. In accordance with some embodiments of the invention, an actual (market) value of a portfolio may be based on the total value of holdings in assets in the portfolio. Calculating the total value of a portfolio's holdings in assets may include totaling the values of each holding in each asset and in each account that is associated with the portfolio including cash holdings. In further embodiments, the actual (market) value of a portfolio may be based upon the actual value of each non-cash position in each strategy that is associated with the portfolio together (plus) with the actual amount of cash in the portfolio or associated with the portfolio, plus the holdings of assets in the portfolio which do not have corresponding positions in any associated strategy. However, it would be appreciated that according to some embodiments of the invention, in case a portfolio includes a holding in an asset which is not part of (not recommended by) any strategy and is not included within any of the recommended model portfolios, it may be added to one of the strategies and may be allocated with a zero relative weight. Thus what is received is a position whose recommended relative weight is 0% and the position's actual value is the actual value of the holding in the asset. An example of a process of obtaining an actual (market) value of a portfolio is provided below with reference to Example 4.

According to some embodiments of the invention, the buy recommendation consistency test may indicate that a strategy change is consistent with a recommendation to buy a non-cash position when the difference between an ideal value of the non-cash position and the actual value of the position or holding associated with the position is positive (larger than zero); i.e. when the positions' ideal value is greater than the corresponding actual value. It would be appreciated that the buy recommendation consistency test discussed above is compatible with a strategy which provides its recommendations via a model portfolio which may be changed from time to time or with any other strategy which provides recommendations that may be converted to relative weights recommendations. Furthermore, as mentioned above, the buy recommendation consistency test may be applied in respect of a (one or more) non-cash position(s) whose relative weight(s) is (are) modified as part of the strategy change; or, in accordance with further embodiments of the invention, the buy recommendation consistency test may be applied in respect of each non-cash position recommended by the changed strategy. According to still further embodiments of the invention, the buy recommendation consistency test may be applied with respect to each non-cash position in respect of which the changed strategy provides explicit or implicit recommended relative weights.

It would be appreciated that according to some embodiments of the invention, in some cases, even when a (explicit or implicit) relative weight recommendation in respect of a certain position is unchanged, the buy recommendation consistency test may conclude that the current recommendation in respect of the position is consistent with a buy recommendation. An example of one such scenario may occur when the actual (market) value of the portfolio has increased (substantially) in value, whereas the actual value of a non-cash position has dropped (or relatively moderately increased). The ideal value of the position, which is calculated based upon the position's relative weight, the predefined proportion between the strategies and the actual (market) value of the portfolio, may thus significantly increase in contrast to the actual value of the position which has dropped. The result is that the difference between the ideal value and the actual value of the non-cash position is positive and the buy recommendation consistency test (in case it is applied to each non-cash position recommended by the changed strategy) may indicate that although the relative weight recommendation in respect of the non-cash position has not changed, the strategy's recommendation in respect of the non-cash position is consistent with a recommendation to buy the non-cash position. Its consistency with a recommendation to buy may be established as part of other scenarios as well.

Returning now to block 204 in which it is determined whether the detected strategy change(s) is (are) consistent with a recommendation to buy a non-cash position. If it is determined at block 204 that the explicit or implicit recommended relative weight provided in respect of a non-cash position is not consistent with a recommendation to buy the non-cash position, the process is terminated in respect of the non-cash position (block 206). For example, this may occur when, in accordance with a consistency test, a recommended relative weight in respect of a non-cash position is not consistent with a recommendation to buy the non-cash position.

However, if at block 204 it is determined that the explicit or implicit recommended relative weight provided in respect of a non-cash position is consistent with a recommendation to buy the non-cash position, a process for allocating cash and suggesting a recommended transaction (block 210) may be initiated. The process for allocating cash and suggesting a recommended transaction (block 210) shall be described in detail below. It would be appreciated that if it is determined that several (two or more) non-cash positions are associated with recommended relative weights that are consistent with a recommendation to buy, the process for allocating cash and providing a suggested transaction may be initiated and executed in respect of each of the non-cash positions.

Having described the triggering of the process that is intended for allocating cash and providing a suggested transaction (block 210), there is now provided a detailed description of the process itself, according to some embodiments of the invention. According to some embodiments of the invention, the process that is intended for allocating cash and providing a suggested transaction(s) (block 210) may include two threads or two sub-processes (blocks 220 and 230). The first sub-process may be intended for computing an allocation of cash for at least one of the strategies that are associated with the portfolio (block 220), e.g., for the changed strategy. The second sub-process may be intended for calculating an ideal transaction in connection with a recommendation or an equivalent of a recommendation to buy the non-cash position (block 230). According to some embodiments of the invention, the outputs of the two sub-processes may be used for computing the suggested transaction as will be described below. The two sub-processes may be parallel or sequential and may share common inputs and common computations or may be independent from one another.

Reference is now made to the first sub-process that is intended for computing an allocation of cash for at least one of the strategies that are associated with the portfolio (block 220). The description of the second sub-process that is intended for calculating an ideal transaction in connection with a recommendation or an equivalent of a recommendation to buy the non-cash position (block 230) shall follow the description of the first sub-process.

The first sub-process that is intended for computing an allocation of cash for at least one of the strategies that are associated with the portfolio (block 220) may include obtaining a relative weight of each cash position in the portfolio (block 221). According to further embodiments of the invention, a relative weight may be obtained specifically for the cash position provided (explicitly or implicitly) by the changed strategy and for at least one other cash position provided by at least one other strategy. According to some embodiments of the invention, the relative weight value obtained for the cash position provided by the changed strategy may correspond to the relative weight of the cash position prior to the change. For example, with reference to example 4, the relative weight 20% of the cash position provided by strategy S2 may be obtained. The relative weight 20% obtained for the cash position of strategy S2, is the relative weight provided by or induced from the strategy S2 prior to the change (recommendation to increase relative weight of DOX position from 30% to 50% of model portfolio). It would be appreciated, that according to some embodiments of the invention, for the purposes of cash allocation in the context of providing a suggested transaction in response to a recommendation to buy a non-cash position (or some equivalent thereof), the cash position recommendation provided by a changed strategy prior to the change may be of relevance for evaluating or determining the extent of the resources available for carrying out a recommendation to buy a non-cash position as provided by the changed strategy.

Next (or in parallel), according to some embodiments of the invention, a relative proportion between the two or more strategies associated with the portfolio may also be obtained (block 222). According to some embodiments of the invention, the specified proportion between the two or more strategies associated with the portfolio is a given value. For example, with reference to example 4 below, portfolio P4 relates to the two strategies S1 and S2 in accordance with a 2 to 3 proportion respectively, or a 40%-60% proportion respectively. Accordingly, in the case of portfolio P4, the specified relative proportion between the two strategies associated with the portfolio S1 and S2 is 40%-60% respectively. A more detailed discussion in respect of the proportion between the strategies was provided above.

According to some embodiments of the invention, further as part of the computing an allocation of cash (block 220), an actual (market) value of the portfolio may be obtained (block 224). As is shown in Example 4 below, a portfolio includes holdings in assets.

### P4 Holdings:

| | |
|---|---|
| IBM | USD 7,000 |
| DOX | USD 14,000 |
| DIS | USD 26,000 |
| CASH | USD 3,000 |
| P4 Actual Value: | USD 50,000 |

Calculating the actual (market) value of a portfolio includes totaling the values of each portfolio holding (in each asset and in each account) in the portfolio including cash holdings. It should be appreciated that in some embodiments of the invention, the actual (market) value of the portfolio is pre-calculated and is provided explicitly.

In Example P4, the portfolio P4 includes holdings IBM, DOX and DIS and a cash holding. Each of the IBM, DOX, DIS holdings and the cash holding has an actual value. The value of each holding may be determined in some embodiments, in accordance with the actual number of units/shares of the asset that are held at the time of the calculation of the actual (market) value of the portfolio and the market price or any other relevant unit price at the time of calculation. The portfolio cash holding may be determined in accordance with the current amount of cash that is within or associated with the portfolio. Calculating an actual value of a holding was discussed above in greater detail. The actual (market) value of the portfolio P4 in Example 4 is obtained by totaling the actual value of each holding in portfolio P4. As is illustrated above, the actual value of portfolio P4 is USD 50,000.

It would be appreciated that the portfolio's holdings in assets may include holdings that are associated with recommended non-cash positions and cash holdings (which may be associated with the recommended cash positions). However, it would also be appreciated that the value of portfolio holdings which are associated with a non-cash position that is recommended by a strategy may change over time, for example in accordance with market conditions. Furthermore, according to some embodiments of the invention, holdings in assets (or portions thereof) may be added or removed from the portfolio from time to time. For example, an operator (or user) may remove/sell some IBM shares from an account associated with the portfolio and the actual value of the holding in IBM may thus be reduced possibly regardless of the recommendations provided by the strategies with which the portfolio is associated. In accordance with another example, an operator may withdraw cash which is associated with a portfolio holding. Furthermore, according to some embodiments, the portfolio holdings in assets may also include holdings that are not associated with any position of any strategy. For example, the portfolio holdings may include a holding in an asset that was added to the portfolio by a human operator independently from the recommendation provided by the strategies associated with the portfolio. Still further, it would be appreciated, that according to some embodiments of the invention, calculating an actual amount of cash may include (or may be based on) calculation of a “power to buy” and therefore may result in a value which is different (higher or lower) than the value of cash related holdings in the portfolio. A “power to buy” calculation may be based, for example, on cash and non-cash holdings of the portfolio (used as collaterals), on the margin policy or credit assigned to some of the accounts associated with the portfolio or on other attributes of accounts that are associated with the portfolio or with entities who own the accounts. It should be appreciated that according to some embodiments of the terms “cash holding”, “value of cash holding”, “actual amount of cash”, are used throughout the description of the invention to refer to the amount of accessible cash within a portfolio, which may be related to the cash assets within the portfolio. However, it should be appreciated that according to further embodiments of the invention, these terms may also be related to a “power to buy” and may thus refer also to the buying power with which the portfolio is associated.

According to some embodiments of the invention, once each of the relative weight of the cash positions (at least for the changed strategy and one more), the specified proportion between the strategies, and the actual (market) value of the portfolio are obtained, an allocation of cash may be computed for the cash position provided by the changed strategy. In FIG. 2, and according to further embodiments of the invention, the allocation of cash for the cash position of the changed strategy is calculated based upon at least a proportion between values that are related to at least two cash positions recommended by at least two strategies with which the portfolio is associated. By way of example, the allocation of cash for the cash position of the changed strategy may be based upon a proportion between the ideal cash position values of each of the strategies associated with the portfolio, as will be described below. It should be appreciated that the motivation to use such proportion in some embodiments is to allocate cash for the cash position of the changed strategy while taking into account the cash reservation needs (e.g. the ideal values) of other cash positions recommended by other strategies, rather than just the needs of the cash position recommended by the changed strategy. It would be appreciated however, that according to some embodiments of the invention the ideal position values are provided for convenience and that the calculation of the allocation of cash for the cash position of the changed strategy may be carried out using other values related to the recommended cash positions such as the relative weights of the cash positions, the specified proportions between strategies and the actual (market) value of the portfolio. According to some embodiments and as explained further below, calculating the cash allocation proportion based upon a proportion between ideal cash position values may be carried out without using the actual (market) value of the portfolio.

Referring back to FIG. 2, according to some embodiments of the invention, as part of computing the allocation of cash for the cash position provided by or induced from the changed strategy, an ideal value may be calculated for each cash position in the portfolio (block 226). As mentioned above, according to some embodiments of the invention, an ideal value of a position may be based upon the position's relative weight as explicitly or implicitly provided by the strategy recommending the position, the proportion between the two or more strategies that are associated with the portfolio and the actual (market) value of the portfolio. One non-limiting mathematical expression which may be used according to some embodiments of the invention for representing a calculation of an ideal value of a position, in this case, the cash position of strategy S2 in example 4, is the following:

idealValue_{cash.S2}=relativeWeight_{cash.S2}×proportion_{S2}×value_{P4} Eq. 1

Where:

relativeWeight_{cash.S2} is the relative weight of the cash position provided explicitly or implicitly by the changed strategy S2 (prior to a weight change if any). In example 4, the relative weight of the cash position provided by the changed strategy, that is strategy S2 is 20%; as mentioned above, the relative weight of the cash position used for calculating the ideal value of the cash position is the relative weight of the cash position prior to the change and prior to implementation of the buy transaction.
proportion_{S2} represents the relative portion of the changed strategy in the portfolio. The relative portion of a strategy in the portfolio is based upon the specified proportion between the strategies. In example 4, the relative portion of the changed strategy S2 is 60% of the portfolio;
value_{P4} denotes the actual (market) value of the portfolio. In example 4, the actual (market) value of the portfolio P4 as detailed above is USD 50,000; and
idealValue_{cash.S2} represents the calculated ideal value calculated for the cash position of the changed strategy. With reference to example 4, in accordance with the above values, the ideal value of the cash position provided by strategy S2 is:

idealValue_{cash.S2}=20%×60%×US$50,000=US$6,000

Similarly, the ideal value of the cash position provided by or induced from strategy S1 is:

idealValue_{cash.S1}=80%×40%×US$50,000=US$16,000

Once the ideal values for the cash positions are computed in some embodiments, (block 226), allocation of cash for the changed strategy may be calculated, and the appropriate sum may be allocated to the cash position of the changed strategy (block 228) based on a proportion between (among) ideal cash position values. As mentioned above, according to some embodiments of the invention, the ideal values of the cash positions may not be required for calculating the allocation of cash for the cash position of the changed strategy since the ratio between two ideal position values is equal to the ratio between the corresponding proportions of the positions while the proportions may be computed by multiplying the relative weight of each position by the strategy proportion of that position. However, for convenience purposes, the cash allocation in FIG. 2 is described with reference to ideal values and the example provided below also uses ideal values. In accordance with one non-limiting example, ideal values may be used in calculating an allocation of cash for a cash position as follows:

$${cashAllocation}_{cash . S 2} = {actualCash}_{P 4} \times \frac{{idealPosition}_{cash . S 2}}{{\sum }_{m = 1}^{n} {idealPosition}_{cash . Sn}} \qquad Eq . 2$$

Where:

actualCash_{P4} is the actual amount of cash that is currently available in the portfolio. In example 4, the actual cash value in portfolio P4 is USD 3,000; idealPosition_{cash.S2} denotes the ideal value of the cash position provided explicitly or implicitly by the changed strategy (the strategy which recommends how to allocate cash). In example 4, the ideal value of the cash position provided by or induced from strategy S2 is USD 6,000 (as calculated above); It should be appreciated that in case the above sum of ideal values of cash positions is zero, division should be avoided (otherwise, division by zero may occur) and the cash allocation in certain embodiments for S2 may be set to zero. In other embodiments (in the case of zero denominator) the cash allocation value may be set to the actual cash or to any value no less than zero and no greater than the actual cash value.

$${\sum }_{m = 1}^{n} {idealPosition}_{cash \cdot Sn}$$

is the sum of all the ideal cash values of all or some of the cash positions in the portfolio (i.e., cash positions recommended explicitly or implicitly by strategies with which the portfolio is associated). In example 4, the sum of all ideal cash positions in portfolio P4 is calculated as follows:

idealPosition_{cash.S1}+idealPosition_{cash.S2}=US$16,000+US$6,000=US$22,000

cashAllocation_{cash.S2} represents the computed allocation of cash for the cash position of the changed strategy. In example 4, the cash allocation for the cash position of strategy S2 may be calculated as follows:

$${cashAllocation}_{cash \cdot S 2} = US \$ 3 \text{,} 000 \times \frac{US \$ 6 \text{,} 000}{US \$ 22 \text{,} 000} \approx 818$$

Accordingly, when the process of calculating an allocation of cash is applied to portfolio P4 and in accordance with the data regarding the portfolio P4 that is provided as part of Example 4, the result of the cash allocation process (block 220) will be that an amount USD 818 is allocated for the cash position of the changed strategy S2.

It should be noted that where in formula of Eq. 2 the sum of all ideal cash positions is zero, any person who is familiar with the art can avoid the zero division, for example, by allocating any value between zero and the actual amount of cash.

It should be appreciated that in some embodiments Equation 2 may be adapted for calculating cash allocation based upon a proportion (or using a ratio) of other values (Relative Values) that are related to cash positions recommended by strategies with which the portfolio is associated, as in the following non-limiting mathematical expression:

$${cashAllocation}_{cash \cdot S 2} = {actualCash}_{P 4} \times \frac{{RelateValue}_{cash \cdot S 2}}{{RelatedValue}_{cash \cdot Sn}} \qquad Eq . {2}^{′}$$

Equation 2′ is similar to equation 2; however it is more general since instead of using a proportion (and related ratio) between ideal values related to cash positions recommended by associated strategies, a more general proportion (and a related ratio) between values related to recommended cash position is used. Thus, RelateValue_{cash.S2} is a value related to a cash position that is recommended by strategy S2, while the denominator is the sum of at least two such values related to at least two recommended cash positions. It should be appreciated that as will be described below, calculating cash allocation in some embodiments may be further based upon reserving cash for re-investing in addition to or instead of reserving cash for cash positions recommended by associated strategies.

According to some embodiments of the invention, as mentioned above, either in conjunction with or in parallel with the sub-process for calculating an allocation of cash for the cash position provided explicitly or implicitly by the changed strategy (block 220), a second sub-process that is intended for calculating an ideal transaction may be executed (block 230). The process of calculating an ideal transaction (block 230) may be intended for computing an ideal transaction which corresponds to a recommendation to buy a non-cash position. The need for the process of calculating an ideal transaction (block 230) is determined at block 204 above, wherein in accordance with a buy recommendation consistency test it has been determined that a change in respect of a non-cash position is consistent with a recommendation to buy the non-cash position. As was also mentioned above, according to some embodiments of the invention, the buy recommendation consistency test described with reference to block 204 above may be implemented in respect of each non-cash position provided by the changed strategy (and not only in respect of a position whose relative weight, whether it be explicit or implicit, has changed as part of the strategy change), and thus the process of calculating and ideal transaction (block 230) may be applied in respect of each non-cash position whose relative weight as provided explicitly or implicitly by the changed strategy has been determined to be consistent with a recommendation to buy the non-cash position.

For convenience, we assume in FIG. 2 and in the following discussion that the second sub-process that is intended for calculating an ideal transaction (block 230) is applied in respect of one non-cash position. The second sub-process that is intended for calculating an ideal transaction for a non-cash position whose explicit or implicit relative weight is consistent with a recommendation to buy, may include obtaining a relative weight at least for the non-cash position that is associated with the buy recommendation (block 231). According to some embodiments of the invention, the relative weight obtained in respect of the non-cash position is the explicitly or implicitly recommended relative weight for the non-cash position after the strategy change. For example, with reference to portfolio P4 in Example 4, the relative weight obtained for the DOX position is the relative weight of the DOX position after the change, in this case 50% (which is consistent with a recommendation to buy). As mentioned above, the relative weight of the non-cash position may have already been obtained as part of the buy recommendation consistency test described above with reference to block 204.

In addition to the relative weight of the non-cash position, a specified relative proportion between the two or more strategies associated with the portfolio may also be obtained (block 232). For example, with reference to example 4, portfolio P4 relates to the two strategies S1 and S2 in accordance with a 2 to 3 proportion respectively, or a 40%-60% proportion respectively. As mentioned above, the explicit or implicit relative weights and the proportion between the strategies and optionally other data as well, may be obtained once for both the first sub-process and the second sub-process.

Further as part of calculating the ideal transaction for a non-cash position (block 230), an actual (market) value of the portfolio may be obtained (block 233). The calculation of the actual (market) value of the portfolio was discussed above. In example 4, as is illustrated in greater detail above, the actual value of portfolio P4 is USD 50,000.

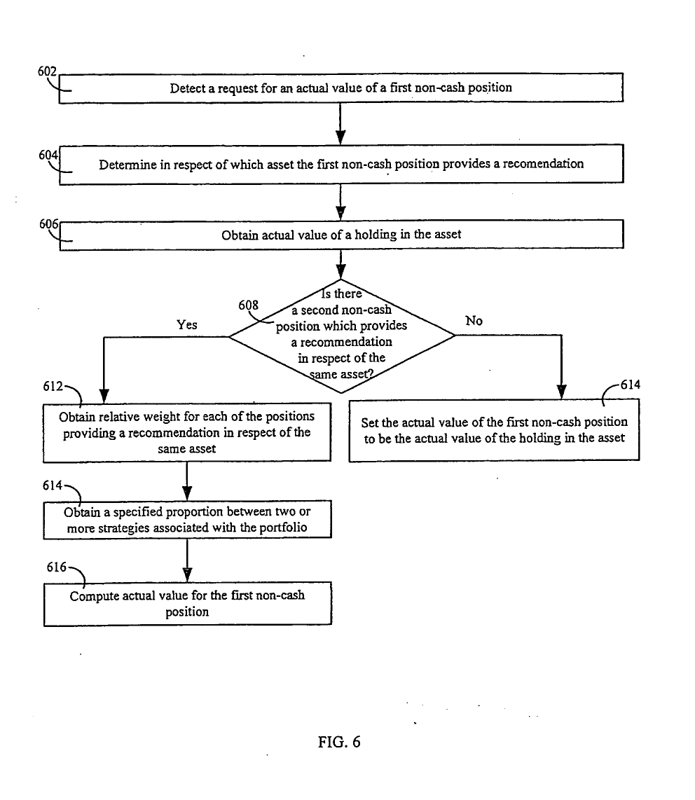

In addition, as part of computing the ideal transaction for the non-cash position, an ideal value and an actual value of the non-cash position may be obtained (block 234, 236). The non-cash position for which the ideal and actual values may be calculated is the non-cash position in respect of which a recommendation to buy or an equivalent of a recommendation to buy is detected. According to some embodiments of the invention, in case a buy recommendation consistency test is implemented as part of the process of suggesting a transaction, the ideal or actual values of the non-cash position may be obtained during the buy recommendation consistency test, and in that case, it may not be necessary to obtain the ideal and actual values of the non-cash position again. However, if it is necessary to calculate the actual value of non-cash position or of a holding which corresponds to the position (block 236), the number of units, shares, stocks or the like that are currently held in the portfolio in association with the non-cash position is obtained. The total number of shares which are associated with the non-cash position is then multiplied by the current market value or any other applicable value of each unit, share stock or the like and the result is the actual value of the position. In example 4, the non-cash position in respect of which a recommendation to buy or an equivalent of a recommendation to buy is detected is the DOX position, and the actual value of the DOX position is, as provided in the example, USD 14,000. As will be described in further detail in respect of FIG. 6, when more than one position refers to the same asset, the actual value of each position may be calculated based on a proportion (or using a ratio) among values related to these positions. The case where two (or more than one) positions refer to the same asset holding will shortly be discussed in detail.

The actual value of the non-cash position in respect of which a recommendation to buy or an equivalent of a recommendation to buy is detected, may be used to calculate an ideal transaction value for the non-cash position. According to some embodiments of the invention, an ideal transaction value for the non-cash position may be calculated based upon a difference between an ideal value of the non-cash position (calculated based upon the explicit or implicit recommended relative weight for the non-cash position after the change) and the actual value of the non-cash position (block 238). The ideal value of the non-cash position and the calculation thereof was discussed above with reference to the buy recommendation consistency test. According to some embodiments of the invention, in case a buy recommendation consistency test is implemented, the ideal value of the non-cash position may be reused as part of determining the ideal transaction value. With reference to example 4, the ideal value of DOX position may be calculated using the following equation:

idealPosition_{DOX.S2}=relative Weight_{DOX.S2}×proportion_{S2}×value_{P4} Eq. 3

Where:

relativeWeight_{DOX.S2} is the relative weight (after the change) explicitly or implicitly recommended for the DOX position, in the case of example 4, the recommended weight for the DOX position is 50% (after the change);
proportion_{S2} is the relative portion of the changed strategy, strategy S2, in the portfolio. The relative portion of a strategy in the portfolio is based upon the specified proportion between the strategies. In example 4, the relative portion of the changed strategy, strategy S2, is 60% out of the portfolio; and
value_{P4} is the actual (market) value of the portfolio. In example 4, the actual (market) value of the portfolio is USD 50,000; and
idealPosition_{DOX.S2} is the calculated ideal value for the DOX position as recommended by strategy S2.
The ideal value of the DOX position provided by or induced from strategy S2 is:

idealPosition_{DOX.S2}=50%×60%×US$50,000=US$15,000

With reference to example 4, the ideal transaction for the DOX position of strategy S2 may be calculated using the following equation:

idealTransaction_{DOX.S2}=idealValue_{DOX.S2}−actualValue_{DOX.S2} Eq. 4

Thus, the ideal transaction for the DOX position of strategy S2 would be:

idealTransaction_{DOX.S2}=US$15,000−US$14,000=US$1,000

According to some embodiments of the invention, once the cash allocation for the changed strategy is computed and the ideal transaction value is calculated, a suggested transaction may be calculated (block 240). The suggested transaction may be calculated based upon the cash allocated for the cash position and the ideal transaction calculated for the non-cash position. In accordance with one, non-limiting example, the suggested transaction may be the minimum out of the cash allocation value and the ideal transaction value. For example, the following equation implemented with reference to Example 4 represents the calculation of a suggested transaction for buying a DOX position:

suggestedTransaction_{DOX.S2}=min(idealTransaction_{DOX.S2},cashAllocation_{cash.S2}) Eq. 5

Thus, referring to example 4 the suggested transaction for buying the DOX position is:

suggestedTransaction_{DOX.S2}=min(US Dollar 1,000,US Dollar 818)=US Dollar 818

In accordance with some embodiments of the invention, the suggested transaction in respect of the non-cash position may be automatically translated to one or more corresponding transactions. For example, data in respect of the suggested transaction may be transmitted or otherwise provided to a transaction execution entity, and the transaction execution entity may execute a transaction based on the data received. For example, with reference to example 4, once it is determined that the suggested transaction is by DOX using US Dollar 818, an appropriate transaction may be generated whereby US Dollar 818 of the cash that is associated with the portfolio may be used to buy DOX shares.

However, it will be appreciated that according to further embodiments of the invention, the suggested transaction may not be automatically and/or literally translated to executable transactions. In some embodiments, the suggested transaction needs to be converted and translated into an order to buy/sell a certain number of units (e.g. shares). Therefore the amount of cash to be used in a suggested transaction needs to be divided by the asset market unit value (or asset price or limit or any other value related to the asset) when translated to a buy/sell order. For example, if the sum provided for the suggested transaction is, as in Example 4, US Dollar 818 for buying DOX shares (units), but the current market price (or limit instruction) of each DOX share is US Dollar 30, then the buy/sell order may be adjusted in accordance with the market price (or limit) of each DOX share and the buy order may be: “buy 27 shares of DOX”.

It will be appreciated that the example provided above in respect of a buy/sell order is a simplified example and that according to some embodiments of the invention there may also be various conditions or constraints which may be applied in respect of a suggested transaction when it is being interpreted as or translated into an actual order to buy/sell. The constraints may be set by an operator or may be dictated by various entities and circumstances. Examples of constraints include, but are not limited to the following: order must include buy or sell of: a minimal number of shares, at a minimal dollar value. After execution of a selling order, there should be a minimal number of shares of the holding left, etc. Thus for example, in case that a minimal number of shares constraint is applied, under certain circumstances, the minimal number of shares constraint may force the rounding of the number of shares either to zero (no transaction) or to the minimal number of shares. In certain embodiments, the suggested transaction may be further converted into multiple orders to be executed in multiple accounts. This kind of conversion may take into account the amount of actual cash in each of the multiple accounts while minimizing tax liabilities (as different accounts may have different tax consequences) and commission payments. In accordance with another example, an operator may be allowed to manually change or override a suggested transaction, such that the implemented buy/sell order is different from the suggested transaction.

In FIG. 2, and in the discussions referring to FIG. 2, there was provided an example of some embodiments which relate to an aspect of the invention, according to which, in response to a change detected in respect of a non-cash position, cash allocation for the changed strategy is computed and a suggested transaction is provided. The aspect of the invention illustrated by FIG. 2 and discussed above with reference to FIG. 2, is relative to a change in respect of a non-cash position which is provided by explicitly or implicitly specifying a recommended relative weight for the non-cash position. It will be appreciated that although the examples provided as part of the discussion of FIG. 2 relate to a non-cash position in respect of which an explicit relative weight recommendation is provided, the aspect of the invention illustrated by FIG. 2 and described herein in respect thereto is not limited in this respect, and that changes which provide recommendations provided in other formats may be translated to relative weights and an allocation of cash and a suggested transaction may be calculated in connection with the changes in accordance with the embodiments of the invention discussed above with reference to FIG. 2.

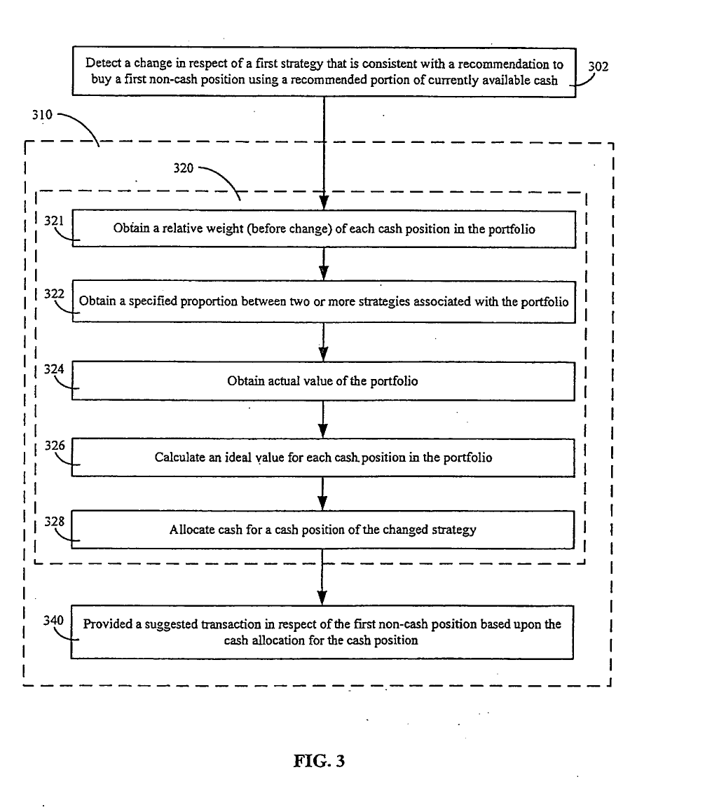

Reference is now made to FIG. 3, which is a flow chart illustration of a method of allocating cash and providing a suggested transaction within a multi-strategy (two or more) investment portfolio, wherein in at least one of the strategies, a change at least in respect of a non-cash position includes, explicitly or implicitly, specifying a portion of available cash that is to be used for buying the non-cash position, according to some embodiments of the invention. FIG. 3 relates to an aspect of the invention, in accordance with which a strategy that is associated with a multi-strategy portfolio (one of at least two strategies that are associated with the portfolio) is configured to provide a change in respect of a non-cash position by explicitly or implicitly specifying a portion of available cash that is to be used for buying the non-cash position.

As mentioned above, since a portfolio according to the invention is associated with two or more strategies, a recommendation by a strategy relating to the available cash may be evaluated in the context of the recommending strategy. Thus, according to some embodiments of the invention, when a recommendation to buy a position, which explicitly or implicitly specifies a portion of the cash available that is to be used for buying the position is received from one of the strategies associated with the portfolio, the recommendation may be regarded as relating to a specified portion of the cash that is allocated to the recommending strategy, rather than to the entire amount of cash included within or associated with the portfolio as a whole.

Referring back to FIG. 3, according to some embodiments of the invention, a change may be detected in respect of a strategy that is associated with an investment portfolio (one of two or more strategies associated with the portfolio). The detected change may be determined to be consistent with a recommendation to buy a first non-cash position using a specified portion of the available cash (block 302). It will be appreciated that if, as part of the strategy change, there is explicitly provided a recommendation to buy certain non-cash position using a portion of available cash, a buy recommendation consistency test is not required for determining that the change is consistent with a recommendation to buy. However, in some cases where the strategy change provides an implicit recommendation to buy a certain non-cash position using a portion of available cash, the buy recommendation consistency test may be required in order to establish that the change provided by the strategy is consistent with a recommendation to buy a non-cash position. For example, when an implicit recommendation to buy a certain non-cash position using a portion of available cash is provided by specifying a relative weight (in a model portfolio) for the non-cash position, the recommendation consistency test may be applied in respect of the change to determine whether the relative weight provided for the non-cash position is consistent with a recommendation to buy the non-cash position.

To assist in the understanding of the embodiments of the invention, FIG. 3 shall be applied to a sample portfolio. It will be appreciated that the sample portfolio is one, non-limiting example of a portfolio, in respect of which a process in accordance with some embodiments of the invention may be implemented.

### Example 5

P5:
S1 (40%):

| | |
|---|---|
| IBM | 20% |
| Cash | 80% |

S2 (60%):

| | |
|---|---|
| DOX | 30% |
| DIS | 50% |
| Buy DOX using 100% of available Cash | |

In example 5, there is provided an investment portfolio P5 that is associated with two strategies S1 and S2. The specified proportion between strategy S1 and strategy S2 is 40% to strategy S1 and 60% to strategy S2 (a 2:3 proportion respectively). Strategy S1 is configured to provide recommendations in the form of a model portfolio. Strategy S1 recommends a 20% position IBM. Currently, this is the only non-cash position recommended by strategy S1. The cash position provided by strategy S1 is 80%. Strategy S2 on the other hand, is configured to provide a change in respect of a non-cash position by explicitly specifying a certain portion of available cash which the strategy recommends to use for buying the non-cash position. Currently, strategy S2 includes a 30% position in DOX and a 50% position in DIS. A change is detected in respect of strategy S2. According to the change detected in respect of strategy S2, it is recommended to buy DOX position using 100% of the available cash.

According to some embodiments of the invention, upon detecting a change that is consistent with a recommendation to buy a first non-cash position using a specified portion of the available cash (block 302), a process for providing a suggested transaction may be initiated (block 310). According to some embodiments of the invention, a process for providing a suggested transaction (block 310) may include a sub-process that is intended for computing an allocation of cash for at least one of the strategies that are associated with the portfolio (block 320). The sub-process may be implemented in respect of the strategy which provided the change in respect of the non-cash position.

According to some embodiments of the invention, as part of the cash allocation process, a relative weight of the cash position as provided explicitly or implicitly by changed strategy may be obtained. For convenience, in FIG. 3, and according to a non-limiting embodiment of the invention, a relative weight of each cash position in the portfolio is obtained (block 321). It would be appreciated, that the cash position's relative weight prior to the change may be of relevance in some embodiments for establishing the amount of cash to be allocated for carrying out the recommended change. In some embodiments of the invention, in case a strategy does not provide an explicit relative weight for a cash position and relative weight for the cash position is only implied, in order to determine the relative weight of the cash position of the strategy, the relative weights of all the non-cash positions provided by or induced from the strategy may be summed (if for some of the non-cash positions the relative weights are implicit, they may be computed) and subtracted from the total which represents the strategy as a whole (e.g. 100% in case of using percentages). The remainder is determined to be the relative weight of the cash position of the strategy.

For example, in portfolio P5 of Example 5, the changed strategy S2 provided prior to the change explicit recommended relative weights in respect of its non-cash positions, namely a 30% relative weight for a DOX position and a 50% relative weight for a DIS position. The changed strategy S2, before the change, is implicit in respect of its cash position, and according to the strategy S2, the cash position is the remainder of the model portfolio associated with the strategy S2. Thus, since the weights explicitly provided for the non-cash positions of strategy S2 are totaled to be 80%, the implicit relative weight of the cash position in strategy S2 is 20%, prior to the change.

In conjunction with obtaining a relative weight of each cash position in the portfolio at block 321 or in sequence therewith, a specified proportion between the two or more strategies associated with the portfolio may be obtained (block 322). In example 5, the portfolio P5 is configured to relate to the first and the second strategies S1 and S2 respectively in accordance with a 2:3 proportion (or 40% to 60%).

In conjunction with block 321 and 322 or in sequence therewith, an actual (market) value of the portfolio may be obtained (block 324). The actual (market) value of the portfolio may be computed by combining the cash associated with the portfolio and the actual (current) value of each non-cash holding in the portfolio. A detailed discussion in respect of the actual (market) value of the portfolio and the calculation thereof was provided above. As mentioned above, the value of each holding in the portfolio may be determined directly or in accordance with the number of units or shares of the asset that are actually held as part of the portfolio and the market value or some other relevant value of each unit. According to some embodiments of the invention, the actual value of cash in the portfolio is the current amount of cash that is actually part of the portfolio or that is assigned to the portfolio or that is calculated based on a “power to buy” policy. It would be appreciated that cash as well as non-cash holdings may be added, changed or removed from the portfolio as a result of some process or by an operator/user regardless of strategy recommendations or suggested transactions.

The actual (market) value of the portfolio P5 provided as part of example 5 is as follows:
P5 Holdings:

| | |
|---|---|
| IBM | USD 6,105 |
| DOX | USD 34,000 |
| DIS | USD 22,895 |
| CASH | USD 137,000 |
| P5 Actual (Market) Value: | USD 200,000 |

In Example 5, the portfolio P5 includes holdings IBM, DOX and DIS and a cash holding. Each of the IBM, DOX, DIS holdings and a cash holding has an actual value. The value of each holding should be determined in accordance with the actual number of units/shares of the asset that are held at the time of the calculation of the actual (market) value of the portfolio and the market price or any other relevant unit/share price at the time of calculation. In some embodiments, the value of each asset holding in the portfolio may be provided directly via a holding value associated with each asset holding and specifying for each asset holding in the portfolio its value. The portfolio cash holding may be determined in accordance with the current amount of cash that is within or associated with the portfolio. Calculating an actual value of a holding was discussed above in greater detail. The actual (market) value of the portfolio P5 in Example 5 is obtained by totaling the actual value of each holding in portfolio P5. As is illustrated above, the actual value of portfolio P4 is USD 200,000.

Next, an ideal value may be calculated for each cash position in the portfolio (block 326). As mentioned above, according to some embodiments of the invention, the ideal value for the cash positions may be based upon each of: the position's relative weight as explicitly or implicitly provided by the strategy associated with the position, the proportion between the two or more strategies with which the portfolio is associated and the actual (market) value of the portfolio. For example, equation 1 may be used to calculate the ideal cash positions, as follows:

idealValue_{cash.S2}=20%×60%×US$200,000=US$24,000

idealValue_{cash.S1}=80%×40%×US$200,000=US$64,000

Once the ideal values for the cash positions are computed, an allocation of cash for the changed strategy may be calculated, and the appropriate sum may be allocated to the cash position of the changed strategy (block 328). As mentioned above, according to some embodiments of the invention, the full calculation of ideal values for the cash positions may not be required for calculating the allocation of cash for the cash position of the changed strategy. However, for convenience purposes, we shall relate to the calculation of the cash allocation using the ideal values for the cash positions described above and calculated based upon the data provided in example 5. In accordance with one non-limiting example, equation 2 (or equation 2′) may be used to compute the allocation of cash for the cash position provided by or induced from the changed strategy, as is illustrated below in respect of example 5:

$${cashAllocation}_{cash \cdot S 2} = US \$ 137 \text{,} 000 \times \frac{US \$ 24 \text{,} 000}{US \$ 88 \text{,} 000} \approx US \$ 37 \text{,} 363$$

Thus, in accordance with the scenario set forth in example 5, the cash position provided by or induced from strategy S2 shall be allocated with a sum of USD 37,363. The sum allocated for the cash position provided by or induced from strategy S2 is higher than the ideal value of the cash position of strategy S2, which is USD 24,000. It should be appreciated that some embodiments may allocate for the above cash position just the ideal value of that cash position; i.e. limit the amount allocated to be no more than the ideal value and allocate in the example above just USD 24,000 (instead of USD 37, 363).

It should be appreciated that as discussed above, some embodiments of the invention allocate cash for a cash position recommended by a changed strategy while considering the cash reservation needs of cash positions recommended by other strategies as well rather than considering only the changed strategy recommendations. As will be discussed below, some embodiments of the invention allocate cash for the changed strategy by considering further other cash reservation needs such as cash needed for reinvesting. It should be also appreciated that according to some embodiments, cash may be allocated for the various cash needs in proportion to the ideal value needs of the various cash positions (and in some embodiments, also taking into account reinvestment needs). Equation 2 above is an example of a cash allocation calculation based upon a proportion between ideal values related to cash positions recommended by strategies with which the portfolio is associated and by using a ratio that is related to this proportion. Equation 2′ may be generalized for cash allocation based upon a proportion between (among) cash needs and using a ratio related to this proportion.

According to some embodiments of the invention, once the cash allocation computation process is completed, and the cash allocation for the strategy associated with the buy recommendation is computed, a suggested transaction may be calculated. The suggested transaction may be calculated based upon the computed cash allocation for the cash position of the strategy associated with the buy recommendation (block 340). With reference to Example 5, the cash allocation for the strategy associated with the buy recommendation, in this case strategy S2, is USD 37,363. The recommendation provided by or induced from strategy S2 is to buy DOX position using 100% of available cash. As mentioned above, this recommendation is regarded as relating to the cash allocated for the recommending strategy, strategy S2. Accordingly, 100% of the cash allocated for this strategy may be used for buying DOX position. As mentioned above, the suggested transaction may undergo various changes including total canceling before it is executed (or canceled).

It would be appreciated that the process according to an aspect of the invention illustrated by FIG. 2 and the process according to a further aspect of the present invention illustrated by FIG. 3 may provide different suggested transactions when applied to the same portfolio. For example, assuming that the recommendation provided by strategy S2 of portfolio P5 which is part of example 5 translated to a recommended relative weight recommendation in respect of the DOX position (e.g., according to the change in respect of a DOX position, the recommended relative weight for the DOX position is to be 50%) and the process described with reference to FIG. 2 is applied to the strategy change, the outcome would have been different. To illustrate this, we first compute the ideal value of the DOX position after the change:

idealPosition_{DOX.S2}=relativeWeight_{DOX.S2}×proportion_{S2}×value_{P4} Eq. 3

thus:

idealPosition_{DOX.S2}=50%×60%×200,000=USD 60,000

then, we compute the ideal transaction for the DOX position:

idealTransaction_{DOX.S2}=idealValue_{DOX.S2}−actualValue_{DOX.S2} Eq. 4

thus:

idealTransactionDOX_{S2}=US$60,000−US$34,000=US$26,000

and finally we compute the suggested transaction:

suggestedTransaction_{DOX.S2}=min(idealTransaction_{DOX.S2},cashAllocation_{cash.S2}) Eq. 5

and thus:

suggestedTransaction_{DOX.S2}=min(USD 26,000,USD 37,363)=USD 26,000

As illustrated above, according to the process illustrated by FIG. 2, the suggested transaction would have been the equal of the ideal transaction value for the DOX position which is USD 26,000, whereas according to the process illustrated by FIG. 3 the suggested transaction would have the equal of the amount of cash allocated for the cash position of strategy S2 or USD 37,363.

The aspect of the invention illustrated by FIG. 3 and discussed herein with reference thereto relates to a portfolio which is associated with two or more investment strategies, each providing recommended cash and non-cash positions, and at least one of the strategies providing a change in respect of a non-cash position by explicitly or implicitly specifying a portion of the available cash is recommended for being used to buy a non-cash position.

A further aspect of the invention relates to a portfolio which is associated with two or more investment strategies, each providing recommended cash and non-cash positions, and at least one of the strategies providing a change in respect of a non-cash position by specifying explicitly or implicitly a recommended transaction in respect of a non-cash position using a specified portion of a strategy (or portion of a model portfolio or a portion of a portfolio). It would be appreciated that the embodiments of the invention described with reference to the aspects of the invention illustrated by FIG. 2 and FIG. 3 may apply mutatis-mutandis to a multi-strategy portfolio wherein an investment strategy provides a change in respect of a non-cash position by specifying explicitly or implicitly a recommended non-cash position using a specified portion of a strategy (or portion of a model portfolio), or in accordance with another example, by specifying a portion of the portion of the portfolio which is ideally allocated to the changed strategy. Further by way of example, an ideal transaction may be calculated for the non-cash position in accordance with the actual (market) value of the portfolio, such that the ideal transaction is computed by calculating the value of the specified portion out of the portion of the portfolio which is ideally allocated to the changed strategy (which is based upon total actual (market) value of the portfolio and the proportion among strategies). The cash allocation may be computed substantially as described above with reference to FIG. 2 and/or with reference to FIG. 3. For example, consider a revised version of example 5, where S2 explicitly recommend buying DOX using 20% of the strategy (or model portfolio). It should be appreciated that the 20% refers to the model portfolio recommended (explicitly or implicitly) by the changed strategy (S2); i.e., the 20% refers to 20% of the portion of the portfolio ideally allocated to S2 which in the revised example has a value of 200,000*60%=USD 120,000). Thus, the ideal transaction that is related to buying 20% of the S2 model portfolio, corresponds to buying 120,000*20%=USD 24,000 of DOX. Since the cash allocation calculation (using equation 2) results in USD 37,363, taking the minimum between the ideal transaction and the actual cash allocation results in a suggested transaction to buy USD 24,000 of DOX.

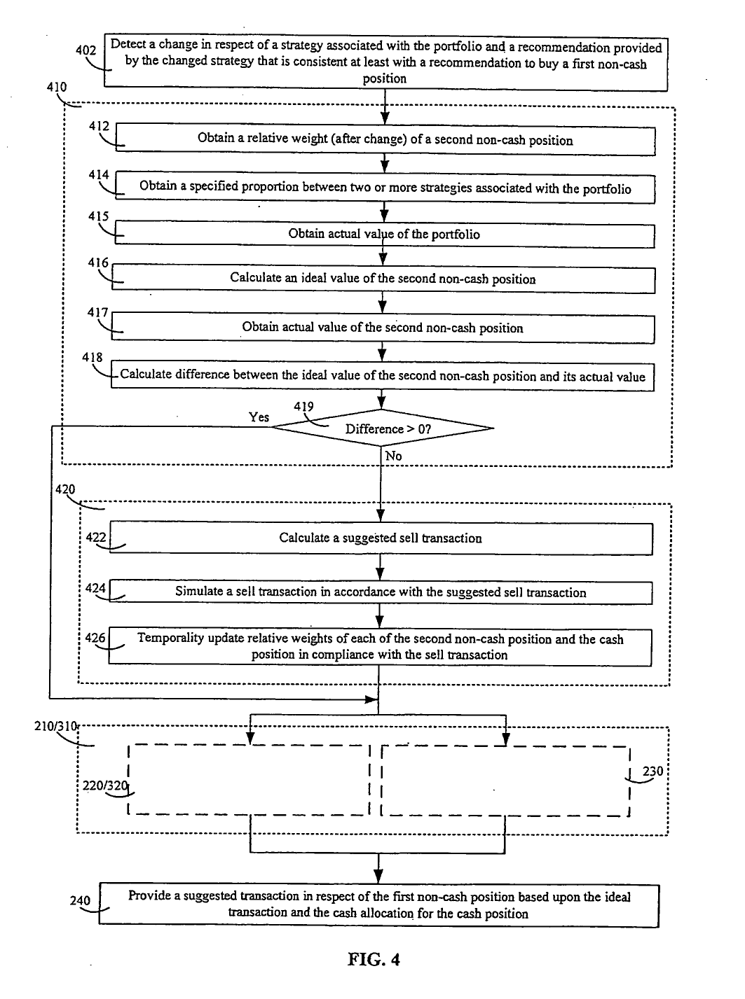

Reference is now made to FIG. 4, which is a flowchart illustration of a method of providing a suggested transaction in a multi-strategy (two or more strategies) investment portfolio, each strategy providing recommended cash and non-cash positions and wherein a change provided by at least one of the strategies provides explicit or implicit relative weights in respect of a non-cash positions which are consistent at least with a recommendation to sell a first non-cash position and with a recommendation to buy a second non-cash position. Before the description of FIG. 4 is provided below, it should be appreciated that FIG. 4 and the discussion in respect of FIG. 4 provided herein generally relate to a process of providing a suggested transaction when a strategy provides changes in respect of at least a first and a second non-cash position and wherein the changes specify explicitly or implicitly a recommended relative weight for each of the first and the second non-cash positions. For illustration purposes, in FIG. 4, and in the discussion in respect of FIG. 4 provided herein, the recommended (explicit or implicit) relative weight in respect of the first non-cash position is consistent with a recommendation to sell the non-cash position (or a portion thereof); and the recommended relative weight in respect of the second non-cash position is consistent with a recommendation to buy the non-cash position, as will be discussed in detail below.

It would be appreciated that FIG. 4 and the discussions provided herein in respect of FIG. 4 may be applied mutatis-mutandis so that a process of providing a suggested transaction may be implemented in respect of changes provided by a strategy, when the changes are in respect of at least a first and a second non-cash position and wherein one of the changes specifies explicitly or implicitly a recommended portion of available cash that is to be used for buying the first non-cash position, and one other change specifies explicitly or implicitly a portion of the second non-cash position that is to be sold.

According to some embodiments of the invention, a process for providing a suggested transaction for an investment portfolio may be triggered when a change is detected in respect of one of two or more strategies associated with the portfolio. According to some embodiments of the invention, the process that is intended for providing a suggested transaction may be triggered when a change provided by a strategy in respect of a non-cash position specifies explicitly or implicitly a recommended relative weight for the non-cash position, and the recommended relative weight is consistent with a recommendation to buy the non-cash position (block 402). As mentioned above, whenever necessary, a buy recommendation consistency test may be implemented in order to determine whether a change provided by a strategy is consistent with a recommendation to buy a non-cash position. For example, when, as part of a strategy change, there is provided an explicit or implicit relative weight for a non-cash position, a buy recommendation consistency test may be implemented in order to determine whether the relative weights provided (explicitly or implicitly) for the non-cash position are consistent with a recommendation to buy a non-cash position. It should be appreciated that, according to some embodiments of the invention any change in respect of a non-cash position which may be transformed into a recommendation to provide a certain relative weight for the non-cash position may be considered as providing (implicitly) a relative weight in respect of the non-cash position.

According to some embodiments of the invention, upon initiation of the process of providing a suggested transaction, a sell recommendation consistency test may be implemented (block 410). According to some embodiments of the invention, similar to the buy recommendation consistency test, but inversely thereto, the sell recommendation consistency test is based upon detecting a difference between an actual value of a non-cash position and an ideal value of the same non-cash position. According to some embodiments of the invention, the sell recommendation consistency test may indicate that a recommended relative weight, provided explicitly or implicitly in respect of a non-cash position, is consistent with a recommendation to sell the non-cash position, when the actual value that is associated with the position is greater than the ideal value of the position. It would be appreciated that the sell recommendation consistency test may be required to determine whether a recommended relative weight provided (explicitly or implicitly) in respect of a non-cash position is consistent with a recommendation to sell the non-cash position. However, if the recommendation that is used as part of the process of suggesting a transaction provides or is translated to provide a (specific) portion of the non-cash position that is to be sold, then the recommendation to sell is inherent and there is no need for an elaborate sell recommendation consistency test such as the one used in case the recommendation provides or is translated to provide a relative weight for the non-cash position.

Returning now to a detailed description of the sell recommendation consistency test, according to some embodiments of the invention, as part of the sell recommendation consistency test, a recommended relative weight (specified explicitly or implicitly) of a non-cash position may be obtained (block 412). When the sell recommendation consistency test is implemented in respect of a non-cash position whose relative position has been modified (for example, as part of the strategy change), the relative weight obtained for that non-cash position as part of the sell recommendation consistency test is the relative weight provided for the position after the change. It would be appreciated that the recommended relative weight provided (explicitly or implicitly) in respect of a non-cash position as part of a strategy change is the relevant relative weight after the change, rather than, for example, a relative weight recommendation in respect of the non-cash position as provided (explicitly or implicitly) prior to the change.

Further as part of the sell recommendation consistency test (block 410) and in addition to the recommended relative weight (specified explicitly or implicitly) of the non-cash position, a specified proportion between the two or more strategies associated with the portfolio may be obtained (block 414), and an actual (market) value of the portfolio may also be obtained or calculated, as described in further detail above (block 415).

Example 6, to which reference is now made, includes multi-strategy portfolio P6 which is associated with strategies S1 and S2, and holdings in assets as detailed below the strategies S1 and S2 listings.

### Example 6

P6
S1 (40%)

| | |
|---|---|
| Cash: | 80% |
| IBM: | 20% |

S2 (60%)

| | |
|---|---|
| DOX: | 0%→90% |
| DIS: | 10% |
| GMC: | 5%→0% |
| Cash: | 85%→0% |

### P6 Holdings:

| | |
|---|---|
| IBM: | USD 10,000 |
| DOX: | USD 0 |
| DIS: | USD 10,000 |
| GMC: | USD 1,000 |
| Cash: | USD 179,000 |
| P6 Actual Value: | USD 200,000 |

Next, an ideal value for the non-cash position may be computed (block 416). The ideal value of the non-cash position may be calculated based upon each of the following: the relative weight of the non-cash position; the specified proportion between the two or more strategies associated with the portfolio; and the actual (market) value of the portfolio.

With reference to portfolio P6 which is provided as part of Example 6, as can be seen, GMC position is entirely removed from the changed strategy. Since there is some actual value associated with the GMC position, the strategy change is consistent with a recommendation to sell the GMC position (the entire position in this case). However, in order to provide an example of the sell recommendation consistency test, calculations should be applied which may be carried out as part of a sell recommendation consistency in respect of the GMC position to provide an example of an application of the sell recommendation consistency test. The following calculations provided with reference to the GMC position may be used to determine whether the change in respect of the GMC position is consistent with a recommendation to sell the GMC position:

idealValue_{GMC.S2}=relativeWeight_{GMC.S2}×proportion_{S2}×value_{P6}

As mentioned above, in portfolio P6, the recommended relative weight for GMC is 0, and accordingly the ideal position value for GMC is also zero. A record in respect of the GMC position may be removed from strategy S2. However, in accordance with further embodiments of the invention, strategy S2 may keep a record of the GMC position and may allocate the GMC position a relative weight of zero or an equivalent of a zero relative weight.

Referring back to FIG. 4, further as part of the sell recommendation consistency test, an actual value of the non-cash position may be obtained (block 417). In example portfolio P6, the actual value of the GMC position is USD 1,000. Next, a difference between the ideal value of the non-cash position (after the change) and the actual value of the non-cash position is calculated (block 418). In example portfolio P6, the difference between the ideal value of the GMC position and the actual value of the GMC position is −USD 1,000.

Based upon the difference between the ideal value of the non-cash position (after the change) and the actual value of the non-cash position, it is then determined whether the recommendation in respect of the non-cash position is consistent with a recommendation to sell the non-cash position. According to some embodiments of the invention if the difference between the ideal value of the non-cash position (after the change) and the actual value of the non-cash position is below zero, it is determined that the recommendation in respect of the non-cash position is consistent with a recommendation to sell the non-cash position (block 419). If the difference is zero or above (positive) there is no recommendation to sell the non-cash position. According to further embodiments of the invention, if the difference is above zero (positive) it is concluded that the change in respect of the non-cash position is consistent with a recommendation to buy the non-cash position. If consistency with a recommendation to buy a non-cash position is established, this information may be used elsewhere in the process of providing a suggested transaction.

It should be appreciated that in some embodiments, consistency with a recommendation to buy or to sell is established more directly based on the format of the strategy change. For example, a change to buy GMC using 40% of cash or to buy GMC using 10% of the model portfolio recommended by the strategy are interpreted by some embodiments as being consistent with a recommendation to buy (without necessarily calculating the difference between ideal and actual values of the changed position). Similarly, an explicit or implicit change recommending selling 20% of the GMC holding may be interpreted according to some embodiments as being consistent with a recommendation to sell.

Once the sell recommendation consistency test is completed, the process of suggesting a recommended transaction is continued. According to some embodiments of the invention, in case in accordance with the sell recommendation consistency test it has been established that a change position by a strategy in respect of a non-cash is consistent with a recommendation to sell the non-cash position (or some portion thereof), a sub-process for simulating a sell transaction in respect of the non-cash position (block 420) may be executed. The sub-process for simulating a sell transaction in respect of the non-cash position (block 420) shall be discussed in greater detail below.

If however, in accordance with the sell recommendation consistency test or otherwise, it is determined that none of the non-cash positions provided by the strategies associated with the portfolio are consistent with a recommendation to sell a non-cash position, a process of suggesting a recommended transaction (block 210) similar to the process discussed above with reference to FIG. 2 may be executed in connection with the recommendation to buy the non-cash position which was detected at block 402.

As mentioned above with reference to FIG. 2, the process of suggesting a recommended transaction (block 210) may include a first sub-process that is intended for computing an allocation of cash for the strategy which is associated with the recommendation to buy the non-cash position (block 220) and a second sub-process that is intended for calculating an ideal transaction in connection with the recommendation to buy the non-cash position (block 230). For a more detailed discussion of the processes and sub-process associated with blocks 210, 220 and 230, the relevant portions of FIG. 2 may be referred to. It would be appreciated that a recommendation that is consistent with a sell transaction (selling a second non-cash position) may be provided or may be translated to provide a certain portion of cash which is to be used for buying the first non-cash position, and that in such cases, the process of suggesting a recommended transaction may be modified accordingly.

Returning to block 420 of FIG. 4, as mentioned above in some embodiments, if it is determined in accordance with the sell recommendation consistence test that a relative weight provided in respect of a non-cash position is consistent with a recommendation to sell the non-cash position (or some portion thereof), a sell transaction in respect of the non-cash position may be simulated. According to some embodiments of the invention, a suggested sell transaction may be calculated based upon the difference between an ideal value of a non-cash position which is associated with the recommendation to sell and an actual value of the non-cash position (block 422). For example, with reference to portfolio P6, a suggested sell transaction for the GMC position may be calculated based upon the −USD 1,000 difference between the ideal value of the GMC position and the actual value of the GMC position. According to some embodiments of the invention, in addition to the difference between an ideal value of a non-cash position which is associated with the recommendation to sell and an actual value of the non-cash position, the suggested sell transaction may be calculated in accordance with one or more predefined constraints. The predefined constraints which may be considered as part of calculated a suggested sell transaction may include, but are not limited to the following non-limiting examples: a transaction must have a minimal size, a transaction should not include fractions of shares (i.e., number of shares must be an integer number), transaction must have minimal number of shares, there should be at least a minimal number of shares held after a selling transaction is simulated/executed, etc. . . . ). As in the buy transaction, in certain embodiments, further processing of the suggested transaction involves computing the number of units (if relevant), divide into multiple accounts and changing (even canceling) the transaction to fit the constraints including the final editing of the transaction by an operator.

According to some embodiments of the invention, once a suggested sell transaction is computed, the affects of executing this transaction may be computed using simulation of executing the transaction within the context of the portfolio and its holdings, and the new holdings within the portfolio resulting from the execution, and new relative weights which may be the result of the recommendation/change to which this transaction is related may be temporarily updated. Thus, temporary updates may be carried out according to some embodiments in order to bring into account these updates before considering other recommendations that depend on the previous ones. In some embodiments, a sell transaction may be simulated in accordance with the suggested sell transaction (block 424) and for each of the non-cash positions to which the suggested sell transaction relates and the cash position of the strategy which is associated with the non-cash position a relative weight may be (temporarily) updated in compliance with the recommended change or with the suggested sell transaction simulation (block 426). In accordance with some embodiments of the invention, a simulation of a sell transaction does not include actual selling of holdings in the portfolio. However, it would be appreciated that the relative weights of the non-cash position, the non-cash asset holding associated with the suggested sell transaction and the cash holding which have been updated as a result of the simulation may influence other suggested transactions. According to some embodiments of the invention, the simulation of the selling transactions may affect (temporarily) the cash holding of the portfolio and the relative weight of the cash and non-cash positions associated (or related) with the simulated sell transaction. For example, with reference to portfolio P6 that is provided as part of example 6, the simulated transaction associated with the recommendation to sell the GMC position may cause the cash holding in the portfolio to temporarily increase by USD 1000, the cash position relative weight temporarily becomes 90%, the GMC holding to temporarily become zero and the GMC position relative weight to temporarily become zero. These temporary simulated updates to the portfolio holdings and strategy position weights may influence the suggested transaction provided in respect of the recommendation to buy the DOX position.

According to a certain embodiment of the invention, if it is determined in accordance with the sell recommendation consistency test that a relative weight provided for a non-cash position is consistent with a recommendation to sell the non-cash position (or some portion thereof), and subsequently a sell transaction in respect of the non-cash position is simulated, the process that is intended for providing a suggested transaction (block 210 in FIG. 2) in respect of the buy recommendation detected at block 402 may be carried out using the updated relative weights and the updated actual holding values. Similarly, the two sub-processes which are part of the process that is intended for providing a suggested transaction (block 210), namely the first sub-process that is intended for computing an allocation of cash (block 220) for the strategy that is associated with the buy recommendation detected at block 402, and the second sub-process that is intended for calculating an ideal transaction in connection with the recommendation to buy the non-cash position (block 230), may be carried out using the updated relative weights and the updated holdings (after the simulation). As mentioned above as an alternative to the process of suggesting a transaction (block 210) described with reference to FIG. 2 above, the process of suggesting a recommended transaction (block 310) described with reference to FIG. 3 may be used, depending upon the recommendation (or the translated recommendation) provided in respect of the non-cash position. Similarly, as an alternative to the above, the process of suggesting a transaction for a recommendation to buy a portion of a strategy (or portion of a model portfolio) (described above) may be used.

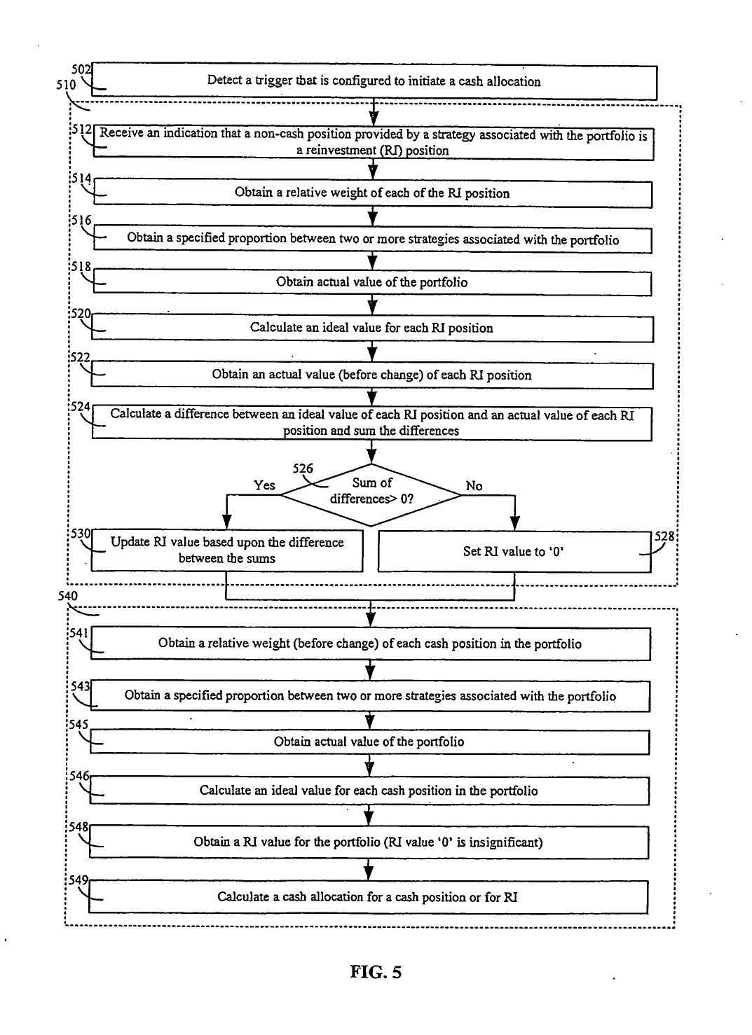

Reference is now made to FIG. 5, which is a flowchart illustration of some aspects of a method of providing a suggested transaction for a multi-strategy investment portfolio wherein at least one of the positions is considered or defined as being a reinvestment (hereinafter also “RI”) position. In some embodiments of the invention, a cash amount that is larger than what is needed for ideal cash positions may be used for pro-active re-investment in certain positions which are considered or defined as positions for reinvestment (RI positions). Reinvesting is the process of using or consuming or expending new cash or cash in abundance by buying into recommended strategy positions which are considered or defined as reinvestment positions. In certain embodiments, not all positions are considered for or defined as RI positions, since for example, some strategies do not recommend pro-active buying into existing positions unless explicitly recommended by a change. On the other hand, in some embodiments, certain strategies (e.g. passive strategies) may be consistent with or even recommend pro-active re-investment when cash is in abundance or new money is injected or otherwise introduced into the portfolio. In some embodiments, when cash allocation is calculated in order to accommodate for a strategy change consistent with a buy transaction/recommendation, it may be necessary for the cash allocation process to consider a certain cash amount (RI value) that should be allocated for reinvestment in RI positions.

As described above, in some embodiments, cash allocation may be intended for bringing into an account various needs for reserving cash within the portfolio rather than just considering the requirement of the changed strategy. One process that may require such cash reserving is the process of reinvestment. The process of reinvesting and the search for optimized reinvesting suggested transactions will be described in detail below. The following discussion describes the calculation of a reinvestment amount (RI value) and the use of the reinvestment amount within the process of cash allocation.

According to some embodiments of the invention, initially a strategy change may be detected in respect of a non-cash position. The change may provide a recommendation in respect of the non-cash position, which may be determined to be consistent with a buy transaction. Detailed discussions in respect of detecting a strategy change and in respect of determining that a strategy change is consistent with a recommendation to buy a non-cash position have been provided above. When a strategy change that is consistent with a recommendation to buy is detected (block 502) a process of updating a reinvestment value may be triggered (block 510). It would be appreciated that according to some embodiments of the invention, the process of updating a reinvestment value may be implemented as part of or in association with a process of allocating cash to a changed strategy. In addition, in some embodiments, the process of calculating the reinvestment value may be implemented as part of or in association with proactive reinvestment, where superfluous actual cash is identified (cash in abundance) and part (or whole) of the superfluous actual cash is allocated for the purpose of reinvesting in current positions which are considered for or defined as RI.

It should be appreciated that as explained above, a trigger for proactive reinvestment may be in some embodiments, the flow of new money into an associated account or a significant change in the market value of certain positions. Calculating the RI value that needs to be allocated for reinvestment in certain embodiments, is detailed below.

A “reinvestment value” or “RI value” or “RI amount” as used herein, shall be used to describe a certain value represented, for example, by a cash amount which may be calculated for a portfolio associated with at least one strategy recommending at least one non-cash position. The RI value corresponds to the differences between an ideal value of each position that is a RI position and the actual value of that position. An example of a process of computing a RI value in a portfolio is provided below. According to some embodiments of the invention, some portion of the cash available may be allocated for RI. The cash allocation for RI may, according to some embodiments may be used for the purpose of re-investing in one or more RI positions. The proactive RI process that is related to consuming (or expending) the allocated RI amount is described further below.

When a trigger for a process of updating a reinvestment value is detected, the process of updating a reinvestment value may be initiated (block 510). As part of the process of updating a reinvestment value (block 510), an explicit or implicit indication may be obtained in respect of a non-cash position provided by a strategy that is associated with the portfolio (i.e., a strategy with which the portfolio is associated) that the non-cash position is a RI position (block 512). According to some embodiments of the invention, a strategy may be defined (explicitly or implicitly and/or by way of default) as a RI strategy, and as a consequence, each of the non-cash positions provided by the strategy may be automatically regarded as being RI positions. According to further embodiments of the invention, the whole portfolio may be defined explicitly or implicitly as a RI portfolio, and as a consequence, each of the strategies associated with the RI portfolio may be considered to be a RI strategy. According to further embodiments of the invention, a position in respect of which a recommendation is provided to buy or sell the position (or a portion thereof), and/or a position in respect of which a change is provided which specifies a changed recommended relative weight for the position, may (temporarily) be excluded from being considered as a RI position. It would be appreciated that a position in respect of which a recommendation to buy/sell is received or a recommendation that is consistent with a buy/sell may be handled as part of a process which is intended to provide a suggested transaction in respect of that position. It should be appreciated that in some embodiments of the invention, the process of calculating a RI value may be triggered by certain events that may affect cash allocation and may result in further “buy” suggested transactions. For example, a change in the cash holding of a certain account may trigger a re-investing of new cash and therefore may trigger the calculation of a RI value. Thus, in some embodiments there may be no need to re-calculate the RI value for the cash allocation process and a previously calculated RI value may be used.

The process of updating a reinvestment position may continue with respect to positions that are RI positions. Further as part of the process of updating a RI value, a relative weight of each of the non-cash positions which are RI positions may be obtained (block 514). According to some embodiments of the invention, a RI value may be calculated based upon the relative weights of the non-cash positions which are RI positions after all applicable sell transaction simulations (if any) and any previous buy transaction simulations (if any) and prior to implementing a current buy recommendation.

Next, or in parallel with obtaining the relative weights of the non-cash position, each of the following may be obtained: a specified proportion between the two or more strategies associated with the portfolio (block 516) and an actual (market) value of the portfolio (block 518). Next, an ideal value may be calculated for each non-cash RI position (block 520). The ideal value of a non-cash position that is a RI position may be calculated based upon each of the following: a relative weight of the position that is a RI position, the specified proportion between the two or more strategies associated with the portfolio and the actual (market) value of the portfolio. Calculating an ideal value was described above in further detail. Additionally, an actual value may be obtained for each non-cash position that is a RI position (block 522).

### Example 7

P7
S1 (40%)

| IBM: | 20% (RI Position) |
|---|---|
| Cash: | 80% |

S2 (60%)

| | |
|---|---|
| DOX: | 0%→90% |
| DIS: | 10% |
| Cash: | 90%→0% |

### P7 Holdings:

| | |
|---|---|
| IBM: | USD 10,000 |
| DOX: | USD 0 |
| DIS: | USD 10,000 |
| Cash: | USD 180,000 |
| P7 Actual Value: | USD 200,000 |

As is indicated above the IBM position in strategy S1 is a RI position. Accordingly, as described above with reference to block 520, an ideal value may be calculated for each non-cash position that is a RI position. In the case of portfolio P7 the IBM provided by strategy S1 is the only position that is a RI position. The ideal value of the IBM position recommended by strategy S1 is as follows:

idealPositionValue_{IBM.S1}=relativeWeight_{IBM.S1}×proportion_{S1}×value_{P7}

Thus:

idealPositionValue_{IBM.S1}=20%×40%×USD 200,000=USD 16,000

The actual value of the IBM non-cash RI position is, as provided above, USD 10,000. Detailed discussions relating to the calculation of an ideal value and an actual value of a position were provided above.

Once the ideal value and the actual value of each position in the portfolio that is a RI position are available, a difference between the ideal value of and the actual value of the position that is a RI position may be calculated (block 524). Referring to example 7, as the only position that is an RI position is the IBM position, a difference between the ideal value and the actual value is calculated only for the IBM position. The ideal value of the IBM position in strategy S1, as calculated above, is USD 16,000, and the actual value of the IBM position provided by strategy S1 is USD 10,000. Accordingly, the total (sum) of the differences (block 526) between the ideal value of each of the non-cash positions provided by strategy S1 (namely the IBM position) and the actual value of each of the non-cash positions provided by strategy S1 is USD 6,000.

According to some embodiments of the invention, as part of the process of updating a RI value, a ‘diff’ value maybe defined. Provided below is a mathematical expression illustrating the calculation of a diff value for portfolio P

$${diff}_{P} = {\sum }_{i}^{ } ( {idealValue}_{( i , s )} - {actualValue}_{( {i}^{′} s )} ) \qquad Eq . 6$$

Where the diff value of portfolio P may correspond to the sum of all differences between an ideal value of each of the non-cash positions ((ideal Value of position i recommended by strategy S) that are RI positions and the corresponding actual value (actual Value of position i recommended by strategy S) of each one of the positions (i) that are RI positions.

Accordingly, in example 7, the sum of differences (diff) related to portfolio P7 which includes only one position that is an RI position (i.e., IBM position provided by strategy S1) is calculated as follows:

diff_{P7}=USD 16,000−USD 10,000=USD 6,000

Since the sum of differences is positive the RI value according to example 7 is USD 6,000.
As another example for calculating the RI value, consider example 7′ which is a modified version of example 7. In the modified portfolio P7′ of example 7′, the position DIS recommended by strategy S2 is also considered a RI position. Thus, there are two RI positions in P7′ instead of just one. As a consequence, the difference between the ideal values of the DIS position recommended by S2 needs to be calculated as follows:

idealPositionValue_{DIS.S2}=10%×60%×USD 200,000=USD 12,000

Consequently, the difference between the ideal value and the actual value for the DIS position recommended by S2 is calculated to be: 12,000−10,000=USD 2,000
Thus the total of differences in P7′ is:

diff_{P7′}=6,000+2,000=USD 8,000

It should be appreciated that according to some embodiments of the invention, the diff value of the portfolio (as a non-limiting example, when all positions are considered as RI positions) may be calculated by subtracting the sum of all ideal cash positions recommended explicitly or explicitly by strategies with which the portfolio is associated from the (market) value of the cash holding within the portfolio as in the following mathematical expression:

diff_{P}=CashHolding_{P}−ΣidealValue_{(cash,s)} Eq. 6′

Wherein cashHolding of P is the (market) value of the cash holding in portfolio P, idealValue_{cash.S} is the ideal value of the cash position recommended by strategy S. The ideal values of cash positions may be totaled for every cash position recommended by a strategy with which the portfolio is associated.

As a non limiting example, consider P7′ of example 7′. The cash holding of P7′ is USD 180,000. The ideal value of the cash position recommended by strategy S1 is 200,000*40%80%=USD 64,000; the ideal value of the cash position recommended by S2 (before the change is applied) is 200,000*60%*90%=USD 108,000. Thus, the diff of P7′ is:

diff_{P7′}=180,000−(64,000+108,000)=USD 8,000

It should be appreciated that for RI value calculation, certain embodiments of the invention may use mathematical expressions that are equivalent to the above equation 6 or equation 6′ and are derived from these mathematical expressions using algebraic manipulation and/or based on the definitions above. It should also be appreciated that under some assumptions and some algebraic manipulations, equation 6 and equation 6′ may be equivalent and therefore may provide the same results.

Next, having calculated the RI value for the portfolio, the RI value is checked to determine whether it is positive or not (block 526). According to some embodiments of the invention, in case the RI value is not positive (negative or zero), the RI value is set to zero (block 528). Otherwise, a non-zero RI value is updated in accordance with the difference (block 530). It would be appreciated that, according to some embodiments of the invention, the RI value is set to zero when the sum of actual values of the non-cash positions that are RI positions (or the sum of differences) is greater than the sum of the ideal values of the positions that are RI positions or when these sums are equal.

It should be appreciated that according to the laws of mathematics, certain embodiments may calculate the sum of differences in various different ways. For example, some embodiments may total the differences related to each RI position while other embodiments may subtract the sum of actual values related to each of the RI positions from the sum of ideal values related to each one of the RI positions.

It should also be appreciated that in some embodiments of the invention only positive differences may be summed (i.e., where an ideal value is greater than the corresponding actual value). In some embodiments of the invention, the sum of positive differences represents cash that is needed (i.e., should be reserved) in order to reinvest in RI positions that have actual value that is less than ideal. Other embodiments that include summing all the differences related to RI positions (both positive and negative) reserve only the cash that is needed for reinvesting after selling (possibly only portions) of RI positions with negative differences. Using the sum of all differences may reserve less cash for reinvestment than if the sum of only positive differences is used. According to some embodiments, a sum of positive differences may be used when it is assumed that no rebalancing or selling of positions with negative differences will be carried out. According to other embodiments of the invention, a re-balancing process (which includes selling positions with negative difference) may be used to generate additional cash for reinvestment. In certain embodiments a selling of positions with negative differences (i.e. positions whose actual value is greater than their corresponding ideal value) may complement and precede, for example, a RI process where the sum of positive differences is used.

Referring back to FIG. 5, according to some embodiments of the invention if the portfolio has a positive RI value (e.g., having a RI value that is larger than zero after totaling all differences), cash may be allocated for the RI positions which means that there may be extra cash that may be used for re-investment; i.e. if RI value is positive, that may mean in some embodiments that the cash holding in the portfolio is larger than the sum of ideal cash values. According to some embodiments of the invention, a process for allocating (reserving) cash for the RI value may be implemented (block 540). According to some embodiments of the invention, the process for allocating cash for the RI value (block 540) may be implemented as part of a process that is intended for calculating an allocation of cash for a changed strategy (block 220 in FIG. 2 or block 320 in FIG. 3). The process for calculating an allocation of cash for a changed strategy may itself be implemented as part of a process that is intended to provide a suggested transaction. It would be appreciated that by allocating (or reserving) cash for reinvestment in the amount specified by the RI value as part of or in conjunction with a process that is intended to allocate cash for a changed strategy (the cash may be used for a transaction to buy a non-cash position), some of the available cash may be diverted from being used to accommodate the strategy change and may be thus reserved for a future reinvestment process.

As mentioned above, according to some embodiments of the invention, the process of calculating a RI value may be triggered when a change in respect of a strategy associated with the portfolio is detected and when a recommendation provided by the changed strategy is consistent at least with a recommendation to buy a non-cash position. As was also discussed above in further detail, for example, with reference to FIG. 2 and FIG. 3, a process that is intended for providing a suggested transaction may also be triggered when a strategy change is detected and when a recommendation provided by the changed strategy is consistent at least with a recommendation to buy a non-cash position. As mentioned above, the process that is intended for providing a suggested transaction includes a sub-process that is intended for computing an allocation of cash at least for the cash position recommended by the changed strategy. Therefore, according to some embodiments of the invention, the process of allocating cash for the RI value (block 540) may be implemented as part of or in conjunction with a process that is intended for calculating an allocation of cash for a changed strategy. The process that is intended for calculating an allocation of cash for a changed strategy may be implemented as part of a process that is intended to provide a suggested transaction.

Returning now to FIG. 5, according to some embodiments of the invention, the process for allocating cash for the RI value (block 540) may include the following: obtaining a recommended relative weight for each cash position in the portfolio (block 541), obtaining a specified proportion between two or more strategies associated with the portfolio (block 543) and obtaining an actual (market) value of the portfolio (block 545). According to some embodiments of the invention, once the relative weights of the cash positions, the specified proportion between the strategies and the actual (market) value of the portfolio are obtained, an ideal value may be calculated for each cash position in the portfolio (block 546). In addition to the examples provided above in respect of calculating and ideal value, a further example of calculating an ideal value is provided below. Additionally, as part of the cash allocation process, the RI value of the portfolio (zero RI value is insignificant in this context) may be obtained (block 548).

Once the ideal values for each cash position in the portfolio and the RI value for the portfolio are calculated and obtained, a cash allocation for each cash position and for the investing needs in the portfolio may be calculated (block 549). According to some embodiments of the invention an allocation of cash for a cash position or for reinvestment may be calculated based upon the following: the ideal value of the cash positions, the RI value of the portfolio, and the actual (market) value of the portfolio.

As previously described, in certain embodiments of the invention, the actual cash holding in the portfolio may be divided proportionally according to the different cash reservation needs. These cash reservation needs may include in some embodiments, cash that should be reserved for cash positions of the strategies with which the portfolio is associated (ideal cash values) and cash that should be reserved ideally for reinvestment (RI value). Equation 7 below is a mathematical formula denoting the allocation of cash to the cash position of strategy S1 using a proportion of cash reservation needs that includes ideal values of cash positions (of strategies with which the portfolio is associated) and also includes the RI value calculated above:

$${cashAllocation}_{cash \cdot S 1} = {actualCash}_{P} \times \frac{{idealPosition}_{cash \cdot S 1}}{{\sum }_{m = 1}^{n} {idealPosition}_{cash \cdot Sm} + {RIvalue}_{P}} \qquad Eq . 7$$

Where, in order to calculate the allocation of cash (cashAllocation) for the cash position recommended by strategy S1, the actualCash of P which is the total cash holding within portfolio P, is multiplied by the ratio between the ideal value of the cash position recommended by S1 (idealPosition) and the sum of all the values related to needs for cash reservation which includes the sum of all ideal values of the cash positions recommended by strategies (Sm) with which the portfolio is associated plus RIvalue which is the RI value computed for portfolio P and that needs to be reserved for reinvestment.

Referring to portfolio P7 which is part of example 7, an allocation of cash for the cash position provided by strategy S1 may be computed in accordance with the above mathematical expression Eq 7: Thus:

Given that the ideal cash position of the cash position provided by strategy S1 is:

idealValue_{cash.S1}=80%×40%×200,000=USD 64,000

and ideal cash position for the cash position provided by or induced from strategy S2 is:

idealValue_{cash.S2}=90%×60%×200,000=USD 108,000

The RI-value for reinvestment is USD 6000 (as calculated above). Then the cash allocation (that is reserved) for the cash position of strategy S1 is:

cashAllocation_{cash.S1}=180,000×64,000/[(64,000+108,000)+6,000)]≈USD 64,710

It should be appreciated that equation 7 above is an example of allocating cash for the cash position of strategy S1 based on a proportion between (among) the various cash reservation needs (of some cash positions and of reinvestment). A similar calculation based on the same proportion of cash reservation needs may be carried for calculating the cash allocation (reservation) for reinvestment. Thus, based on P7 of example 7, the cash allocation (reserved) for reinvestment in P7 may be:

cashAllocation_{RI}=180,000×6000/[(64,000+108,000)+6,000)]≈USD 6,067

Where the cash holding in the portfolio (USD 180,000) is multiplied by the ratio between the reinvestment cash reservation needs (RI value of USD 6,000) and the sum of all cash reservation needs which includes the sum of ideal values of the various cash positions and the RI value.

In accordance with other embodiments, there is provided another mathematical formula which may be implemented for calculating an allocation of cash for a cash position of the changed strategy.

$${cashAllocation}_{cash \cdot S 1} = ( {actualCash}_{P 7} - {RIvalue}_{P 7} ) \times \frac{{idealPosition}_{cash \cdot S 1}}{{\sum }_{m = 1}^{n} {idealPosition}_{cash \cdot Sm}} \qquad Eq . 8$$

In accordance with equation 8, the reinvestment value is allocated for reinvestment (exactly), while the rest of the cash holding is divided amongst the cash position in the portfolio. The rest of the cash holding is divided amongst the cash positions in proportion to their ideal values and may use, according to some embodiments, a ratio related to that proportion between an ideal value of a cash position and sum of the ideal values of cash positions recommended by the strategies with which the portfolio is associated. It would be appreciated that the calculation represented by equation 8, as opposed to the calculation represented by equation 7, allocates any cash left after the RI value to the cash position of the strategies (meaning that extra cash—if exists after R1-will benefit cash positions and thus be likely to produce larger suggested buy transactions upon strategy change), whereas in accordance with equation 7, reinvestment may also benefit from the extra cash.

It should be appreciated, that as was the case in Eq. 2, the possibility of dividing by zero should be avoided in both Eq. 7 and Eq. 8, for example, in case the denominator is equal to zero, the allocation for a cash position (of S1), may be zero or any number between zero and the actual cash value.

Reference is now made to FIG. 6, which is a flow diagram illustration of a method of calculating an actual value of a first non-cash position in a multi-strategy portfolio, where there is at least a second non-cash position which relates to the same asset as the first non-cash position. According to some embodiments of the invention, a multi-strategy portfolio may include two or more positions which relate to the same asset with non-zero relative weights. For example, a first strategy may provide a first position in respect of an IBM stock and a second strategy may provide a second position in respect of the same IBM stock. Thus, an actual value of a position may be required, in order to divide a holding in an asset, to which two or more non-zero positions in the portfolio relate, between the two or more positions. The process illustrated by FIG. 6 and described herein with reference to FIG. 6, is one example of a process which may be implemented according to some embodiments of the invention to divide a portfolio holding in an asset amongst two or more (non-cash) positions which relate to the (same) asset.

According to some embodiments of the invention, a process that is intended for calculating an actual value of a first non-cash and non-zero position, when there is as least a second non-cash non-zero position which relates to the same asset as the first non-cash position, may include detecting a request for an actual value of a first non-cash position (block 602). An actual value of a non-cash position may be required as part of various processes in respect of the portfolio, the strategy providing the non-cash position and processes in respect of the non-cash position itself. Examples of processes which require that actual value of a non-cash position be obtained or provided may include, but are not limited to: a buy/sell recommendation consistency test in respect of the non-cash position, calculation of a RI value (assuming that the non-cash position is a RI position), calculation of cash allocation, computation of a desired transaction for the non-cash position (specifically in accordance with the aspects of the invention described with reference to FIG. 2 and FIG. 3 above).

Once a request for an actual value of a (first) non-cash position is detected (at block 602), it may be determined in respect of which asset the (first) non-cash position provides a recommendation (block 604). Next, an actual (market) value of the holding in the asset is obtained (block 606).

The portfolio is then checked to determine whether there is any other (second) non-cash position which relates to the same asset as the first non-cash position (block 608).

In case it is determined that the asset is exclusively recommended by (first) non-cash position and there is no other non-cash positions which recommends (non zero) holding in the same asset, the actual value of the (first) non-cash position is determined to be equal to the actual (market) value of the holding in the asset (block 614).

However, if at block 608 it is determined that there is at least one other non-cash position (e.g., a second non-cash position) which recommends a non-zero holding in the same asset as the first non-cash position, a process that is intended for calculating an actual value for the first non-cash position, when there is at least one other (a second) non-cash position which recommends a holding in the same asset as the first non-cash position, may be initiated.

In accordance with some embodiments of the invention, a process that is intended for calculating an actual value for the first non-cash position, when there is at least one more (a second) non-cash position which recommends or is associated with a (non-zero) holding in the same asset as the first non-cash position, may include dividing the non-cash asset holding and designating an actual value allocation for each of the positions based upon a proportion between (among) values which are related to at least the first and second positions. The principles of the division of the asset holding according to a proportion of values for allocating an actual value are similar to the principles of the division of a cash holding according to a proportion of cash reservation needs which were described above for the purpose of cash allocation. In accordance with some embodiments of the invention, the values that may be used within the proportion may be the ideal values of at least the abovementioned first and second positions or they may be other related values as will be described below.

In accordance with some embodiments of the invention, a process within the Actual Value Calculator (which is part of the Portfolio Management Processor—block 130 in FIG. 1) that is intended for calculating an actual value for the first non-cash position associated with an asset, is responsive to there being at least one other (second) non-cash position which is associated (e.g. recommends a non zero holding) with the same asset as that with which the non-cash position for which the actual value is being calculated is associated. This process, implemented in some embodiments within the Actual Value Calculator (block 152 with reference to FIG. 1) may include calculating the actual value based at least upon a (market) value of said asset holding and further based upon a proportion amongst values related to each of a plurality of the non-cash positions that are associated with the same asset as that with which the non-cash position, for which the actual value is being calculated, is associated.

In accordance with some embodiments of the invention, a process for calculating the actual value for such a position may include obtaining a relative weight of each of a plurality of positions providing a recommendation in respect of the same said asset (block 612). For example, a relative weight may be obtained in respect of each of the first and the second non-cash positions associated with the same asset to which reference was made above. It would be appreciated that in case the relative weight in respect of any of the non-cash position is implicit, a process may be provided for translating the recommendation in respect of the non-cash position so that a relative weight is provided in respect of the non-cash position.

Next, a specified proportion between each of the strategies associated with the non-cash positions which relate to the same assets may be obtained (block 614). For example, a proportion between a first strategy that is associated with the first non-cash position and a second strategy that is associated with the second non-cash position, (which relates to the same asset as the first non-cash position), may be obtained.

In some embodiments of the invention, once the relative weights for the non-cash positions and the proportions between the strategies are obtained, an actual value may be computed for the first non-cash position (block 616) based upon a proportion between (among) ideal values of each of non cash positions which are associated with the same said asset. According to some embodiments of the invention, as an example, the actual value of the first non-cash position may be calculated based upon a proportion between ideal values by means of a ratio between the ideal value of the first position and a sum of ideal values of a plurality of positions associated with the same asset. For example the following expression may be used:

$${actualValue}_{nc , S 1} = {holding}_{nc , P} \times \frac{{idealPosition}_{nc \cdot S 1}}{{\sum }_{m = 1}^{n} {idealPosition}_{nc \cdot Sm}} \qquad Eq . 9$$

where:
holding_{nc,P} is a value in portfolio P of a holding in a non-cash asset (nc) which is recommended by at least both the first non-cash position and the second non-cash position; i.e., at least first and second positions are related to (e.g., recommending) the non-cash asset;
idealPosition_{nc.S1} is the ideal value of the position related to the non-cash asset (nc) which is recommended by strategy S1 (including first position recommended by S1 and second position recommended by S2). As described above, the ideal value of a position may be calculated based upon a relative weight explicitly or implicitly recommended by strategy Si and further based upon the proportion between (among) the strategies. It should be appreciated that, as was described above, for the cash allocation process, the actual (market) value of the portfolio may be used, but is not mandatory when a ratio between ideal values is to be calculated (i.e., as in equation 9).
actualValue_{nc.S1} is the calculated actual value for the first non-cash position based upon the value of the asset holding and the proportion among ideal values of at least the first and second positions.

In further embodiments of the invention, a proportion between (among) other types of values (rather than ideal values) related to the positions which provide recommendations to, or which are related to the same asset, may be used. For example, the value of the asset holding may be multiplied by the number of units derived or implied from historical transactions related to changes to the first position, and is divided by the total number of units derived or implied from historical transactions, related to changes provided by at least said first and second positions. In some embodiments, historical transactions may be suggested transactions, executed transactions or transaction orders that are logged and/or stored in a transactional data base. According to some embodiments of the invention, the actual value of the first non-cash position may be calculated using a ratio as in the following expression:

$${actualValue}_{nc \cdot S 1} = {HoldingValue}_{nc} \times \frac{{Units}_{nc \cdot S 1}}{{TotalUnits}_{nc , P}} \qquad Eq . 10$$

where:
HoldingValue_{nc} is a (market) value within a portfolio of a holding in an asset (nc) to which both the first non-cash position and the second non-cash position are related; i.e. first and second positions recommend the same asset (nc).
Units_{nc.S1} is a non-zero number of units which may be derived from historical transactions (including suggested transactions, executed transactions or transaction orders) related to (historical) changes related to first position provided explicitly or implicitly by strategy S1. In some embodiments of the invention, instead of units, other types of values may be used which represent amounts that may be derived from transactions related to a (first) position recommended by strategy S1. Units, amounts or (in general) transactional values may be extracted or derived in some embodiments from historical transactions that are found in a historical database that stores such entities. In some embodiments, these transactional values are derived by simulating (or computing the effects of) the historical transactions stored in the database and that are related to S1 (or with changes provided by S1) and calculating the abovementioned value related to the position recommending the asset nc within strategy S1.
TotalUnits_{nc,P} is a non-zero total number of units (or amount or another value type) related to the nc asset in portfolio P. According to some embodiments of the invention, the TotalUnits_{nc,P} may be derived from historical transactions (including suggested transactions, executed transactions or transaction orders) related to changes to the asset (nc) or related to positions associated with (or recommending) that same said asset (nc). actual Value_{nc.S1} is the calculated actual value for the first non-cash position based upon the actual (market) value of the asset holding and the described proportion of values (e.g. units) related to at least the first and second positions.

It should be appreciated, that the calculation of the number of units (or other values) related to changes in a first asset position recommended by a strategy may be carried out by tracking historical suggested transactions generated as a result of (past) changes with respect to the strategy or with respect to the positions recommended by the strategy. Similarly, one may track transactions, orders or executed transactions that are results of the suggested transactions or later interventions (in some embodiments, suggested transactions may be further modified by human or computerized processes.

As a non-limiting example, assume a historical transaction log(data base) that includes the recording of the following transactions. Each of the transactions was generated with respect to a certain strategy change and therefore each transaction is related to one of the strategies with which the portfolio was associated. In certain embodiments, these transactions may be either suggested transactions, orders submitted for execution following a strategy change or executed transactions which are a result of executing orders submitted):
1) buy 1000 units at 20 USDs per unit of asset X (related to S1)
2) buy 600 units at 21 USDs per unit of asset X (related to S1)
3) buy 1000 units at 22 USDs per unit of Asset X (related to S2)
4) Sell 100 units at 23 USDs per unit of asset X (related to S1)
   Assuming the portfolio holding of asset X is 10,000 USDs. The total number of units of asset X related to strategy S1 is 1000+600−100=1500 (by adding the units related to buy transactions 1 and 2, and subtracting units related to sell transaction 4, all transactions being related to strategy S1 and therefore related to the first position), whereas the number of units of X related to strategy S2 (second position) is 1000 (related to buy transaction number 3 above). The calculated actual value for the first position of asset X is therefore calculated according to equation 10 above by multiplying the actual (market) value of the asset holding of X by the ratio between the number of units related to the first position and the total number of units related to both first and second positions (recommended by both S1 and S2 strategies). Thus, the calculated actual value of the first position is: 10,000*1500/(1000+1500)=USD 6,000.

It should be appreciated that in certain embodiments of the invention, instead of units, other types of values related to each position (e.g. a total value of an asset purchased in USD by transactions related to changes in a position) may be calculated for each position recommending the same asset (as the first position) or per strategy, based on tracking historical transactions that are related to the asset with which the first and second positions are associated.

For example, consider the transaction log(data base) of the previous example. Instead of using a proportion between units of the first and second position, some embodiments may use a proportion between the USD values related to those positions. Such USD values may be derived from historical transactions by multiplying the number of units in each transaction by the unit price in each transaction and summing the results by adding values related to buy transactions and subtracting values related to sell transactions. Thus, the value associated with the first position which is recommended by strategy S1, is calculated by totaling 1000*20=USD 20,000 (USD value related to transaction 1); 600*21=USD 12,600 (USD value related to transaction 2); and −100*23=USD −2300 (USD value related to sell transaction 4) resulting in a value of 20,000+12,600−2300=USD 30,300 related to the first position. The value related to the second position is calculated as follows: 1000*22=USD 22,000. Thus, the actual amount calculated for the first position is: 10,000*(30,300/(30,300+22,000))=USD 5793.5. Using the same principle, an actual value may be calculated for the second position using the same proportion: 10,000*(22,000/(30,300+22,000)=USD 4,206.5) is the actual amount for the second position using the proportion between USD buy values of transactions associated to the abovementioned positions.

For clarity and generality, it should be appreciated that in accordance with some embodiments of the invention, dividing a value of an asset holding using (or according to) a proportion between a plurality of values and possibly implementing it by multiplying the value of the asset holding by a ratio between one of the values and a sum of plurality of values, is a general technique and principle used also in the cash allocation process above. In general, dividing a value of a holding H (be it a cash holding or a non-cash asset holding) using a proportion between n values (V₁:V2: . . . :Vi:, . . . :Vn) related to positions (or needs), and allocating a portion of the holding H to a particular position i (or need i) may be done by multiplying the value of the holding H by a ratio between a value Vi related to position i (or need i) and the sum of all the values: V1+V2+ . . . Vi+ . . . Vn, as in the following mathematical expression:

$${allocation}_{i , H , P} = H \times \frac{{V}_{i , P}}{{\sum }_{m = 1}^{n} {V}_{m , P}} \qquad Eq . {10}^{′}$$

Where, H is the holding to be proportionally allocated according to values related with positions or needs 1 to n.
P is a proportion (V1:V2: . . . :Vn) of values related to positions or needs.
V_{i,P} is the i-th value within the proportion; i.e., the value related to position/need i.
allocation_{i,H,P} is the result: amount allocated to position/need i, from Holding H using proportion P

It should be appreciated that examples of types of values within proportions given above include ideal values related to positions, RI-value that is related to a need for cash reservation, units or USD amounts related to positions and derived from historical transactions, etc.

As mentioned above, in accordance with some embodiments of the invention, a portfolio may be associated with a plurality of investment strategies. Each one of the plurality of investment strategies may be associated with a certain fraction of the portfolio, and thus the plurality of investment strategies may be associated with the portfolio according to a predefined proportion. For example, an investment portfolio may be defined according to some embodiments of the invention, whereby each one of three strategies (three being an example of a plurality) may be associated with a certain fraction of the portfolio as a whole, and the combination of all the fractions associated with each of the three strategies may be the whole portfolio or part of it. It would be appreciated that some assets, for example, stock securities, have dynamically changing market values, and thus the actual proportions between the strategies may vary according to market conditions as the portion of the portfolio that is associated with some strategies may become more valuable while other portions of the portfolio which are associated with other strategies may become less valuable. In other cases, some strategies represent a relatively steep value increase whereas other strategies' value increase more moderately. Therefore the actual proportions between different strategies that are associated with the portfolio may shift away from the proportion which was originally defined for the strategies with which the portfolio is associated.

Furthermore, each strategy may recommend positions in certain cash and/or non-cash assets. The recommendations may provide, explicitly or implicitly, a recommended model portfolio wherein each recommended position is assigned with a certain relative weight which represents the recommended portion for that position out of the strategy as a whole. Thus, for example, if a certain strategy recommends that out of a total of 10,000 US Dollars investment (that is associated with the strategy), 2,000 US Dollars be invested in IBM stock, a IBM stock position in a model portfolio which represents the strategy may be assigned a 20% relative weight value. Thus, each recommended position within a strategy, implies explicitly or implicitly an ideal value. In some embodiments, this ideal value is determined based upon a proportion among the strategies and a position relative weight; while in other embodiments this ideal value is given explicitly or is calculated based upon a provided weight and the portfolio market value. Examples of other forms of recommendation formats have been provided above. As will be apparent to one with ordinary skill in the art, the market value of a position may change from time, for example, the market value of IBM stocks may rise, and the actual relative weight of the IBM stock actual position may thus also change.

In some embodiments of the invention, each cash and non-cash position may have an actual value which is derived from the market value of the asset with which the position is associated. In some embodiments, as was described previously, when a plurality of positions relate to the same asset, the actual value of a position may also be derived from a proportion (or ratio) among values associated with the plurality of positions. The calculation of the actual value and the ideal value of a position in an investment portfolio that is associated with two or more strategies according to a predefined proportion between the strategies and where each strategy provides, explicitly or implicitly, a recommended relative weight with respect to cash and/or non-cash positions was discussed in greater detail above. It would be appreciated that both ideal and actual values of a certain asset may change according to market conditions as ideal values may be based on the market value of the portfolio whereas actual values may be based on the market value of the holding associated with the asset.

The following discussion provides a description of a method and a system for generating cash and/or for reinvestment of cash. In some cases and under certain circumstances, there may be a need to sell (or dispose) one or more assets which are part of a portfolio, for example, in order to generate a certain amount of cash. Non-limiting examples of circumstances which may trigger the sale of assets in order to generate cash may include, for example, a need for buying a certain asset when there is not enough available cash in the portfolio and a need to generate a regular cash flow (e.g., for a monthly stipend). Further examples of circumstances which may trigger the sale of assets in order to generate cash are described below.

It should be appreciated that although the description of some embodiments of the system and method according to the present invention refer to only cash generation, further embodiments of the invention are intended for both cash generation and for reinvestment. For convenience purposes some parts of the discussion are made with reference to cash generation only, whereas other parts also refer to reinvestment. However, it would be appreciated, that some of the teaching according to some embodiments of the invention may be equally applicable to both cash generation and reinvestment although one or the other is not explicitly mentioned in connection with each specific embodiment of the invention described herein.

In an investment portfolio, there may be various combinations of asset selling transactions which may generate approximately the needed cash amount. In many cases the number of possible asset selling transaction combinations may be quite large and each combination may bring about different results, such as, for example, different transactions fees, tax consequences, changes to a risk that is associated with the portfolio, and changes associated with a measure of imbalance(s) with respect to the portfolio (where an imbalance refers, for example, to the absolute value of a difference between actual and ideal values of a certain position within the portfolio), etc. An exhaustive search in the space of possible selling transactions while optimizing certain objectives may be an unrealistically long process. For example, consider a case where the goal is to generate 10,000 US Dollars by selling transactions in a portfolio that consists of 20 different assets, where each of the 20 assets is associated with a portfolio holding with a market value of 10,000 US Dollars. Assuming that the assets can be sold by increments of 100 US Dollars, there may be 100 different possibilities to sell each asset holding, resulting in an order of 100 in the power of 20 (100²⁰) possible combinations of selling transactions which should be considered as possible solutions. The search space becomes even larger, for example, if each holding has several tax lot possibilities which should also be considered.

Some embodiments of the invention relate to a method and a system for determining an asset selling vector in respect of an investment portfolio which is associated with a plurality of investment strategies according to a predefined proportion between the strategies, and where each investment strategy provides, explicitly or implicitly, a recommended relative weight with respect to cash and/or non-cash positions. The asset selling vector may denote or represent asset selling transactions which may generate a needed cash amount (if executed). Further embodiments of the invention, relate to a method and a system for determining an asset selling vector in respect of an investment portfolio by way of optimizing a predefined set of objectives and possibly while meeting some constraints. Similarly, as described later, some embodiments of the invention relate to a method and a system for determining an asset buying vector in respect of an investment portfolio by way of optimizing a predefined set of objectives and possibly while meeting some constraints. Throughout the description of some embodiments of the invention, both asset selling vectors and asset buying vectors are sometimes simply referred to as “vectors”. The mechanisms or techniques for generating, searching and optimizing asset selling vectors and asset buying vectors are similar and this similarity is discussed later below. For clarity and simplicity, the discussion starts with a description of a cash generation technique and therefore the terms “asset selling vector” and “needed cash amount” are used instead of the more general terms: “asset selling or buying vector” and “needed cash amount for cash generation or reinvestment”. However, unless stated otherwise, it would be appreciated that the terms “asset selling vector” (or just “vector”) and “needed cash amount” are interchangeable with the respective more general terms “asset selling or buying vector” and “needed cash amount for cash generation or reinvestment”.

As with the general case of an investment portfolio, in an investment portfolio which is associated with a plurality of investment strategies according to a predefined proportion between the strategies, and where each investment strategy provides, explicitly or implicitly, a recommended relative weight with respect to cash and/or non-cash positions, there may be various combinations of asset selling transactions which may generate approximately the needed cash amount. Some embodiments of the proposed system and method offer a way of determining an asset selling vector which provides approximately the needed cash while optimizing other objectives, including, by way of non-limiting examples, minimizing (absolute values of or squares of) differences between ideal values and actual values of positions in the portfolio, minimizing the estimated cost of the asset selling transactions denoted by an asset selling vector and minimizing the variance of differences between ideal values and actual values of positions in the portfolio or the volatility of these differences. Thus, according to some embodiments of the invention, a need for a certain amount of cash may be answered in a way which provides a desired balance between the cash needs, the differences between the ideal and actual values of positions in the portfolio (taking into account the predefined proportion between the strategies and position weights within strategies), the estimated cost of the asset selling transactions and possibly other objectives and/or constraints. Some embodiments of the proposed method and system of determining an asset selling vector in respect of an investment portfolio which is associated with a plurality of investment strategies are described below in further detail.

Reference is now made to FIG. 7, which is a block diagram illustration of a system for determining an asset selling vector in respect of an investment portfolio which is associated, according to a predefined proportion, with a plurality of investment strategies, and wherein each investment strategy provides explicitly or implicitly a recommended relative weight with respect to cash and/or non-cash positions, according to some embodiments of the invention. According to some embodiments of the invention, a system for determining an asset selling vector 700 may include a needed cash calculator 710, an ideal value calculator 720, an actual value calculator 730, a cost function initializer 740 and an optimizer 750. As mentioned above, the system for determining an asset selling vector 700 may be used either for generating cash or for reinvesting.

According to some embodiments of the invention, the needed cash calculator 710 may include a cash generation rules repository 712. The cash generation rule repository 712 may include data which may enable to determine when, how and how much cash should be generated. The needed cash calculator 710 may be configured to operate in accordance with the cash generation rules stored within the cash generation rules repository 712. Some examples of cash generation rules are provided below. According to some embodiments of the invention, the rules repository 712 may provide a data base which may be used to store conditional rules in a format of “if condition <condition> is met, then perform action <action>”.

As a non-limiting example, the rules repository 712 may include a condition expression according to which, when an amount (X) of cash (e.g. in US dollars) that is needed in order to enable an ideal “buy” transaction is less than the amount of available cash (Y) in a certain account of the portfolio a certain action which is referenced by or otherwise associated with the condition is to be carried out. As a further non-limiting example, the action, which is referenced by or otherwise associated with the above condition expression, may calculate a needed cash amount as the maximum between X-Y and a certain minimal amount (M).

In some embodiments of the invention, the needed cash calculator 710 may include a rules engine which may be configured to interpret the rules in the rules repository 712, evaluate whether the rules conditions are met and execute the associated actions. In some embodiments, rules may also be used for candidate vector generation (e.g. local repair, initial vector or stochastic generation) described later on.

Each of the ideal value calculator 720 and the actual value calculator 730 may be in communication with a plurality of investment strategy data sources 722a-722n and with a portfolio data repository 724.

The investment strategy data sources 722a-722n may include information about investment strategies, with which the portfolio or portfolios for which the system 700 may be configured to determine an asset selling vector, is associated. The ideal value calculator 720 and the actual value calculator 730 may be adapted in some embodiments to obtain from the investment strategy data sources 722a-722n information about the positions recommended (explicitly or implicitly) by the strategy and about the relative weight recommended for each position.

The portfolio data repository 724 may include data about a portfolio or portfolios with which the system 700 is associated. For example, the portfolio data repository 724 may include data about a portfolio for which the system 700 may be configured to calculate an asset selling vector. For each portfolio, the portfolio data repository 724 may include at least data about strategies with which the portfolio is associated and the predefined proportion among these strategies. For each portfolio, the portfolio data repository 724 may also include the value of each cash and non-cash asset holdings within the portfolio (e.g. number of units for each asset holding and unit price for each asset holding).

According to some embodiments of the invention, with respect to a portfolio for which the system 700 may be configured to calculate an asset selling vector, the ideal value calculator 720 may be adapted to calculate the ideal value of a position that is recommended by one of a plurality of strategies that are associated with the portfolio. The calculation of an ideal value of a position that is recommended by one of a plurality of strategies with which the portfolio is associated was discussed in greater detail above.

According to some embodiments of the invention, the ideal value calculator 720 may be adapted to process data received from the investment strategy data sources 722a-722n in order to determine the relative weight recommended by a certain strategy for a certain position. For example, when a strategy data source recommends a certain position in a certain asset but does not explicitly provide the recommended relative weight for that position, the ideal value calculator 720 may be adapted to process the data received from the strategy data source in order to determine the relative weight recommended for the position. Some examples of investment strategy recommendation which do not explicitly provide a recommended relative weight for a recommended position have been provided above. Examples of ways for converting such non relative weight recommendations to a model portfolio where positions are associated with relative weights were also provided above.

According to further embodiments of the invention, the ideal value calculator 720 may be adapted to process data received from the portfolio data repository 724 in order to determine the proportion between strategies with which a certain portfolio is associated.

It should be appreciated that according to some embodiments, the ideal value of a position may be provided by external system or process or may be calculated regardless of strategies (or proportion between strategies) as will be described later.

According to still further embodiments of the invention the ideal value calculator 720 may further obtain data about the total market value of the portfolio. According to some embodiments, the total market value of the portfolio may correspond to the combined current market value (which may be estimated in some cases) of all the assets which are part of the portfolio holdings.

According to some embodiments of the invention, with respect to a portfolio for which the system may be configured to calculate an asset selling vector, once the ideal value calculator 720 obtains data about a recommended relative weight for a certain position recommended by a strategy with which a portfolio is associated, the proportion between the strategies with which the portfolio is associated, and the total market value of the portfolio, the ideal value calculator 720 may calculate an ideal value for the position. It should be appreciated that in some embodiments of the invention, a relative weight is provided for a recommended position regardless of any strategy recommendation and the ideal value calculator calculates an ideal value for the position based on that relative weight and the total market value for the portfolio.

As a non-limiting example consider a portfolio with no associated strategies and a (market) value of USD 10,000; even though no strategies and no proportion between strategies is provided, relatives weights (percentages) are provided for certain recommended positions IBM and DIS regardless of any strategy: IBM 15% and DIS 20%; wherein the relative weights (percentages) are considered to be out of the total portfolio and the ideal value for each of the recommended positions according to the above may be calculated by multiplying the (market) value of the portfolio (USD 10,000) by the corresponding percentage (relative weight). Thus, the ideal value of the IBM position is 10,000*15%=USD 1,500 and the ideal value of the DIS position is 10,000*20%=USD 2,000.

In other embodiments, the ideal value calculator may be provided directly with an ideal value for a position by an external system or process or by a user of the system. A more detailed description of a way of calculating an ideal value was provided above.

According to some embodiments of the invention, with respect to a portfolio for which the system 700 may be configured to calculate an asset selling vector, the actual value calculator 730 may be adapted to calculate the actual value of a position that is recommended by one of a plurality of strategies that are associated with the portfolio. However, according to further embodiments of the invention, the calculation of the actual value or the ideal value for a position or positions may be carried out at a later stage of the process, for example, during a vector scoring and evaluation sequence, and the effects of selling or buying transactions denoted by a particular asset selling or buying vector on asset holdings within the portfolio may be taken into account in the calculation of the actual values of positions with which the effected asset holdings are associated.

According to some embodiments of the invention, with respect to a portfolio for which the system may be configured to calculate an asset selling vector, the actual value calculator 730 may obtain or estimate the market value of a holding in an asset which is recommended by the strategy, for example, by obtaining data about the current market value or number of units of the relevant asset from accounts or other information sources. When in a certain portfolio, there is only one recommended position which is associated with a certain asset, determining the actual value of the position is relatively straightforward. For example, when there is only one recommended position which is associated with a certain asset, the actual value of the position that is associated with the asset may be determined to be the current market value of a portfolio holding in that particular asset.

According to further embodiments of the invention, in some cases, for example, when strategies with which a portfolio is associated provide two or more recommended positions which are associated with a common asset, the actual value calculator 730 may be required to obtain additional data about the positions and the portfolio in order to determine the actual value of the position(s). Examples of determining with respect to a certain portfolio the actual value of each of two or more positions when the two or more positions are associated with a common asset, were provided above. According to a non-limiting example, for the purpose of determining with respect to a certain portfolio the actual value of each of two or more positions associated with a single asset, the actual value calculator 730 may obtain from the investment strategy data sources 722a-722n, for example, data with respect to relative weights of the positions, and from the portfolio data repository 724 data with respect to the predefined proportion between the strategies with which the portfolio is associated and/or the market value of asset holdings within the portfolio. In other embodiments of the invention, a history (log) of recommended and/or executed transactions may be consulted as part of determining with respect to a certain portfolio the actual value of each of two or more positions associated with a single asset, as described in detail above. According to still further embodiments of the invention, the actual value calculator 730 may be configured to receive from the optimizer 750 data with respect to an asset selling or buying vector and may be configured to estimate the actual value of each position or holding that is effected by the asset selling or buying vector after the simulation or execution of the sell or buy transaction(s) denoted by the vector.

The Cost function initializer 740 may be adapted to obtain data that is needed in order to calculate or estimate the cost of executing transactions denoted by an asset selling vector. As a non-limiting example, the cost function initializer 740 may be configured to obtain data related to broker fees (e.g. 0.2% of transaction value or flat USD 8 per transaction or USD 0.01 per unit sold) and/or data related to tax estimation (e.g. according to holding period information obtained from portfolio data repository 724).

The optimizer 750 may be configured to use an optimization algorithm to search for an asset selling vector that optimizes an objective function while satisfying constraints. According to some embodiments of the invention, the process implemented by the optimizer 750 is intended to provide an optimal asset selling vector. The optimal asset selling vector may be interpreted as representing recommendations to sell certain assets in order to provide approximately the needed cash amount.

It should be appreciated that a system for determining an asset buying vector in respect of an investment portfolio may be constructed in a similar way to the system 700 for determining an asset selling vector that was described with reference to FIG. 7. The asset buying vector provided by such a system for determining an asset buying vector may be used, for example, for denoting reinvestment transactions, which according to some embodiments may consume or expend a certain amount of cash in order to buy additional assets related to existing positions recommended by strategies with which the portfolio is associated.

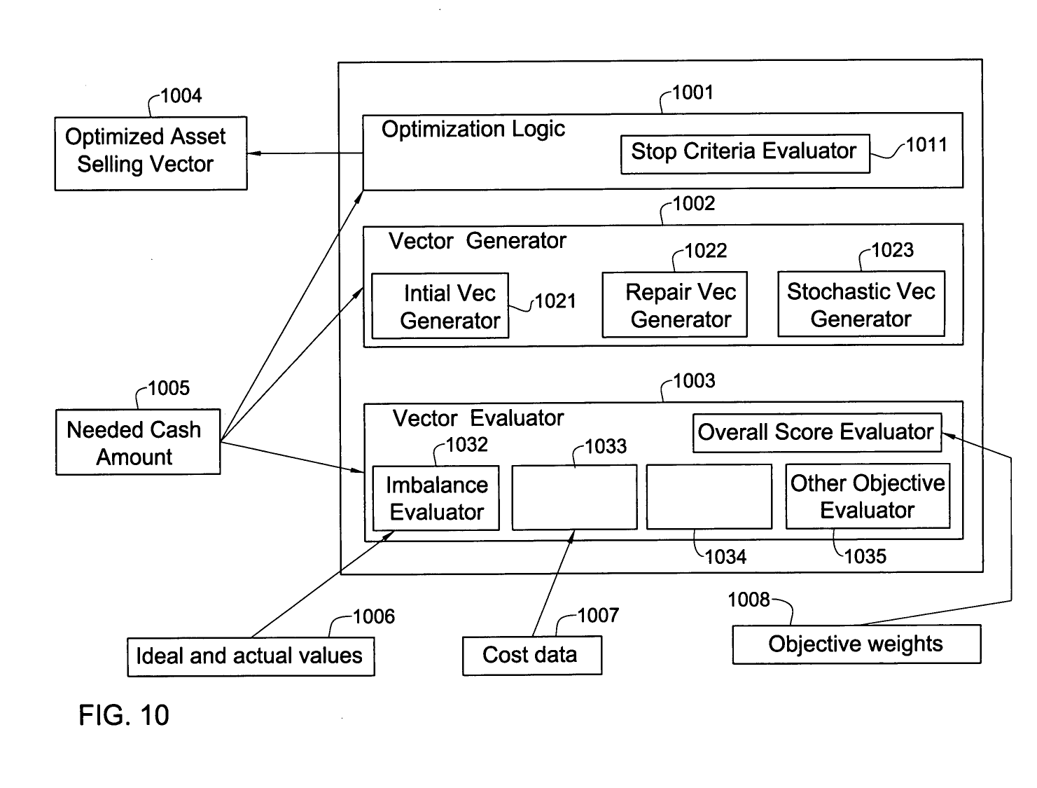

Turning now to FIG. 10, there is shown a block diagram illustration of an optimizer for determining an optimal asset selling or buying vector, according to some embodiments of the invention. For convenience, the operation of the optimizer and its elements is sometimes described below with reference to an asset selling vector, however, as will be evident to anyone with ordinary skill in the art, an optimizer, possibly with some simple modifications, may be devised for handling, in a similar way, asset buying vectors. In some embodiments of the invention, the optimizer 1000 may include at least an optimization logic 1001 that is configured to control and direct an optimization process, a vector generator 1002 that is configured to generate an asset selling vector(s), a vector evaluator 1003 for evaluating a degree by which an asset selling vector satisfies pre-defined objectives and constraints and a stop criterion evaluator 1011 that is configured for evaluating a criterion or criteria to stop the optimization process. When the stop criterion is met and the optimization logic is stopped, an optimal asset selling vector may be provided and considered to be an optimal solution.

It would be appreciated, that the construction of the optimizer 1000 is provided here by way of illustration only and that an optimizer according to further embodiments of the invention may be otherwise constructed and may include different elements, additional elements or no internal elements.

According to some embodiments of the invention, the optimization logic 1001 may be adapted to provide an objective function for scoring an asset selling or buying vector. According to some embodiments of the invention, the optimizer 1000, or in accordance with further embodiments, the vector evaluator 1003 may be adapted to score an asset selling or buying vector based on a pre-defined objective function which measures the “degree” by which an asset selling vector satisfies one or more pre-defined objectives. According to further embodiments of the invention, the predefined objective function may include a plurality of score elements (two or more) and each score element may be associated with a different objective or constraint or with a different combination of a group of objective and/or constraints. The terms “score element” and “objective function” may be used interchangeably throughout the description of the present invention in the context of a measure of a degree by which a certain asset selling or buying vector satisfies a single objective.

According to further embodiments of the invention, the objective function may induce an order relation which denotes a relationship between a set of possible asset selling or buying vectors according to their corresponding scores. Scoring an asset selling or buying vector is also described in further detail below. According to still further embodiments of the invention, according to the order relation, a first vector may be considered “better” than a second vector if the overall score assigned to the first vector is less than the overall score assigned to the second vector (in this case a lower score represents a “better” compliance with the objectives). In other embodiments, a first vector is considered “better” than a second if the overall score assigned to the first is greater than the overall score assigned to the second vector. Calculating an overall score for an asset selling or buying vector and the terms “better vector” and “optimal vector” are described in further detail below.

In some embodiments of the invention, the vector generator 1002 may be configured to generate new asset selling vectors using any one or more of the following mechanisms: a) the initial vector generator 1021 may use a greedy algorithm to relatively quickly find an initial asset selling or buying vector which satisfies some of the constraints; b) the optimization logic component 1001 may decide to utilize the repair vector generator 1022 to repair a candidate asset selling or buying vector by evaluating simple local changes (moderate modifications) to the candidate asset selling vector, thus generating new candidate vectors; c) the optimization logic component 1001 may decide to utilize a stochastic vector generator 1023 to generate a new candidate asset selling vector using a stochastic process.

The local repair component 1022 may be adapted to search for a relatively simple repair that generates a new asset selling vector which is evaluated to be “better” than the preceding asset selling or buying vector. In certain embodiments, the new generated repaired asset selling or buying vector is also “better” than all other possible repairs. The meaning of one vector being “better” than another is intuitively explained above; yet, this term will be described in more detail later as part of the description of evaluating an overall score of an asset selling or buying vector.

The stochastic vector generator 1023 may be used, for example, when the optimization process reaches a local minimum. A local minimum is typically encountered when a “better” solution (i.e., improvement of the overall score) is not achievable through the local repair process and no local repair vectors are found which improve (e.g. result in a lower overall score) the overall score associated with the preceding candidate vector(s). It would be appreciated that using the stochastic vector generator 1023 may enable to resume the optimization process beyond a local minimum situation by generating a new candidate asset selling vector by using, in some embodiments, a random number generator to impose randomness into the process.

In some embodiments, the vector evaluator 1003 may be adapted to find an overall score that is based upon a degree by which pre-defined objectives and constraints are satisfied or violated by an asset selling or buying vector. According to further embodiments of the invention, the vector evaluator 1003 may be configured to use an objective function with respect to each asset selling or buying vector that is to be evaluated in order to compute an overall score with respect to the asset selling or buying vector. The objective function may measure the degree by which the pre-defined objectives and constraints are satisfied or violated by an asset selling or buying vector.

According to further embodiments of the invention, the objective function may include a score element which is sensitive to a particular objective or group of objectives, and which provides a measure of the degree by which that or those particular objectives are satisfied or violated by an asset selling or buying vector that is being evaluated. The vector evaluator 1003 may thus be adapted to determine the overall score for a certain asset selling or buying vector according to the score element values for that particular asset selling or buying vector. For instance, according to one non-limiting example, each score element may be associated with a certain weight and the overall score for a certain asset selling or buying vector may be calculated by computing a weighted average of the score elements according to their respective weights.

Further in accordance with some embodiments of the invention, the vector evaluator 1003 may be configured to utilize an imbalance evaluator 1032, a cost evaluator 1033 and possibly other objective evaluators 1035 (representing one or more associated objectives) for measuring the degree by which the objectives associated with these evaluators 1032, 1033 and 1035 are satisfied by a candidate asset selling or buying vector and for providing a value to a corresponding score element.

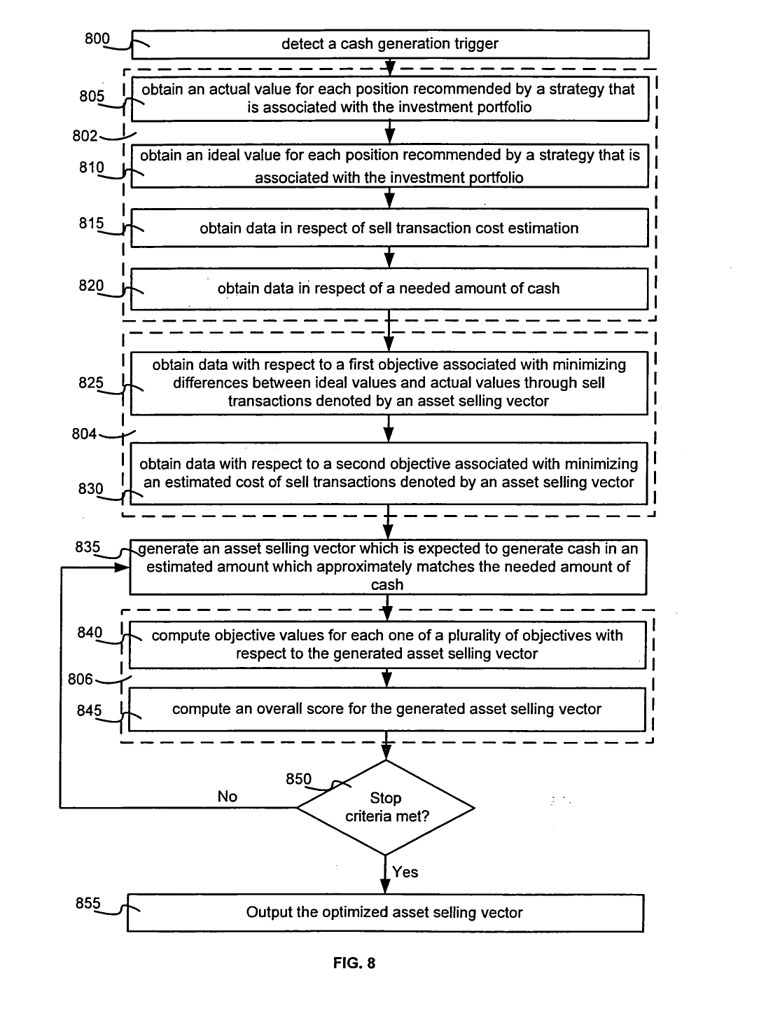

Having provided basic details about the system for determining an asset selling or buying vector, the process of determining an asset selling or buying vector with respect to an investment portfolio shall now be described in greater detail. For convenience, the process described below relates to an asset selling vector, however, as will be evident to anyone with ordinary skill in the art, a similar process may be devised which relates to an asset buying vector. Reference is now additionally made to FIG. 8, which is a flowchart illustration of a method of determining an asset selling (or buying) vector with respect to an investment portfolio which is associated with one or more investment strategies according to a predefined proportion between the strategies (in the case of plurality of strategies), each investment strategy providing explicitly or implicitly a recommended relative weight with respect to cash and/or non-cash positions, according to some embodiments of the invention. According to some embodiments of the invention, a process of determining an asset selling vector with respect to an investment portfolio may be initiated, for example, in response to detecting a trigger for a cash generation process (block 800). According to some embodiments of the invention, certain events and/or circumstances may be defined as triggers of a cash generation process, and the process of determining an asset selling vector may be carried out as part of the cash generation process. Some examples of such events and circumstances which may serve as triggers of a cash generation process will be described in greater detail below.

Upon the initiation of the process of determining an asset selling vector with respect to an investment portfolio, a first set of computer data may be obtained (block 802). According to some embodiments of the invention, obtaining a first set of computer data may include each one of the following: obtaining an actual value for each position recommended by a strategy that is associated with the investment portfolio (block 805); obtaining an ideal value for each position recommended by a strategy that is associated with the investment portfolio (block 810); obtaining data in respect of sell transaction cost estimation that will aid in computing the estimated cost associated with executing transactions denoted by an asset selling vector (block 815); and obtaining data in respect of a needed cash amount (block 820). Determining the actual and ideal values of a position was discussed in greater detail above. However, as mentioned above, according to further embodiments of the invention, the calculation of the actual value or the ideal value for a position or positions may be carried out at a later stage of the process, for example, during a vector scoring and evaluation sequence, and the effects of selling or buying transactions denoted by a particular asset selling or buying vector on asset holdings within the portfolio may be taken into account in the calculation of the actual values of positions with which the effected asset holdings are associated.

In some embodiments of the invention, obtaining asset selling transaction cost data may be intended for the purpose of later estimating the cost associated with executing transactions denoted by an asset selling vector measuring the degree of violating a cost saving objective. In some embodiments, the cost may be estimated with respect to each asset selling transaction denoted by the asset selling vector. Obtaining asset selling transaction cost data includes in some embodiments of the invention obtaining data from various sources regarding various types of costs which may result from the selling of a certain asset, such that estimation with respect to the total cost of the transactions denoted by an asset selling vector may be computed. It should be further appreciated that in some embodiments of the invention, at least with respect to selling of some assets (or buying assets), different quantities of the asset may involve different transactions costs. Furthermore, it would be appreciated that in some cases and with respect to at least some assets, a mathematical expression representing the estimated cost of selling different quantities of the asset may be non-linear in the quantities sold and may even be non-continuous. As non-limiting examples, the process of calculating a cost estimation may be based on a flat fee per transaction, a minimum transaction fee, a tax estimation that is based on tiers and/or based on the holding periods of the assets. Transaction costs are discussed in greater detail below.

According to some embodiments, the needed cash amount may be determined based upon a predefined set of rules which are intended for enabling the calculation of the needed cash amount under various circumstances. According to further embodiments, the needed cash amount may be determined in accordance with a user input. According to still further embodiments of the invention, the needed cash amount may be determined based upon a combination of inputs provided by a user and input generated based upon predefined rules. Some examples of rules which may be used to determine a needed cash amount are provided below.

In addition to the first set of computer data, a second set of computer data may be obtained (block 804). According to some embodiments of the invention the second set of computer data may represent a plurality of objectives with respect to an asset selling vector. Obtaining the second set of computer data may include, in some embodiments, at least obtaining data with respect to a first objective associated with minimizing or maximizing a value related to differences between ideal values and actual values through asset selling transactions denoted by an asset selling vector (block 825). According to further embodiments of the invention, the second set of computer data may also include data with respect to a second objective, for example, an objective that is associated with minimizing an estimated cost of asset selling transactions denoted by an asset selling vector (block 830).

Continuing with the description of the method of determining an asset selling vector with respect to an investment portfolio, according to some embodiments of the invention, a candidate asset selling vector which is expected to generate cash in an estimated amount which approximately matches the needed cash amount may be generated (block 835) and the candidate asset selling vector may be evaluated (block 806) regarding its satisfying of the objective(s). It should be appreciated that in some embodiments, the candidate asset selling vector that is generated may not approximately match the needed cash amount. In these embodiments, the above mentioned constraint is implemented as one of the objectives and not necessarily as one of the constraints that each asset selling vector must satisfy. Various mechanisms for generating an asset selling vector are discussed further below. In some embodiments of the invention, a greedy algorithm may be used for generating the first asset selling vector, a local repair algorithm may then be used to provide asset selling vectors with “improved” or “better” overall score (e.g. smaller overall score) and a stochastic process using a random number generator may be used for continuing the search for an optimal asset selling vector, for example, beyond an asset selling vector which provides a local minima (when local repairs cannot further “improve” the overall score).

According to some embodiments of the invention, evaluating the an asset selling vector (block 806) may include computing a score element based in connection with each objective and based upon a degree by which the asset selling vector satisfies (or violates) the respective objective (block 840) and computing an overall score for the asset selling vector (block 845).

Some examples of objectives and of mathematical expressions which may be used to calculate score elements (or “objective values”) in respect of different objectives are provided below.

In accordance with further embodiments of the invention, computing an overall score for an asset selling vector (block 845) may include computing an overall score for the asset selling vector according to predefined weights associated with predefined objectives and their respective score elements, and according to the related objective values computed in respect of the candidate asset selling vector. A more detailed description of some examples of calculating an overall score for an asset selling vector is provided below.

Next, according to some embodiments of the invention, it may be determined whether the asset selling vector satisfies a predefined optimization criterion (or criteria) (block 850). According to some embodiments of the invention, the predefined optimization criterion may be associated with a stop criterion or criteria which relate to the optimization process. According to further embodiments of the invention, a stop criterion may be provided, and in accordance with the stop criterion it may be determined at block 850 whether the optimization process should continue or not.

In accordance with some embodiments of the invention and according to a non-limiting example, the stop criterion may be related to a bound on resources (e.g. stop after enough time has elapsed since beginning of the optimization process or after certain computing power has been exhausted) or in some embodiments with a bound on a proxy for a resource (e.g. stop after a certain number of vector generations or iterations). In accordance with a further non-limiting examples, either in some combination with one or more of the above criteria or as an alternative, the stop criterion may be associated with a degree by which objectives and possibly also constraints are satisfied by the asset selling vectors with the optimal or best overall score found so far (e.g. when an asset selling vector is found that is “close enough”—as prescribed by the stop criterion—to fully satisfy the objectives and constraints). It would be appreciated that according to some embodiments of the invention, a complex stop criterion may be implemented, for example, a stop criterion may be implemented which designates a bound on resources and a measure of compatibility of objectives and/or constrains. As a non-limiting example of a complex stop criterion, an optimization process may stop when a certain pre-defined number of candidate vectors has been generated and evaluated or when the overall score of the last generated candidate asset selling vector is less than some predefined minimum or when a certain amount of time has elapsed since optimization has begun.

According to some embodiments of the invention, if it is determined at block 850 that the optimization criterion is met, the optimal asset selling vector so far with the “best” overall score so far may be selected (e.g., the vector with minimal overall score generated so far in the process) and the process may output the selected optimal asset selling vector (block 855). According to some embodiments of the invention, outputting the selected optimal asset selling vector may terminate the process of searching for an optimal asset selling vector. The output of the process for determining an optimal asset selling vector may be used, for example, for generating, recommending and/or executing the asset selling transactions that are denoted by the optimal asset selling vector found. The output of the process for determining an asset selling vector may be further processed so that valid selling order transactions may be issued as recommendations or be submitted for execution. In some embodiments of the invention, these selling orders may be further modified by a mechanized system or by an operator before they are sent for execution or user approval.

According to further embodiments of the invention, if it is determined at block 850 that the optimization criterion (or stop criteria) is not met, the process of generating asset selling vectors and evaluating the asset selling vectors may continue (blocks 835-850) until the optimization criterion is met. If the optimization criterion is not met, the iterative process may continue and a new asset selling vector may be generated at block 835 and may be evaluated (block 806). It should be appreciated that in some embodiments of the invention, a new asset selling vector may be generated in order to systematically explore the search space of asset selling vectors. In some embodiments of the invention a stochastic process may be used for the generation of further asset selling vectors. In accordance with further embodiments, a combination of a stochastic and a systematic search may be used.

Various aspects and further embodiments of the process of determining an asset selling vector are described in greater detail below.

According to some embodiments of the invention, the system for determining an asset selling vector with respect to an investment portfolio may be configured to determine an asset selling vector with respect to an investment portfolio as part of a cash generation process that is intended to generate cash for a certain portfolio by selling or by suggesting the sell of certain assets which are held in the portfolio.

In some embodiments of the invention, a computer implemented system for determining an asset selling vector with respect to an investment portfolio may be part of or may be associated with a multi-strategy portfolio management system (MSPMS). Various aspects of a multi-strategy portfolio management system were described above with greater detail. According to some embodiments of the invention, a multi-strategy portfolio management system may utilize a system for determining an asset selling vector with respect to an investment portfolio in order to generate cash for the purpose of being able to execute a transaction (e.g., following a strategy change consistent with a recommendation to buy an asset or a need for an increased margin). According to a further embodiment of the invention, a multi-strategy portfolio management system may utilize a system for determining an asset selling vector with respect to an investment portfolio or as a proactive process that is intended to generate a certain amount of cash. For example, a multi-strategy portfolio management system may utilize a system for determining an asset selling vector with respect to an investment portfolio to generate cash when the cash holding in a portfolio or in a particular account is determined to be insufficient according to some criteria or in order to satisfy an explicit or implicit request, for example, by a user or broker, for some needed cash amount. Thus, in accordance with some embodiments of the invention, the multi-strategy portfolio management system may receive an explicit request for a certain amount of cash, and the request may trigger the multi-strategy portfolio management system to implement a cash generation process that utilizes the system for determining an asset selling vector with respect to an investment portfolio.

As mentioned above, the computer implemented system for determining an asset selling vector with respect to an investment portfolio may be utilized in order to suggest an asset selling vector representing suggested transactions that are intended for generating a needed cash amount. The collection of the transactions denoted by the asset selling vector may be considered as a plan for asset disposition that may be executed for the purpose of generating a needed cash amount. In accordance with some embodiments of the invention, the system may be configured to generate the asset selling vector as part of a cash generation process that is intended for the purpose of being able to execute a transaction with respect to the investment portfolio. As was described above with greater detail, in an investment portfolio that is associated with investment strategies which issue recommendations with respect to positions recommended by the strategy, there may be a need to calculate suggested transactions from time to time. For example, a suggested transaction may be calculated in response to a strategy change which is consistent with a recommendation to change the relative weight of a certain position in the portfolio. According to some embodiments of the invention, the system for determining an asset selling vector with respect to an investment portfolio may be utilized as part of a cash generation process that is triggered when cash is insufficient to carry out a suggested transaction. Cash may be considered as being insufficient to carry out a certain transaction when the amount of available cash is less than a certain calculated or pre-defined threshold. For example, a cash generation triggering rule may specify that if the amount of cash holding within the investment portfolio is less than 90% of the value of the ideal transaction (calculated in reaction to a strategy change consistent with a recommendation to buy), then a cash generation process is triggered. Another rule example may specify that if a margin call is detected a cash generation process is triggered.

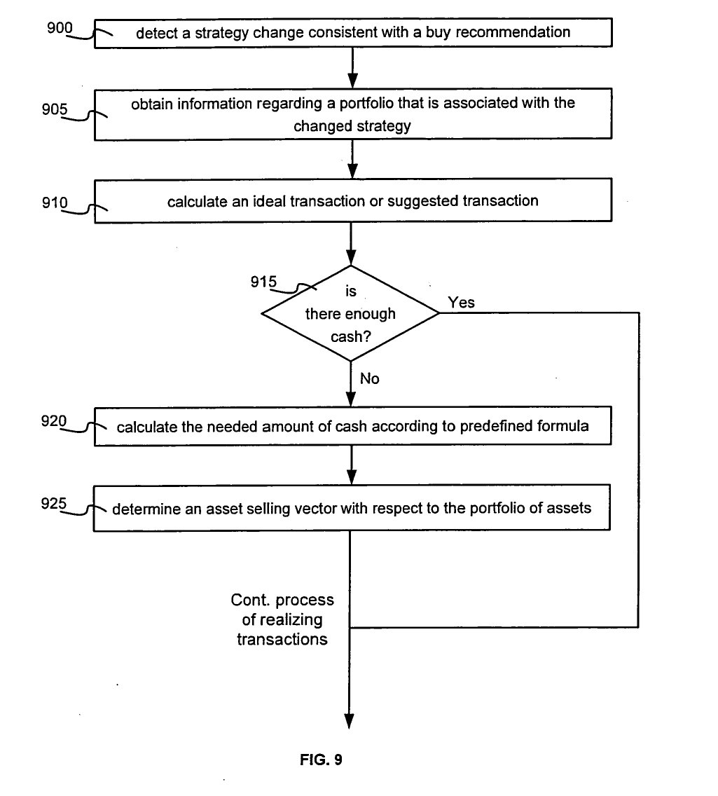

Reference is now made to FIG. 9, which is a flowchart illustration of process of determining whether an amount of cash available in a portfolio is sufficient to carry out a suggested transaction, calculating the needed amount of cash and determining an asset selling vector denoting transactions that generates the needed cash, according to some embodiments of the invention. In accordance with a non-limiting example, the process of determining whether an amount of cash available in a portfolio is sufficient to carry out a suggested transaction illustrated by FIG. 9 and described herein with reference thereto, may be triggered in response to detecting a strategy change that is consistent with a buy recommendation. Various aspects of a process of detecting a strategy change and determining whether the strategy change is consistent with a buy recommendation were discussed in greater detail above. Referring back to FIG. 9, initially a strategy change consistent with a buy recommendation may be detected (block 900).

Following the detection of the strategy change, information regarding an investment portfolio (or plurality of investment portfolios) that is (are) associated with the changed strategy may be obtained (block 905).

In certain embodiments, obtaining information regarding an investment portfolio that is associated with the changed strategy may include identifying the investment portfolio (or portfolios) associated with a Personal Investment Policy (PIP) that reference the changed strategy. In accordance with further embodiments of the invention, obtaining information regarding an investment portfolio may include obtaining information regarding asset holdings within the portfolio, such as asset identities, unit quantities, and current market value of the portfolio asset holdings by retrieving data from accounts associated with the portfolio identified or from data sources that are associated with such accounts.

Based on the information regarding the investment portfolio that is associated with the changed strategy and additional data if necessary, an ideal transaction or suggested transaction may be calculated (block 910). According to a non-limiting example, an ideal transaction calculation may be based upon the difference between ideal value and actual value of the changed position. According to another non-limiting example, first a cash allocation may be calculated for a cash position recommended explicitly or implicitly by the changed strategy, based at least on the value of the cash holding within the portfolio. Next, an ideal transaction value may be calculated based on the cash allocated for the cash position recommended by the changed strategy. Various aspects of calculating an ideal transaction value and calculating a cash allocation were discussed in detail above. In certain embodiments, the ideal transaction value and the cash allocation that is associated with the cash position recommended explicitly or implicitly by the strategy which issued the change (e.g. a change that is consistent with a recommendation to buy) may be used to determine whether there is enough cash to execute the ideal transaction (block 915). As a non-limiting example, the cash needed for executing the ideal transaction may be compared with the cash allocated for the cash position recommended explicitly or implicitly by the changed strategy, and if the allocated cash value is less than the cash needed for the ideal transaction, the cash generation process may be triggered. As mentioned above, a predefined criterion may be used to determine whether there is enough cash in order to execute the ideal transaction. If it is determined that the amount of cash holding or cash allocated is enough, for example to realize a certain ideal transaction, the process may continue with the realization of that ideal transaction. For example, an ideal transaction may be realized by issuing a suggested transaction or an order to buy a certain asset according to the details of the ideal transaction. If it is determined that the amount of cash that is associated with the cash position recommended explicitly or implicitly by the changed strategy is insufficient, the needed cash amount may be calculated according to predefined criterion formula or rule (block 920). In some embodiments, the needed cash amount which needs to be generated may be approximately the amount that is sufficient to enable the ideal transaction or the suggested transaction to be executed, taking into account the existing value of the cash holding in the portfolio.

In accordance with further embodiments, the needed cash amount may be calculated so that a minimal transaction (and not necessarily the ideal transaction) is able to execute. As a non-limiting example, a transaction should be USD 200 minimum. In other embodiments of the invention, the needed cash amount is calculated based upon an ideal value of the cash position recommended explicitly or implicitly by the changed strategy. In other words, in some embodiments, the needed cash amount may be calculated so that the total amount of cash holding in the portfolio (after generating the needed cash amount) is approximately sufficient to enable cash allocation for the cash position recommended explicitly or implicitly by the changed strategy, on par with the ideal cash value of the cash position (recommended by the changed strategy). According to certain embodiments, the amount of cash needed may be determined according to the cash allocation process which was described in some length above, so that the allocated cash amount for the cash position (recommended by the changed strategy) is on par with the ideal value of that cash position. The process of calculating an ideal value for any position recommended by a strategy with which the portfolio is associated was described in length above.

According to yet further embodiments, the needed cash may be calculated so that there is enough cash to meet the cash requirements set (typically implicitly) by a plurality of ideal values of cash positions recommended explicitly or implicitly by a plurality of strategies with which the portfolio is associated. For example, the needed cash may be calculated so that the amount of cash (after executing the suggested cash generation transactions) is approximately equal to the total amount of cash represented by the ideal cash value of the cash position recommended by each one of a plurality of strategies with which the portfolio is associated.

Following are some non-limiting examples of rules which may be used to determine the needed cash amount:

1. If an ideal buy transaction value is calculated to be X (US dollars) and the amount of cash holding (or cash allocation for the cash position recommended by the changed strategy) that is available for the buy transaction is Y (US dollars), and Y<X, then the needed cash amount may be the maximum between X-Y and some positive number MIN representing the minimum amount of cash to be generated;

2. If the amount of cash holding that is available for the buy transaction is Y (in US dollars) is less than the sum Z of the ideal values of the cash positions recommended by each of the strategies with which the portfolio is associated, then the needed cash amount may be determined according to the following mathematical expression: MAX (Z-Y, MIN) where MIN is a minimal transaction size. It would be appreciated that according to this mathematical expression, the needed cash amount is the maximum between a minimal transaction size and the amount needed to bring the amount of cash holding within the portfolio on par with the sum of the ideal values of the cash positions recommended by each of the strategies with which the portfolio is associated. The minimal transaction size may be effective for excluding cash generating transactions which are too small, for example to exclude any transaction whose value is below a predefined minimum transaction size or which involves a too small number of units of the asset with which the position is associated. It would be appreciated that the proposed threshold may also help to exclude transactions which are too small to execute or too small to have a true significance and which may increase the overhead of the suggested process.

3. If the amount of cash (Y) that is available for the buy transaction is less then the ideal transaction value (X) or less than a threshold T (representing a minimal cash level to keep), and the sum of the ideal values of the cash positions in each of the strategies with which the portfolio is associated (Z), the needed cash may be determined according to the following mathematical expression:

MAX(X-Y,Z-Y,T+X,MIN)

It would be appreciated that according to this mathematical expression, the suggested cash generation transactions (if executed) are intended to generate enough cash for the suggested buy transaction to execute (X), for reserving cash for ideal cash position values of associated strategies (Z), for raising the cash level at least to the required level (T) (after executing the buy transaction) and for the transaction value to be in access of at least a minimal amount (MIN).

Following the calculation of the needed cash amount (block 920), the process of determining an asset selling vector with respect to the investment portfolio may be initiated in order to generate the amount of cash that is needed (block 925). According to further embodiments of the invention, the process of determining an asset selling vector with respect to an investment portfolio may be initiated only if the needed cash amount is greater than a minimum cash generation threshold.

Having described in principal the process of determining an asset selling vector with respect to an investment portfolio as part of a process of computing and executing a suggested transaction, there is now provided a description the process of determining an asset selling vector with respect to an investment portfolio as part of a pro-active cash generation process. According to some embodiments of the invention, a pro-active cash generation process may be activated automatically when certain criteria are met. In further embodiments of the invention, the criterion for triggering a proactive cash generation process may be independent of any strategy change and may depend upon certain circumstances related, for example, to the status of the portfolio, its cash holding and/or status of the account[s] that are associated with the portfolio, margin associated with the portfolio etc.,

According to some embodiments of the invention, initially a trigger to perform a pro-active cash generation process with respect to an investment portfolio may be detected using pre-defined criteria. According to a non-limiting example, a trigger of a pro-active cash generation process may be associated with a reduction in the amount of cash holding within a certain account that is associated with the portfolio or with a reduction in the amount of cash holding in the portfolio itself. According to a further non-limiting example, the trigger for a pro-active cash generation process may be associated with a certain date (e.g. generating monthly income at the beginning of the month). According to yet another example, a trigger for a cash generation process may be an explicit request made by a user seeking to generate a certain amount of cash. According to yet another example, a trigger for a cash generation process may be a margin call issued by a bank or broker as a result of change in portfolio asset market valuation.

In some embodiments of the invention, following the detection of a trigger for pro-active cash generation process, a process of determining the needed cash amount may be initiated. Following are non-limiting examples of criteria which may be used as part of the process of determining the needed cash amount for proactive cash generation:

1. If the value of a cash holding X (US Dollars) is less than a threshold T (US Dollars), then the needed cash amount is calculated using the formula: Max (Z-X, MIN), where Z is a positive value greater than T, and MIN is the minimal cash generation amount. In some embodiments, Z and T are explicitly provided by a broker or a user of the system where available cash value is expected to be between T and Z.

2. If the current date is the beginning of a month and the portfolio cash holding X (in US Dollars) is less than the sum of ideal cash position values I (in US Dollars) plus a predefined amount IN (in US Dollars), which may represent a desired monthly income, the needed cash may be denoted by the following mathematical expression:

IN+I-X,

so that cash may be generated to cover for both the requested income amount (IN) and amount which corresponds to the sum of the ideal cash position values (I). According to another example, the needed cash may be denoted by the following mathematical expression:

Max(IN-X,MIN)

According to the latter mathematical expression, the needed cash amount may be intended to cover the requested income amount (IN) but may not necessarily cover the amount which corresponds to the sum of the ideal cash position values.

3. If a user explicitly requests cash generation of a certain amount X (in US Dollars), the needed cash is the maximum of X and a positive number MIN representing a minimal cash generation value.

According to some embodiments of the invention, if the needed cash amount is greater than a certain predefined threshold, a process of determining an asset selling vector with respect to an investment portfolio may be carried out, giving rise to one or more suggested asset selling transactions, which, if executed, the suggested transactions are estimated to generate approximately the needed cash amount while optimized to meet certain objectives and constraints.

According to some embodiments of the invention, the process of determining an asset selling vector with respect to an investment portfolio may include searching for a vector comprised of non-negative selling values (X1, . . . Xn) which are hereby also referred to as the elements of the vector, where the selling values relate to positions recommended by strategies with which the portfolio is associated or to portfolio asset holdings (H1, . . . Hn) which may be associated with positions that are recommended by investment strategies which are in turn associated with the investment portfolio. The search for the vector may be intended to find a vector of non-negative selling values whereby the sum of the selling values (i.e., the sum of the elements Xi's) is approximately equal to the given needed cash amount and at the same time, the vector minimizes (or maximizes) an overall score which relates to at least one objective function, possibly under some additional constraints.

As mentioned above, according to one example, the vector denotes (or represents) asset selling transactions such that each selling value (element) within the vector denotes a selling transaction of the corresponding asset holding (or position) with a transaction value denoted by the selling value. For example, assume a portfolio holding of IBM valued USD 10,000 and a holding of DIS valued USD 20,000. The vector (5000, 6000) relates to the assets of IBM and DIS. The first element (5000) denotes a selling transaction to sell USD 5,000 from the IBM holding of USD 10,000, while the second element (6,000) denotes a transaction to sell USD 6000 from the DIS holding of USD 20,000. Thus the vector (5000, 6000) denotes 2 selling transactions: “Sell USD 5,000 of the IBM holding” and “Sell USD 6,000 of the DIS holding”. It should be also appreciated that in some embodiments of the invention, the elements of the vector (X1 . . . Xn) may denote selling values that correspond to positions (Pi) recommended by strategies with which the portfolio is associated (rather than to asset holdings). Thus a vector (X1, . . . Xn) may denote selling transactions that correspond to positions (1 . . . n) recommended by strategies with which the portfolio is associated. Any person with ordinary skill in the art could readily interchange any of two aforementioned notations of asset selling vectors. It would also be appreciated that instead of Xi representing selling values in a specific currency, one could use Xi as vector elements which represent percentage (or portion) of a holding (Hi) or) or of an actual value of a position. (Pi).

According to some embodiments, inputs for the cash generation process may include some or all of the following: A set of positive holdings (Hi) in cash and non-cash assets which are held within the portfolio (e.g. the number of units in each asset holding and the current unit price/quote for each asset may be used for calculating the holdings); information with respect to one or more investment strategies (Si) which are associated with the portfolio; a predefined proportion (P1:P2: . . . ) between two or more investment strategies with which the portfolio is associated (if the portfolio is associated with a plurality of strategies); for each investment strategy with which the portfolio is associated, there may be provided the strategies' recommended positions and relative weights recommended explicitly or implicitly for each such position. As mentioned above, the recommended positions may be denoted by relative weights which are associated with each position recommended by a strategy with which the portfolio is associated. The relative weights may be explicitly provided by the strategies or may be implied and the recommendations may need to be translated to relative weights as described above in detail.

According to further embodiments of the invention, ideal values of portfolio assets and/or actual values of those assets may be provided as inputs for the cash generation process and may not have to be calculated using the above-mentioned predefined strategy proportion and position weights. It would be appreciated that if the ideal values and actual values of the portfolio positions are directly provided (or calculated in different ways), the data about strategies in general and about relative weights and strategy proportion in particular may not be required for the cash generation process. According to yet another embodiments of the invention, in case ideal and actual values are obtainable for only a subset of the assets holdings or positions in a portfolio, cash generation may be carried out in respect of a subset of the holdings or positions where ideal and actual values are obtainable. It would be further appreciated that the data with respect to the actual values of the positions may be updated once an asset selling or buying vector is provided and in respect of that asset selling or buying vector, since the optimization process may require the estimated actual value of each position or holding that is effected by the asset selling or buying vector after the simulation or execution of the sell or buy transaction(s) denoted by the vector.

Additional inputs which may be obtained in some embodiments of the invention, as part of or in service of the cash generation process may include: data with respect to a needed cash amount (as a non-limiting example, a positive number which designates a needed cash amount specified in US Dollars); asset selling transaction cost data, enabling the calculation of the cost that is associated with executing the asset selling transactions denoted by an asset selling vector. The asset selling transaction cost data may enable to estimate the cost of selling quantities of some or all of the assets held in the portfolio. As a non-limiting example, the cost data may include data which may enable to estimate the cost of tax which may be associated with the asset selling transactions, data which may enable to estimate broker transaction fees, data which may enable to estimate a value associated with opportunity loss of potential returns which may be associated with assets to which the asset selling transaction relate, etc.

According to some embodiments of the invention, the evaluation of an asset selling vector may be based upon a computation of an overall score that is based at least on differences between actual values of a plurality of positions recommended by the plurality of strategies associated with an investment portfolio and corresponding ideal values of such a plurality of positions. According to further embodiments of the invention, the evaluation of an asset selling vector may be based upon a computation of an overall score that is based on at least two objectives. Each objective may be expressed as an arithmetic expression describing a score element (or an objective function) that measures the degree by which the objective is met. The evaluation of an asset selling vector in some embodiments may include computing in respect of the asset selling vector a plurality of objective values or score elements, each of the plurality objective values being associated with one of a predefined plurality of objectives. The terms “score element” and “objective value” relate to a value which is the result of applying a target function (related to a particular objective) to a certain asset selling or buying vector and they may be used interchangeably. The objective value (or score element) that is associated with each objective may be calculated according to the mathematical expression that is associated with that particular objective. The evaluation of an asset selling vector in some embodiments may further include assigning to each objective a predefined weight or a predefined factor. The result of the evaluation of the asset selling vector may be an overall score for that vector that is computed in some embodiments by adding each one of the objective values (or score elements) according to the weights or factors assigned to each objective (i.e., the weighted sum of the objective values). Examples of objectives which may be defined for the purpose of determining an asset selling vector in respect of an investment portfolio may include the following (enumerated 1-4):

1. Minimizing a measure of imbalances between actual and ideal values associated with positions recommended explicitly or implicitly by investment strategies with which the investment portfolio is associated, after the simulation of the execution of the asset selling transactions denoted by an asset selling vector. In some embodiments, the expression for measuring imbalances is based on adding differences between ideal values and actual values of recommended positions after simulating the asset selling transactions denoted by asset selling vector.

In some embodiments, the absolute values of differences are added for measuring the imbalances associated with an asset selling vector (since both negative and positive differences should be minimized), while in other embodiments the squares of the differences may be used. In further embodiments, relative difference may be used (e.g., (Ideal-actual)/actual; when only non-zero actual values are used; or (Ideal-actual)/ideal when only non-zero ideal values are used). As a non limiting example, in accordance with still further embodiments of the invention, the sum of the squares of the differences may used or the sum of the absolute values of the differences may be used, or the sum of the squares of relative differences may be used. In some embodiments of the invention, the formula associated with the imbalances measurement may further include quadratic root and/or weights for each added term (e.g. quadratic root of the weighted average of squares of relative differences). The following are non-limiting examples of mathematical expressions which may be used as part of an objective function for measuring imbalances. The objective function (or score element) for measuring imbalances may be employed as part of the process of determining an asset selling vector (referenced Equations OF1-OF5):

$$imbalances ( X , P ) = f 1 \times \sqrt{{\sum }_{i = 1}^{n} w ( i ) \times {( diff ( i ) )}^{2}} \qquad Eq . OF 1$$

Equation OF1 is an example of a mathematical expression describing an objective function (or score element) for measuring the degree of imbalances with respect to an asset selling vector X, after the execution of the asset selling transactions denoted by the asset selling vector X within investment portfolio P, where i represents a position recommended by a strategy with which a portfolio P is associated, and where diff(i) may be either a difference between ideal value and actual value related to position (i.e., ideal(i)-actual(i)) or a relative difference (ideal(i)-actual(i)/actual(i) where ideal(i) is not zero). The weights w(i) may be numbers associated with the actual value of position i or may be predefined numbers associated with positions or with corresponding asset holdings within the portfolio P (e.g. an equal weight of 1 (w(i)=1) for all positions (i) is a special case of the abovementioned scheme that determines that each difference has equal weight). The factor f1 represents the relative importance that is associated with the objective of minimizing differences in relation to other objective functions or expressions which may be minimized as part of the optimization process. In certain embodiments, the factor f1 may be intended to introduce into the mathematical expression a normalization factor which sets the objective value within a predefined range (e.g. between zero and one). In yet another example of an objective function that is intended to measure imbalances, a sum of absolute values of the differences is used instead of the sum of squares as in the following equation:

imbalances(X,P)=f1×Σw(i)×abs(diff(i)) Eq. OF2

where, abs(diff(i)) represents the absolute value of Diff(i), while f1, X, P, w(i) and diff(i) are interpreted as explained in Eq. OF1 above.

It should be appreciated, that in some embodiments of the invention, ideal values are calculated based on a portfolio market value modified so that it does not include the needed cash amount. The needed cash amount may be reduced from the total portfolio value so that ideal values of the portfolio positions are calculated based on a portfolio of smaller market value, as if the needed cash amount is not part of the portfolio. This approach may be desired for example, when the needed cash is going to be at least partially withdrawn, consumed or expended and ideal values should be calculated based on a more relevant portfolio market value which does not include the needed cash amount soon to be consumed. Subtracting the needed cash amount from the portfolio market value may therefore accommodate for intended withdrawals or consumption of the needed cash amount and produce ideal values which better reflect the intention of strategy recommendations. It would be appreciated that by basing ideal value calculations on a portfolio value that does not include the needed cash amount, it may be possible (as a result of smaller ideal values) to generate the needed cash amount by selling only asset positions with actual value that are greater than their ideal value.

As a non-limiting example for calculating ideal values based on reducing the needed cash amount from a total portfolio value, consider an investment portfolio associated with proportional strategies: strategy S1 may be defined as being associated with a 40% share of the investment portfolio, and position X recommended by that strategy (S1) has a recommended relative weight of 10%. The total market value of the investment portfolio is 100,000 (US Dollars) while the needed cash amount is 10,000 (US Dollars). The ideal value of position X may be calculated, for example, according to the following mathematical expression:

(USD 100,000−10,000)*40%*10%=USD 3,600;

Whereas calculating the ideal value of position X without reducing the needed cash amount provides the following result:

100,000*40%*10%=USD 4,000.

Assuming a holding of USD 5000 in X, in accordance with the first approach (excluding the needed cash) results in a larger difference (dif(i)=5000−3600=1400) whereas in accordance with the second approach (including the needed cash) results in a smaller difference (dif(i)=5000−4000=1000). In some embodiments the two approaches will result in different overall scores and may result in different optimal vectors. In other embodiments, the imbalance measurement objective function may be constructed in a way that causes the optimization process to generate the same optimal vector according to both approaches.

In other embodiments, the objective function for measuring imbalances may measure imbalances at the strategy level and not at the position level as in the above. As a non-limiting example, measuring imbalances at the strategy level may include totaling the squares (or the absolute values) of strategy differences instead of the squares (or the absolute values) of position differences. In one example of calculating a strategy difference, the strategy difference may be calculated by totaling all of the position differences related to positions recommended explicitly or implicitly by that specific strategy. In another example a strategy difference is calculated by subtracting ideal strategy value (based on the strategy proportion out of the portfolio market value) and the actual strategy value (based on totaling the actual values of the positions recommended by that strategy).

The following is a non-limiting example of a mathematical formula which may be used for calculating a strategy difference related to strategy s with which the portfolio is associated:

$$StrategyDiff ( s ) = {\sum }_{i = s 1}^{sk} diff ( i )$$

The above mathematical expression denotes a calculation of a strategy difference related to strategy s by adding all the position differences related to positions s1 to sk recommended explicitly or implicitly by strategy s. The following mathematical expression is a non-limiting example of an objective function that measures imbalances at the strategy level by totaling the absolute values of strategy differences related to strategies with which the portfolio is associated:

imbalances(X,P)=f1×Σₛabs(StrategyDiff(s))

wherein f1 is a similar to the normalization factor f1 which was described above, s denotes each of the strategies with which portfolio P is associated and StrategyDiff(s) is the strategy difference related to strategy s that is described above.

2. Another example of an objective function which may be defined for the purpose of determining an asset selling vector in respect of an investment portfolio may be associated with charges (or cost) which are estimated as being associated with (or to arise from) the suggested asset selling transactions denoted by an asset selling vector X=(X1, . . . Xn). Typically, in some embodiments of the invention, cost objective calculation is based on an expression that may be used to measure the charges and/or costs associated with the suggested asset selling transactions. Such an expression may be based on totaling the charges associated with each asset selling transaction denoted by the vector. There follows an example of a mathematical expression which may be used to measure the charges or cost associated with suggested sell transactions:

$$cos t ( X , P ) = f 2 \times {\sum }_{i = 1}^{n} ( fee ( X , i ) + tax ( X , i ) + loss ( X , i ) ) \qquad Eq . OF 3$$

where, fee(X,i) calculates the broker estimated fees associate with selling Xi of holding i, tax(X,i) calculates the estimated taxes which may be due as a result of selling Xi of holding i, and loss(X,i) is the estimated loss of opportunity resulting from selling Xi of holding i which, had it not been sold, is estimated to have produced certain future returns (e.g. dividends, interest and/or capital gains).

As in another non-limiting example, cost (X,P) may include a penalty that may be calculated per asset selling transaction of position i, denoted by an asset selling vector X=( . . . Xi . . . ). The penalty calculated may be based on a priority that is pre-assigned to a position i or to all the positions recommended by a certain strategy with which the portfolio is associated. According to a non-limiting example, selling each and every position of a certain strategy may generate a high penalty cost of USD 1000. In some embodiments, high penalties may be associated with a user's explicit request not to sell a particular holding or asset or a strategy and may thus increase the likelihood of the holding, asset or strategy not being sold.

3. A third example of an objective which may be defined for the purpose of determining an asset selling vector in respect of an investment portfolio may correspond to obtaining low volatility in the distribution of imbalances associated with positions recommended by strategies with which the portfolio is associated. In other words the objective is to obtain (approximately) or to approach even distribution of imbalances instead of high volatile distribution. According to some embodiments of the invention, an expression that measures a statistical variance may be used. In some embodiments of the invention, such an expression may measure the sum of squares of the distances between imbalances (diff(i)) for each asset position and the average of the imbalances within a portfolio P created after simulating the execution of the asset selling transactions denoted by the asset selling vector (X). In some embodiments, the variance or standard deviation of the differences may be used while in other embodiments, a sum of absolute distances may be used instead of or in addition to the sum of squares. In further embodiments of the invention, relative differences may be used as mentioned above. As in the non-limiting example, the following equation OF4 is a mathematical expression which may be implemented for measuring a variance of imbalances:

VarDifferences(X,P)=f3×Σ(diff(i)−averageDiffs(X,P))² Eq. OF4

where, AverageDiffs(X,P) is the average of all the differences (diff(i)) which are associated with positions recommended by strategies with which portfolio P is associated, after simulating the execution of the asset selling transactions denoted by vector X. As described in the examples above, diff(i) measures the difference between ideal value and actual value associated with a position i in either absolute or relative terms. The factor f3 may represent the importance that is associated with the objective of minimizing this variance of imbalances. In some embodiments of the invention, further normalization may be used to force the measurement to produce values between one and zero.

4. A fourth example of an objective function which may be defined for the purpose of determining an asset selling vector in respect of an investment portfolio may be associated with the objective of minimizing a change in the risk of a portfolio after the simulation of the execution of the asset selling transactions denoted by the asset selling vector. An expression may be provided for measuring a change in the risk of a portfolio after the simulation of the execution of the asset selling transactions denoted by the vector X=(X1 . . . Xn). According to some embodiments, evaluating the risk change may include utilizing measures such as Value At Risk (in short:VAR, described in Philippe Jorion, “Value at Risk, the new benchmark for managing financial risk”, copyright 2007 by The McGraw-Hill Companies, Inc), standard deviation of the portfolio based on historical position(s) returns, the beta of the portfolio, estimated variance of the returns using covariance matrix, etc. According to some embodiments of the invention, the expression used to denote the objective function used for measuring the degree of risk change is based on the square of the difference between the portfolio risk after simulating the execution of the asset selling transactions (denoted by the asset selling vector X) and the portfolio risk prior to simulating these asset selling transactions, may be minimized. In yet another embodiment, the objective function expression may be based on the square of the difference between a desired (or planned) portfolio risk and the risk of the portfolio after simulating the execution of the transactions denoted by the asset selling vector. The desired portfolio risk may be provided in some embodiments by a financial planner, a user or a planning system. The expressions that are used in some embodiments for calculating portfolio risk (e.g. VAR, beta, variance, etc.) are known in the art and thus, the process of crafting expressions denoting objective functions for minimizing risk change may be devised by those with ordinary skill in the art.

Each of the above objective function expressions (1-4) may include a normalization factor so that the expression produces objective values within a pre-determined range (e.g. between 0 and 1). General techniques for normalization are known in the art and thus, the process of crafting the normalization factor may be devised by those with ordinary skill in the art.

It should be appreciated that other objectives (and corresponding objective functions) may be used as part of the optimization process described above and in accordance with further embodiments of the invention. As a non-limiting example, maximizing the expected returns (or risk adjusted expected returns) after simulating the sell transactions denoted by vector X is an objective which may also be implemented in some embodiments and may be added in addition to any subset of the previous examples.

Having described various examples of objectives and associated mathematical expressions denoting objective functions, there is now provided a description regarding the processing of a plurality of objectives by computing an overall score for an asset selling vector based on objective values (or score elements) calculated for each objective. It would be appreciated that it may be a desirable result to find an optimal vector that achieves an optimal compliance with some or all of the above objectives, for example, by minimizing (or maximizing) each of the objective functions associated with these objectives. It would be appreciated that in some embodiments of the invention, finding an asset selling vector which provides an optimal compliance with some or all the above mentioned objectives, may include finding an asset selling vector which provides an optimal compliance with the following objectives (a-d): a) minimizing imbalances within the portfolio, where the imbalances are calculated based on a simulation of executing the transactions denoted by the asset selling vectors; b) minimizing the cost of the transactions denoted by the asset selling vectors; c) minimizing the variance related to the aforementioned imbalances and d) minimizing the change in the risk of the portfolio based on a simulation of executing the transactions denoted by the asset selling vectors.

It should be appreciated that since two or more objectives may conflict with one another, it may be quite uncommon for one asset selling vector to completely satisfy all (or even a plurality or a majority) of the objectives above. Therefore, in some embodiments of the invention, the target may be to find an asset selling vector which minimizes a single composite objective function which is based on a plurality of objective functions (and their associated score elements) with relative weights/factors that designate the importance or desirability of obtaining compliance with each one of a plurality of objectives. According to some embodiments of the invention, this target may be represented at least in part by the stop criterion which may be implemented as part of the optimization process, as was described in greater detail above.

In some embodiments, each expression that is related to an objective may include or may be associated with a factor. The factor may represent the importance of meeting the related objective or the desirability of meeting that objective and the factor may thus provide a mechanism to construct an overall objective function for resolving a scenario where conflicting objectives exist. For example, minimizing the total transaction(s) fees, may conflict with minimizing the variance of the differences, since minimizing fees may involve reducing the number of asset selling transactions, while minimizing the variance may involve the suggesting of many smaller-size asset selling transactions. It would be appreciated that in the above example, using a relatively large factor for the variance objective function (and its associated score element) may result in some priority being given to selling small portions of many portfolio assets for the sake of minimizing the variance of imbalances, rather than keeping transaction fees relatively low by selling larger quantities of fewer assets.

In some embodiments of the invention, one global objective value (Overall Score) may be calculated using a weighted sum of the individual objective values (or score elements) associated with each of the plurality of individual objectives as, for example, in the following equation:

OverallScore(X,P)=Σfₖ×ObjectiveValueₖ(X,P) Eq. OF5

where OverallScore is the overall score which measures the degree by which an asset selling vector X complies or satisfies a plurality of weighted objectives and is used by the optimization process to evaluate each asset selling vector X, where the k-th ObjectiveValue is calculated based on the k-th objective function denoted by the expression associated with the k-th objective and which measures the degree by which the asset selling vector X satisfies objective k. The k-th factor fₖ denotes the importance/weight associated with satisfying the k-th objective. It should be appreciated that in some embodiments, evaluating an asset selling vector X includes calculating the objective value (score element) with respect to X for each of the plurality of objectives (based on the objective function denoted by the expression associated with the objective) and then calculating the overall score as a weighted sum as in equation OF5.

It should be appreciated, that under certain circumstances, and according to some embodiments of the invention, a vector X′ may provide an “improvement” over another (previously generated) vector X (sometime we refer to such an “improving vector” as X′ is “better” than X) if the overall score associated with asset selling vector X′ is less than the overall score associated with asset selling vector X. In a similar way, asset selling vector X′ may be “BEST” amongst a set of asset selling vectors, if the overall score associated with vector X′ is no greater than the overall scores associated with each one of the vectors in set S. Here, a lower overall score indicates higher overall vector compliance with the predefined objective target (being minimized by the optimization process). It should be appreciated however, that a target objective function may be devised such that high overall compliance is expressed by a higher, rather than lower, overall score and the objective function is maximized by the optimization process.

Having provided a description with respect to some objectives which may be implemented as part of a process of determining an asset selling vector in respect of an investment portfolio, there is now provided a discussion with respect to certain constraints which, according to further embodiments of the invention, may also be part of the process of determining an asset selling vector for cash generation. In some embodiments, a set of constraints may be used as part of the process of determining an asset selling vector to further limit possible solutions of the cash generation process and eliminate some asset selling vectors from being considered as part of the process of determining an asset selling vector.

Provided below is a list of some non-limiting examples of constraints:
1. The sum of the values of the asset selling transactions denoted by an asset selling vector (X=(X1 . . . Xn), must be approximately equal to the needed cash amount as is denoted by the following equation:

$$NeededCashAmount ≅ {\sum }_{i = 1}^{n} Xi \qquad Eq . CON 1$$

where NeededCashAmount is the needed cash amount which the process is required to generate and Xi is the i-th selling value in vector X, denoting an asset selling transaction to sell Xi of the asset holding Hi. Note that in case the process searches for asset buying vector, the needed cash amount represents an available cash which we wish to “consume” by buying transactions.
2. The selling value Xi of an asset selling transaction denoted by asset selling vector X=(X1 . . . Xi . . . Xn) must be greater than a positive minimal size (MIN) or zero; i.e., Xi>MIN or Xi=0 for all selling values Xi in vector X.
3. The holding that is left after simulating the execution of a selling transaction with respect to a certain asset may be required to be zero or greater than a positive minimal amount (MIN); i.e. Hi-Xi>MIN or Hi-Xi=0 where, Hi-Xi is the holding that is left after selling Xi of that asset, and where Hi is the current market value of an asset holding which is associated with asset i within the portfolio and Xi is the selling value of an asset selling transaction associated with asset i within the portfolio denoted by an asset selling vector (X).
4. A certain user-defined holding Hi within the portfolio cannot be sold for the purpose of cash generation and therefore the selling value associated with Hi must be zero; i.e. Xi=0
5. Positions associated with a particular given strategy (S) may not be sold for the purpose of generating cash.

In some embodiments of the invention, constraints (including the above examples) may be considered objectives and may be implemented using objective functions (which are used for calculating objective values or score element s which in turn may be used for calculating the overall score). In some embodiments of the invention, objective functions which represent constraints may each be associated with a factor/weight which represents a relatively large penalty which may be placed upon any asset selling vector which fails to satisfy the constraint. As a non-limiting example, the first example of a constraint provided above which states that the asset selling vector must generate approximately the needed cash amount, may be implemented by minimizing an objective function that is calculated based on the following mathematical expression (with a positive factor f5):

$$f 5 \times {( NeededCashAmount - {\sum }_{i = 1}^{n} {X}_{i} )}^{2} \qquad Eq . OF 5$$

Where, NeededCashAmount is the needed cash amount to generate and Xi is the selling value Xi of the asset selling transaction associated with holding Hi and is denoted by the asset selling vector X=(X1 . . . Xi . . . Xn)

In other embodiments of the invention, a constraint may not be associated with an objective function, rather, the constraint may be enforced within the optimization algorithm by the process (or processes) that suggests possible solution candidates (i.e., generate candidate asset selling vectors). As part of the description of some embodiments of the invention, an example will be provided where the above constraint (according to which an asset selling vector may be required to denote asset selling transactions that (if executed) generate approximately the needed cash amount), is not implemented as an objective function but instead is enforced as a prerequisite condition for an asset selling vector as part of the processes that generate the candidate asset selling vectors.

Embodiments of the invention may use any optimization methods or techniques known in the art which suit the objective function and constraints. As a non-limiting example, embodiments of the invention that use only linear constraints and linear objective functions may use the Simplex method for linear programming. In further other embodiments, other techniques such as genetic algorithms may be used to find approximate solutions for the cash generation problem.

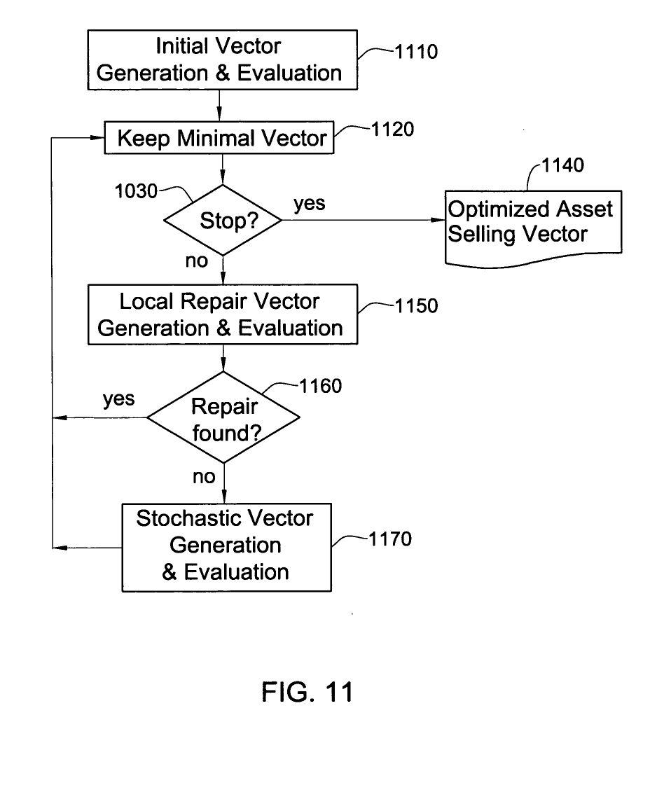

Reference is now made to FIG. 11, which is a flow chart illustration of a local repair technique which may be implemented as part of an optimization method of determining an asset selling or buying vector for cash generation or for reinvestment with respect to an investment portfolio, according to some embodiments of the invention. According to some embodiments of the invention, a local repair technique may be used to find an approximate solution, for example, as described hereinbelow.

1. Initially, a first candidate asset selling vector X=(X1 . . . Xn) which satisfies one or more constraints may be provided and its overall score may be evaluated (block 1110). According to some embodiment of the invention, evaluating the overall score may include calculating a set of objective values (score elements) in respect of the asset selling vector based upon each one of a plurality of predefined objective functions associated with pre-defined objectives and calculating the weighted sum of these objective values (as described above). A greedy algorithm may be used to find the first candidate asset selling vector X. An example of such greedy algorithm is provided further below.

2. The vector that is associated with a minimal (so far) overall score may be saved (kept as the minimal vector) as “BEST” vector (block 1120). According to some embodiments of the invention, referring to a certain vector being the “BEST” asset selling vector indicates that this vector is a vector with “better (e.g., minimal) overall score among those vectors found so far. In certain embodiments, a process, whereby the overall score associated with a most recently generated candidate asset selling vector (X) is checked to determine whether it is “better” (e.g. less) than an overall score associated with a saved asset selling vector (that is the “BEST” asset selling vector thus far), may be carried out. According to some embodiments of the invention, if the most recently generated asset selling vector has an overall score that is less than the overall score of the saved asset selling vector (which is the “BEST” so far), the most recently asset selling vector is saved (as “BEST”).

3. Next, a stop criterion may be evaluated (block 1130), and if the stop criterion is met, the optimization process may be terminated and the vector that is kept as minimal (associated with the minimal overall score so far—“BEST”) may be provided as an output of the process (block 1140). As a non-limiting example, implementing a stop criterion may include determining one or several of the following (3):

a) whether each one of a plurality of objective values is no greater than a predefined threshold.

b) whether the overall score associated with the asset selling vector is not greater than a predefined threshold.

c) whether the process has taken resources (e.g. computation resources and/or time resources) above certain pre-defined thresholds. 4. According to some embodiments of the invention, if the stop criterion is not met, a local repair algorithm may be used to slightly or moderately modify the current asset selling or buying vector and compute a relatively moderately modified (or synonymously, local repair vector or moderately modified vector) asset selling vector (block 1150) which satisfies the constraints and improves the overall score of X; i.e., the overall score of the new local repaired vector is better than the overall score of the vector prior to modification. The local repair algorithm may include evaluating a plurality of possible asset selling vectors X′ which are relatively moderately modified with respect to the previous vector X.

It should be appreciated that local repairing (i.e. moderately modifying) of a candidate solution to a problem is typically done in the art using a tractable and relatively simple modification of the candidate solution, in a way that the process of systematically exploring all possible such moderate modifications of the solution is tractable with a computational complexity polynomial in the size of X. Some embodiments of the invention use a finite set of increments and/or decrements by a predefined value of one or more elements of the modified vector. An example of such relatively simple and tractable moderate modification (local repair) that uses one increment and one decrement by a predefined value of two elements within a vector is described further below.

Evaluating the modified asset selling vectors in some embodiments, may include calculating an overall score for each one of the modified asset selling vectors X′ and selecting one of the modified vectors (if such are found) which results in a lowest (or greatest) overall score that is less (or greater) than the overall score associated with vector X. In other words, the local repair algorithm may be configured to search for a moderately modified vector X′ that is associated with the “BEST” overall score compared to other possible moderately modified asset selling vectors resulting by moderately modifying candidate vector X, providing that vector X′ also “improves” the overall score of vector X. An example of an algorithm for local repair is described later.

In some other embodiments of the invention, no search for “BEST” moderately modified vector is done, instead, the first moderately modified vector found with an associated overall score that is less (or greater in other embodiments) than the overall score associated with asset selling vector X, is selected (if one is found) as the local repair candidate vector. In some embodiments, the selected local repair asset selling vector must be a new candidate vector; i.e., one which has not been generated in previous steps of the process by either the initial step (block 1110) or the stochastic step (block 1170). In some embodiments of the invention, the selected local repair candidate vector may be required to satisfy one or more predefined constraints. If no moderately modified vector is found that “improves” the score of the previously generated vector (X), it may be determined in some embodiments that a candidate vector X is associated with a “local minimum” (or “local maximum” in other embodiments).

5. After the search for a moderately modified, local repair asset selling vector is performed, it may be determined in some embodiments, whether a local repair vector X′ that “improves” an overall score that is associated with vector X was found (block 1160). According to some embodiments of the invention, the process of searching for local repairs continues until either the stop criterion is met or no more local repairs are found. It should be appreciated that within this process, it may be determined that the selected local repair candidate vector X′ “improves” an overall score that is associated with vector X when the overall score associated with the vector X′ is less (or greater in other embodiments) than the overall score associated with previous asset selling vector X. If it is determined that the local repair vector X′ “improves” an overall score that is associated with vector X, the repair vector X′ may become the new candidate asset selling vector (X) and blocks 1120-1160 may be repeated with respect to the new candidate asset selling vector (X). As long as the stop criterion is not met, the search will continue for local repair vectors which may “improve” the overall score associated with a current “BEST” vector.

6. In certain embodiments, if no repair vector can be found that “improves” the overall score of a current asset selling vector (X), (meaning in certain embodiments that a local minimum/maximum was identified) a stochastic process may be carried out (block 1170). According to some embodiments of the invention, as part of the stochastic process, a new candidate asset selling vector (X) may be generated stochastically (for example, using a random number generator) using random number generation. In some embodiments, a vector generated by the stochastic process does not necessarily intend to “improve” the overall score of the “best” vector or even the previously generated vector. According to some embodiments of the invention, the stochastic process may intend to enable the optimization process to continue when the repair process reaches a state where a certain asset selling vector results in an overall score which is a local minimum/maximum (i.e., does not improve using local repair modifications), thus “escaping” from the local minimum/maximum. It would be appreciated that according to some embodiments of the invention, a candidate vector generated as a result of the stochastic process may be required to first satisfy the constraints (e.g. selling transactions denoted by vector X generates approximately the needed cash amount and have selling values (Xi) which are either zero or above some threshold). In accordance with some embodiments of the invention, the generated vector may be required to be a new vector which was not previously generated as an initial vector (block 1110) or as a stochastic vector (block 1170).

It should be appreciated that in some embodiments, calculating an overall score for an asset selling vector may include simulating an execution of the asset selling transactions denoted by the asset selling vector X with respect to the investment portfolio, evaluating the overall score based on the simulated holdings and/or positions resulting from the simulation and undoing the simulation results later to thereby revert to the actual situation within the portfolio. In some embodiments, simulating an execution of the denoted transactions includes calculating the effects of executing the denoted transactions on the holdings of the portfolio. It would be appreciated that other objectives which may be defined as part of a process of determining an asset selling or buying vector according to some embodiments of the invention may involve further and/or other simulations and estimations.

In certain embodiments of the invention, the initial step (block 1110) may be implemented based on a greedy algorithm for finding a first candidate asset selling vector which satisfies, at least, the needed cash amount generation constraint (see equation CON1) as follows:
a. Begin with a preliminary zero asset selling vector X=(0, 0 . . . 0) representing no selling transactions;
b. Implement the following search until the total amount of cash that is estimated (simulated) to be generated by executing the asset selling transactions denoted by the asset selling vector X approximately equals the needed cash amount:
c. Iteration step: Select the “best” delta increment for X=(X1, . . . Xj, . . . Xn); where a delta increment for asset selling vector X is another asset selling vector X′=(X1 . . . Xj+delta, . . . Xn), such that X′ represents the same asset selling transactions denoted by X except for the selling value of vector element Xj which is increased by a positive number delta; and where “best” delta increment as referred to herein relates to the “goodness” order relation that is induced over all asset selling vectors by the overall score. In other words, in some embodiments, “best” delta increment means that the overall score calculated in association with X′ is the minimal (maximal on other embodiments) among the overall scores calculated in association with all other delta increments possible for vector X and where delta is a relatively small positive value.
d. Replace X with the selected (“best” delta increment) X′ so that the search may continue based on the selected vector.

It should be appreciated that steps a and b above of the greedy algorithm may be repeated until the sum of values of the asset selling transactions denoted by asset selling vector X is approximately equal to the needed cash amount. It should be appreciated that the delta that is chosen must be small enough so that the needed cash amount may approximately be obtained (as the generated cash amount) as a result of executing the transactions denoted by the vector. The generated cash may be therefore in some embodiments, within a delta distance from the needed cash amount. It should also be appreciated that other constraints may be enforced in some embodiments by the above greedy algorithm, for example, enforcing minimal transaction size by using initial delta increments that are no smaller than the minimal transaction size; and enforcing minimal holding by constraining incrementing of a selling value (Xi) if the implication of the incrimination is that the estimated remainder of a certain holding (Hi-Xi) is less than a minimum (a certain threshold).

It should be appreciated that some embodiments of the invention may use in each iteration step a set of one or more delta increments or delta decrements. In such embodiments, the use of more than one delta increments/decrements may accelerate the optimization process by reducing the number of iterations on the one hand, while on the other hand using a plurality of delta increments/decrements may slow each iteration.

In some embodiments of the invention, it may be determined with respect to each delta increment vector whether or not some constraints are met by the vector and only delta increment vectors which fail a limited number or the minimal number of constraints may be considered. In some embodiments, all delta increments may be checked for constraint violations or incompliance and among the delta increments which violate the minimal number of constraints, one delta increment which provides the minimal overall score may be selected for step b above.

In accordance with other embodiments, a second greedy algorithm may begin with an asset selling vector denoting sell transactions, which, if executed, dispose as much assets (but not more than the needed cash amount) as possible which are associated with positions having a negative difference value (i.e., actual value associated with the position is higher than the ideal value associated with the position). In some embodiments, the process may be carried out in a manner so that first delta increments are added to positions which are associated with a negative difference until the asset selling transactions denoted by the proposed candidate asset selling vector X are estimated to generate (if executed) the needed cash amount or no more negative differences exist (after simulating the asset sell transactions). According to the second greedy algorithm, if still more cash is needed, additional delta increments (e.g., in steps) may be added to the asset selling vector, similarly to the first greedy algorithm above.

The following discussion provides a detailed description of how local repair may be defined and implemented, according to some embodiments of the invention. In some embodiments, a local repair process with respect to a first asset selling vector X=(X1 . . . Xn) may generate a second modified vector X′=(X1, . . . Xi−D, . . . Xj+D, . . . Xn), where, D is a relatively small predefined non-zero quantity and i and j reference elements of the vector denote holdings or positions associated with the portfolio. In order to generate X′, a pre-defined relatively small non-zero value, D may be added to element j within the asset selling vector X, denoting an asset selling transaction to sell Xj+D out of an asset holding associated with element j. The pre-defined positive value D may then be deducted from another element i within the asset selling vector X, denoting a transaction to sell Xj−D of the asset holding associated with element j; i.e., X′ may differ from X by two different elements i and j such that X′i=Xi−D and X′j=Xj+D. In other words, a set composed of a delta increment and a delta decrement modifies the vector by incrementing one element j of the vector and decrementing another element i of the vector by the same predefined value D.

It should be appreciated that according to certain embodiments of the invention, just as in the iterative step of the greedy algorithm above, each local repair step may use a set of one or few delta increments or delta decrements, so that at every step, a moderately modified vector may be generated by applying one or more delta increments/decrements. According to further embodiments, the repair step may not be directly constrained to the “needed cash approximate consumption” constraint, and, as discussed above, the “needed cash approximate consumption” may be evaluated within the overall score (as one of the objectives). An embodiment which implements a local repair step that is limited to a single delta increment/decrement may accelerate the search for a local repair, but may cause the number of iterations to be increased. Similarly, if in each local repair step, two or more delta increments/decrements are searched for, the search complexity may be increased (as more possible local repairs are checked), while the number of iterations may be reduced.

In some embodiments of the invention, the new vector X′ must satisfy certain predefined constraints; as a non limiting example, the selling value X′i must be non-negative and if X′i is greater than zero it must also be no less than a certain minimal transaction value or size. In addition in some embodiments, X′j should not exceed the market value of the asset holding (Hi) in the associated asset. In some embodiments when X′ violates constraints it is simply eliminated from being considered as a potential local repair vector. In certain embodiments of the invention, rules may be used to enforce these (or other) constraints. As non-limiting examples of such rules consider the following: If X′i>Hi then X′i=Hi; If X′i<0 then X′i=0; If (X′i>0 and X′i<MIN) then X′i=MIN; where, Hi is the asset holding of the asset associated with element i (or in some embodiments, the actual value of the position associated with element i) and MIN is the minimal transaction value. It should be appreciated that as previously discussed, some embodiments do not force the local repair step to satisfy some or all above constraints. Typically, such embodiments implement the constraints as one or more objectives which are handled within the overall score evaluation (within the objective function).

In some embodiments of the invention, stochastic generation of a new candidate asset selling vector is a process which may take a valid asset selling vector and may modify the vector by applying several local repair steps chosen in random using a random number generator. As a non-limiting example, the stochastic generation step may use one of the previously generated candidate asset selling vectors. According to another non-limiting example, the “BEST” vector found so far (where “BEST” is the vector with minimal overall score which is saved in block 1130 of FIG. 11) and apply a random number of local repair modifications on that vector. In some embodiments, each such local repair may also be randomly generated by randomly picking positions i and j to specify with respect to which values of the asset selling vector the repair is to be applied on. According to certain embodiments, the stochastic generation process applies a random number of delta increments/decrements with respect to a vector that is used as a base, or the stochastic generation process may include randomly generating a new vector from scratch. It should be appreciated that in these embodiments, the generated vector may not necessarily be required to satisfy the pre-defined constraints and rather rules or objectives which represent constraints within the objective function may be used as mentioned above.

It should be appreciated that in some embodiments of the invention, the stochastic generation uses randomness in order to create new candidate asset selling vectors and thus may have a chance of escaping from a local minimum/maximum situation where no local repairs may be found which “improve” the overall score.

The following is a non-limiting example of a cash generation process which includes a search for an asset selling vector which generates (if its denoted transactions are executed) a needed cash amount while optimizing objectives that are related to minimization of imbalances, variance of imbalances and costs with respect to the asset selling vector.

Example of a cash generation process according to some embodiments of the invention:

Consider two investment strategies 1 and 2 which are associated with a portfolio P. Both strategy 1 and strategy 2 have a proportion of 50:50; meaning that 50% of the investment portfolio is allocated for each one of the strategies 1 and 2. Strategy 1 recommends allocating 100% of the resources associated with that strategy for holding asset A, whereas strategy 2 recommends allocating 60% of the resources associated with the strategy for holding asset B and 40% of the resources for holding asset C.

### Strategy 1: 50%:

A 100%;

### Strategy 2: 50%:

B 60%;
C 40%

The actual holding (and actual position value) associated with asset A is 5,000 US Dollars. Similarly the actual holding that is associated with asset B is 2,000 US Dollars and 3000 US Dollars are associated with asset C. The total portfolio value is therefore 10,000 US Dollars. Since in this example, each of the assets A, B and C is associated with a single position (i.e., no multiple positions that are associated with a single asset), actual asset positions are also the asset holdings, and therefore, the asset positions (A, B and C) are denoted in this example, by the corresponding asset names; i.e. A, B and C. The following table presents actual position value, ideal percentage and ideal position value for each of the asset positions (A, B and C). Note, that ideal percentage of a position is the relative weight of a position within the portfolio as a whole and is obtained by multiplying the strategy proportion by the position weight within the strategy.

| | positions: | | | |
|---|---|---|---|---|
| Assets | A | B | C | Total portfolio |
| Actual position value (Holding) | 5000 | 2000 | 3000 | 10,000 |
| Ideal percentage out of P | 50% | 30% | 20% | 100% |
| Ideal position values | 5000 | 3000 | 2000 | 10,000 |

The ideal values of the recommended positions A, B and C are: 5000=10,000*50%*100% for A; 3000=10,000*50%*60% for B; and 2000=10,000*50%*40% for C. Note that according to some embodiments of the invention the ideal values, percentages out of the portfolio market value or the ideal position weights within the portfolio, may have been provided directly without the need to calculate them based on strategy proportions and position weights.

According to the present example all asset selling vectors are of the form: (X1,X2,X3). Each vector (X1,X2,X3) represents the following 3 asset selling transactions: selling X1 US Dollars of asset A; selling X2 US Dollars of asset B and selling X3 US Dollars of asset C.

Because the cash generation example provided herein is based on searching for an asset selling vector which optimizes a set of objectives, the objective functions that correspond to each of the objectives shall be shortly defined herein. Objective functions relating to position imbalances involving ideal and actual position values (such as minimizing imbalances and minimizing imbalances variance) are used in the current example of an optimization process according to some embodiments of the invention and will be described in the following:

Consider first the following mathematical notations that will be useful in explaining the calculations involved in calculating objective functions (score elements) related to position imbalances and cost and evaluating an overall score with respect to asset selling vectors:

Dif(X1)[A] denotes the calculated difference (position imbalance) between actual and ideal values of the asset position denoted by A (after simulating the execution of the transaction of selling X1 US Dollars out of the actual position value of asset A). Where calculating the difference is based on the following mathematical expression: Dif(X1)[A]=Actual[A]−X1−Ideal[A] which takes into account the effect (simulation) of selling X1 US Dollars from A, and

where Actual[A] and Ideal[A] are the actual and ideal values associated with asset position A and where X1 is the value in US Dollars of the selling transaction that is simulated.

AvgDif(X1,X2,X3) denotes the average of the differences (imbalances) associated with all asset positions in the portfolio (after simulating the execution of the asset selling transactions denoted by the asset selling vector (X1,X2,X3)). The average of the differences is used within the objective function associated with the imbalances variance minimization objective and may be calculated using the following mathematical expression:

AvgDif(X1,X2,X3)=(Dif(X1)[A]+Dif(X2)[B]+Dif(X3)[C])/3

Imbalance(X1,X2,X3) is an objective function denoting a measurement of the degree of imbalances after simulating the execution of the asset selling transactions denoted by the asset selling vector (X1,X2,X3). Minimizing the imbalances associated with positions recommended by strategies with which the portfolio is associated, is one of the objectives of the cash generation process in this example. The imbalances function in this example is calculated by totaling the squares of the differences associated with positions A, B and C (after simulating the execution of the asset selling transactions denoted by the vector (X1,X2,X3)). The Imbalance objective function is used in this example with a factor of 1/(500*500) and may be calculated using the following mathematical expression:

Imbalances(X1,X2,X3)=((Dif(X1)[A])²+(Dif(X2)[B])²+(Dif(X3)[C])²)/(500×500)

Another objective within the present cash generation example, is to minimize the variance of imbalances, so that recommended positions will not differ by too much (e.g., as defined by a certain threshold value) one from the other with respect to the amount of imbalance associated with each position. Var(X1,X2,X3) is an objective function that measures the variance of the imbalances (differences) after simulating the execution of the asset selling transactions denoted by the vector (X1,X2,X3). The variance objective function measures the degree of fluctuations of the differences (as a distance from their average). The objective function is calculated by summing of the squares of the distances between differences and the average difference, with factor 1/(500*500). The variance objective function may be calculated using the following mathematical expression:

VAR(X1,X2,X3)=((Dif(X1)[A]−AvgDif)²+(Dif(X2)[B]−AvgDif)²+(Dif(X3)[C]−AvgDif)/(500×500)

where AvgDif=(Dif(X1)[A]+Dif(X2)[B]+Dif(X3)[C])/3

Another objective within the present cash generation example, is to minimize the cost associated with executing the transactions denoted by the asset selling vector result of the current cash generation example. Cost (X1,X2,X3) is an objective function that measures the estimated cost of executing the asset selling transactions denoted by the vector (X1,X2,X3). The cost objective function is typically dependent on broker fee structure and/or tax estimation rules. In this example, a mathematical expression for calculating estimated cost is not provided, instead it is assumed that cost estimation is available for every asset selling vector (derived from a specific cost function) and sample examples of such costs are provided in Table 1 below (10^{th} column: Cost) in association with some examples of asset selling vector instances. The cost function may be calculated using a factor of 1/(500*500).

Further according to the present example, a mathematical expression may be provided which is effective for calculating an overall score with respect to a certain asset selling vector based on the results of applying the objective functions on the asset selling vector (X1,X2,X3). According to the present example, the mathematical expression which calculates the overall score may be effective for summing the weighted measures of all objectives (score elements) with respect to an asset selling vector. The overall score function may be calculated by adding the objective values calculated for each of the objective functions above with a weight of one for each objective value as in the following mathematical expression:

OverallScore(X1,X2,X3)=Cost(X1,X2,X3)+Var(X1,X2,X3)+Imbalance(X1,X2,X3).

It should be appreciated that in this example, the normalization factors associated with each of the objectives have been included within each of the objective functions above. It should be appreciated that in this example, the overall score calculation uses unit (1) weights (i.e., equal importance factors) for combining the objective values. However, as mentioned above and in accordance with further embodiments of the invention, the normalization factors may be applied at the overall score calculation stage for each objective value according to the relative factor (weight) associated with the objective with which that objective value corresponds.

The following table (Table 1) presents the calculated results of the expressions above for several examples of asset selling vectors.

TABLE 1

| X1 | X2 | X3 | Dif[A] | Dif[B] | Dif[C] | AvgDif | ImBalance | Var | Cost | OS |
|---|---|---|---|---|---|---|---|---|---|---|
| 500 | 0 | 0 | −500 | −1000 | 1000 | −166.7 | 9 | 8.2 | 80 | 97.2 |
| 1000 | 0 | 0 | −1000 | −1000 | 1000 | −333.3 | 12 | 8.9 | 160 | 180.9 |
| 0 | 500 | 0 | 0 | −1500 | 1000 | −166.7 | 13 | 12.6 | 120 | 145.6 |
| 0 | 1000 | 0 | 0 | −2000 | 1000 | −333.3 | 20 | 18.2 | 120 | 158.2 |
| 0 | 0 | 500 | 0 | −1000 | 500 | −166.7 | 5 | 4.6 | 80 | 89.6 |
| 0 | 0 | 1000 | 0 | −1000 | 0 | −333.3 | 4 | 2.2 | 250 | 256.2 |
| 500 | 0 | 500 | −500 | −1000 | 500 | −333.3 | 6 | 4.6 | 180 | 190.6 |
| 500 | 500 | 0 | −500 | −1500 | 1000 | −333.3 | 14 | 12.6 | 200 | 226.6 |
| 0 | 500 | 500 | 0 | −1500 | 500 | −333.3 | 10 | 8.2 | 200 | 218.2 |

Each row of the table denotes an asset selling vector instance X=(X1,X2,X3) where its asset selling values are denoted by the first three columns X1, X2 and X3. The fourth through sixth columns denote the differences (dif(i)) associated with each of the three assets positions (A, B and C) after the executing the transactions denoted by X. The seventh column denotes the average of the differences (AvgDif). The eight column denotes the imbalance objective value (imbalance) associated with the vector instance. The ninth column denotes the variance objective value (Var) associated with the vector instance. The tenth column denotes the cost objective value associated with the vector instance. The eleventh column denotes the overall score (OS) associated with the vector instance.

For example, consider the first row which represents asset selling vector X=(500,0,0). Related to this vector (500,0,0), the difference associated with position A is −500, the difference associated with B is −1000 and the difference associated with C is 1000. The average of all the differences for vector (500,0,0) is (500−1000+1000)/3=166.7. The objective value of the imbalance objective is calculated to be 9, the variance is 8.2, the cost is 80 and the overall score is 97.2.

The purpose of the cash generation optimization process is to find an asset selling vector which is associated with the lowest (or close to the lowest) overall score, and that denotes selling transactions such that if executed, will generate approximately 1000 US Dollars (the needed cash amount). The following discussion provides a step by step illustration example of an implementation of an optimization process according to some embodiments of the invention.

Initially (block 1110 of FIG. 11): a vector may be generated using a greedy algorithm. The greedy algorithm described above may provide the first asset selling vector. The following are the steps which may be implemented according to a non-limiting example of a greedy algorithm described above. The algorithm uses Delta=500.

Step 0: Start with vector (0,0,0) denoting no selling transactions. Step 1: Check all (3) possible delta increments to vector (0,0,0). The lowest overall score of 89.6 is found for a 500 delta increment with respect to position C, the selected vector X′=(0,0,500)) denotes a transaction to Sell 500 of C, (other alternative delta increments result in a higher overall score: OS(0,500,0)=145.6; OS(500,0,0)=97.2).

Step 2: Of all delta increments to (0,0,500), the vector X′=(500,0,500) has the lowest overall score of 190.6 (other alternative delta increments have a higher overall score: OS(0,500,500)=218.2; OS(0,0,1000)=256.2). At this point the vector represents transactions that generate (if executed) the needed cash amount of 1000 US Dollars and the greedy algorithm stops. Vector (500,0,500) is saved as the minimal vector (“BEST”) (block 1120 of FIG. 11). In accordance with the current example, according to the stop criterion that is implemented by the optimization process in this example (block 1130), when a vector is found which is associated with an overall score of less than 180 or when more than 10,000 vectors have been generated and evaluated, the optimization process is terminated (in the present example, the second stop criterion is never met and the process stops when good enough overall score under 180 is obtained). The asset selling vector found by the greedy algorithm of block 1110 is X=(500,0,500) with an overall score that is not less than 180, and thus the stop criterion is not yet met.

At this point in the optimization process a search for local repairs that “improve” the overall score found so far may be conducted (block 1150). Specifically, according to one example, a search may be carried out for local repair vectors which are associated with overall scores that are less than 190.6 which is the overall score of the “BEST” vector found so far.

At block 1150, the local repair may be processed with D=500. Each one of the possible local repairs is examined and evaluated. Each local repair vector is generated by adding D=500 to one position (i) and reducing D=500 from another position (j) as in the vector ( . . . Xi+D, . . . Xj−D . . . ), while enforcing constraints using rules. For example, when Xi+D does not exceed the actual value (or holding) of the associated position i and Xj−D is not negative and is not less than a certain MIN. The possible local repair vectors are examined and their overall score is calculated:

OS(1000,0,0)=180.9 (the lowest overall score)

OS(0,0,1000)=256.2

OS(0,500,500)=218.2

OS(500,500,0)=226.6

The vector (1000,0,0) is the repair vector that is found to be the next candidate asset selling vector since its overall score is the lowest, with objective value 180.9. Since a local repair vector that “improves” the overall score of the previous candidate vector is found (block 1160), this “new” repair vector is kept as the minimal vector (i.e., stored as the “BEST” vector so far) (block 1120). The stop criterion is applied to determine whether to continue with the optimization process, and since the stop criterion is not met (the overall score associated with the “BEST” vector is not less than 180), the optimization process continues. According to some embodiments of the invention, the optimization process may now continue with an additional local repair (block 1150); however, when no more improvements my be done, the local repair process results in a local minimum, the local repair process cannot further “improve” the overall score with which the vector (1000,0,0) is associated since all local repairs vectors based on vector (1000,0,0) have higher associated overall score:

OS(500,0,500)=190.6

OS(500,500,0)=226.6

According to some embodiments of the invention, under these circumstances, determining whether the repair vector “improves” an overall score that is associated with a current vector (block 1160) may return a “negative” result, and according to some embodiments, since a fail or negative response is received at block 1160 the stochastic process or stochastic algorithm (block 1170) may be initiated and carried out. It would be appreciated, that according to some embodiments of the invention introducing the stochastic process or algorithm may add randomness to the optimization process, for example, as a way of escaping from a local minimum (which a local repair process that is also part of the optimization process may not be able to improve).

Within the stochastic process or algorithm of the current example, a random number of random local repairs may be selected, and by combining the random number of local repairs together, an asset selling vector may be generated which has not been previously selected during the optimization process. It may be assumed for illustration purposes that the stochastic step (block 1170) uses a single randomly generated local repair operation of subtracting 500 from position A and adding it to position B (i.e., adding the local change vector: (−500,+500,0) to the previous candidate vector (1000,0,0)). This random local repair results in generating a new asset selling vector X′=(500,500,0) which is associated with an overall score of 226.6. Unlike the process of local repair, despite the fact that the overall score of the new vector is higher than the previously generated vector, according to some embodiments, this vector is taken to be the next candidate vector and is used in an attempt to escape the local minimum situation.

The overall score that is associated with the newly generated candidate asset selling vector (500,500,0) is not a minimal overall score, and therefore the new candidate asset selling vector is not kept (block 1120) as the “BEST” vector. However, since the stop criterion is not met yet (block 1130) a further local repair step (block 1150) may be processed:

As part of the subsequent local repair (block 1150) each of the possible local repair vectors which moderately modify the new candidate vector (500,500,0) is evaluated and the overall score for each such local repair vector is calculated:

OS(1000,0,0)=190.9

OS(0,1000,0)=158.2; (the minimal overall score)

OS(500,0,500)=190.6

OS(0,500,500)=218.2

The local repair vector which is associated with a minimal overall score X′=(0,1000,0) is selected. In this case, the selected repair vector represents a single selling transaction of 1000 US Dollars with respect to asset B. The selected asset selling vector is associated with the lowest overall score OS(0,1000,0)=158.2.

At block 1160, a repair vector is found and may be saved as “BEST” (minimal vector) at block 1120, after comparing it with the “BEST” vector. At block 1130, it may be determined that the optimization process should be halted or terminated since the stop criterion is met (i.e., the overall score of the last candidate vector is less than 180.

The optimal asset selling vector that was found is (0,1000,0) denoting the selling of 1000 US Dollars with respect to asset B. This asset selling vector is associated with the minimal overall score found so far.

There is now provided a process according to some embodiments of the invention, according to which an optimization process, for example, such as the ones described above, may be used for re-investing of a given amount of cash.

Reinvestment (hereinafter: “RI”) as used herein relates to a process of identifying an amount of cash (RI amount or RI value) that should be allocated to buying assets in a portfolio and suggesting buy transactions (e.g., trade orders) so that some pre-defined objectives may be obtained and/or some pre-defined constraints may be satisfied. According to some embodiments of the invention, a reinvestment process may include a process of determining an asset buying vector that is similar to the process of determining an asset selling vector. The elements of an asset buying vector are asset buying values X1, . . . Xn denoting asset buying transactions (instead of asset selling transactions—as in the case of an asset selling vector). An asset buying vector X=(X1, . . . Xn) may denote n buying transactions, such that Xi denotes a buying transaction with respect to an asset associated with an asset holding i or in some embodiments with respect to a recommended position i. The value of the corresponding buy transaction is denoted by the asset buying value Xi. In some embodiments of the invention, the recommended positions are recommended by a strategy with which the portfolio is associated.

Similar to the cash generation process, the RI process may initially calculate a needed cash amount for reinvestment (RI amount or RI value). According to some embodiments of the invention, a needed cash amount for reinvestment may be the cash value within the portfolio that is allocated for re-investing. In some embodiments, the RI amount (the needed cash amount for RI) may be provided by a user, advisor or broker, or calculated using rules, or as was described in detail above (based upon summing of certain differences or based upon the difference between cash holding and total of ideal values of cash positions—described in FIG. 5 and equations 6 and 6′). Once a needed cash amount for RI is obtained, the RI process may continue with a search for an optimal asset buying vector that minimizes certain objective functions and which satisfies certain constraints. It would be appreciated, that according to some embodiments of the invention, the vector output of the RI process may represent buying transactions which approximately depletes (or exhausts or expends or consumes) if executed, the allocated RI amount.

In one embodiment, a RI amount calculation process may be triggered whenever a significant, possibly predefined, change or event is detected with respect to a portfolio (as non-limiting examples for such change or event: a change with respect to a portfolio holding; a change with respect to a strategy that is associated with the portfolio; a significant change with respect to a market value of an asset which is held in the portfolio; detection of a new cash position; or cash transfer, etc.). According to further embodiments of the invention, a RI amount calculation process may be triggered periodically (e.g. monthly) or occasionally. Certain rules (similar to those described above with reference to a cash generation process, for example) may trigger the RI amount calculation process, where the calculated RI amount may be used within the reinvestment process as the needed cash amount is used within the cash generation process; for example, searching for an asset buying vector (instead of an asset selling vector) which denotes transactions that consume (or deplete or exhaust or expend or the like—which may be used interchangeably with the term “consume” or the like) the RI amount (instead of an asset selling vector denoting transactions that generate the needed cash amount) while satisfying some or all of the abovementioned constraints and minimizing some or all of the abovementioned objectives; e.g., transactional cost, imbalances; variance of imbalances; and/or change in risk which were described above.

In some embodiments, the needed cash amount for re-investment (RI amount) may be calculated using the RI value calculation process described above (for example with reference to FIG. 5). Therefore, according to some embodiments of the invention the RI amount may be calculated in some embodiments while considering a total amount of cash holding within the portfolio and the cash positions recommended by the strategies associated with the portfolio.

In some embodiments, the RI process may be substantially similar to the cash generation process described above. In one embodiment of the invention, the goal of the RI process, given a RI amount, may be to determine an asset buying vector which denotes non-negative buy transactions X=(B1, . . . Bn). According to some embodiments of the invention, each element value Bi that is part of the asset buying transactions vector may relate to an asset holding or to a position that is recommended by one or by several strategies with which the portfolio is associated, such that a certain given needed cash amount for RI (the abovementioned RI amount) is approximately consumed (or depleted or expended) by the buying transactions denoted by the vector (if executed), while satisfying the same or similar objectives and constraints as used by the cash generation process.

In some embodiments of the invention, the process of determining an asset buying transactions vector may include implementing constraints and objective function(s) that are similar to those which may be used as part of the process determining an asset selling vector (the latter was discussed in detail above). However, in some embodiments, the process of determining an asset buying vector may include implementing other constraints and/or objectives which are customized for the RI case as opposed to the cash generation. As a non limiting example, the process of determining an asset buying vector may include constraints which state that each one of the buy transactions denoted by the asset buying vector, if executed, must reduce a positive difference between ideal and actual position values (i.e., (ideal(i)-actual(i))>0 for all positions i with corresponding buy transaction), and should not generate a negative difference between ideal and actual position values (i.e., ideal(i)-(actual(i)+Bi)>=0, for all positions i). It should be appreciated that in some embodiments, negative differences may be allowed—up to a threshold when simulating buying transactions denoted by an asset buying vector. Therefore, as in another non limiting example, an asset buying value Bi should not denote a buy transaction which causes (if executed) the actual position value (after execution) to be significantly beyond an ideal value associated with that position.

An example of constraints which may be implemented as part of a process of determining an asset buying vector X=(B1 . . . Bi . . . Bn) may include the following:
1. The total of all asset buying values (Bi) is approximately equal to the RI amount which is the calculated needed cash amount for re-investment;
2. The values of the transactions denoted by an asset buying vector X=(B1 . . . Bi, . . . Bn) are non-negative and are either zero or greater than some minimum. For example, Bi should be such that Bi >=0 and if Bi>0, then Bi>MIN where MIN is some pre-defined positive minimum. It should be appreciated that in some embodiments the process may not seek to enforce the non-negative Bi constraint (Bi>−0) and as a result both buys and sells (e.g. selling short for opening or increasing a recommended short position) may be allowed. In some embodiments, in case an asset buying vector includes sell elements, the RI value is approximately consumed while taking into account sell vector elements, and together with the sell elements the overall score for a certain asset buying vector may be better. Similarly, certain embodiments of the cash generation process may allow both sells and buys while approximately generating the needed cash amount.
3. For all values of the transactions denoted by vector X=(B1 . . . Bi . . . Bn), If Bi>0 then the difference before executing the buy transaction must be positive (i.e., ideal(i)-actual(i)>0) and the difference after execution the transactions should be greater than a negative threshold. For example, (ideal(i)-(actual(i)+Bi))>-epsilon, where epsilon is a relatively small positive threshold. According to the constraint the asset selling transaction denoted by Bi may be used to reduce a positive difference associated with position i, but does not create a significant negative difference.
4. The number of units to buy denoted by an asset buying value Bi should be no less than a minimum; i.e., Bi divided by the unit price of an asset which is associated with position i is not less than a pre-defined minimum number of units.

In some embodiments, the objective functions that may be used as part of a process of determining an asset buying vector may include using substantially the same mathematical expressions that were mentioned above with respect to the objective functions that may be used as part of the cash generation process. A person of ordinary skill in the art may readily adapt the mathematical expressions as needed in order to accommodate for the changes between the process of searching optimal asset selling vector and the one searching for an optimal asset buying vector. As was the case with cash generation optimization process, in some embodiments, some or all of the above constraints may be implemented as objectives and may be part of the objective functions that are used by the optimization RI process for determining an asset buying vector.

In certain embodiments, the RI process may include searching for an asset buying vector of asset buying values (Bi's) that satisfies the constraints above (or a subset of these constraints) while minimizing or maximizing an objective function which is based on calculating an overall score which is based on a plurality of objectives values (score element s) with weights, as was described in detail for the cash generation process above.

In some embodiments of the invention, the RI process may include implementing a local repair process or algorithm and/or stochastic vector generation process or algorithm as described above with respect to the cash generation process above.

With respect to both the RI process and to the cash generation process, according to some embodiments of the invention, the asset selling vector with respect to the cash generation process (or the asset buying vector with respect to the RI process) may utilize other forms of asset selling (or buying) vectors for denoting asset selling (or buying) transactions. As a non-limiting example, consider the vector X=(X1 . . . Xi, . . . Xn), where each of the Xi's may represent a percentage of selling (or buying) of an asset holding associated with a certain position or positions; e.g. sell 20% of holding; buy 200% of holding; sell 100% of the actual value of position i, etc. In other embodiments, each one of the Xi's may represent the number of units to be sold (or bought) instead of the buying values (in a certain currency); e.g., sell 100 units of holding; buy 300 units of the asset associated with position i, etc. In other embodiments, each of the Xi's may represent a value of the actual position (e.g. in US dollar or in another currency or in units) that is left (or that is created) after executing the denoted selling or buying transaction. It should be appreciated that an asset selling or buying vector may be in any form or format as long as it is possible to calculate unambiguously which are the asset selling or buying transactions denoted by the vector.

It should be appreciated that according to some embodiments, the search for an asset selling vector (or the search for asset buying vector) which optimizes certain objectives and/or which satisfies certain constraints, is not guaranteed to find a vector with an associated overall score that is a global minimum (i.e. the absolute “best” vector, that satisfies all constraints and with the lowest associated overall score, is not guaranteed to be found). It would be appreciated that according to some embodiments, at least one reason for this is that the process as a whole and/or specific segments thereof may be resource bound (e.g. may stop because of time or computational limitations). As a result, according to some embodiments, the process may stop before the absolutely “best” vector is found and even before a large portion of the search space is explored. It would however also be appreciated, that according to some embodiments, the output of the optimization process may be the “best” vector or the optimal vector among those that were explored as part of the optimization process and when local repairs are used, it may be guaranteed that the output vector is associated with a local minimum/maximum of the overall score (though not necessarily a global minimum). It would also be appreciated that in certain embodiments of the invention, the objective function may be constructed so that it is maximized (rather than minimized). For clarity, reference has been made sometimes only to minimization; yet, the optimization process may be implemented either as a maximization or a minimization process.

Having described various embodiments of the invention, there is now provided a description of some implementations of some embodiments of the invention. The following is a description of certain implementations of some embodiments of the invention within a plurality of business scenarios. Embodiments of the invention may be used and may be implemented in accordance with any of scenarios/implementations described below, but further embodiments are not limited to any particular implementation and may be used in any other way and in any other business environment or for any other purposes and as part of any other scenario.

A method or system according to some embodiments of the invention may be implemented by one or more financial institutions (e.g. banks, broker/dealers, wealth management firms) and may enable clients of the financial institution to operate the system and typically manage their own portfolios by approving or modifying suggested transactions generated by the method or system. In some embodiments, transactions generated are executed without the approval of a particular user.

A method or system according to certain embodiments may be implemented internally within certain financial institutions (e.g. mutual funds, banks, Portfolio management firms) for the purpose of managing a portfolio belonging to the financial institution or to clients of the institution. The operator of a system or a method according to this implementation may be the owner of the portfolio, a representative of the portfolio owner or an employee of the institution.

Further embodiments of the system or the method may be implemented in a way unrelated to any financial institution. At least a portion of the system may be implemented over a central unit, such as a server for example, and operators of the system may be users accessing the system through the Internet, through a wireless communication link or via through any other communication channel. Implementation of the invention may be over the web where any registered user of a web service may be an operator of the system. Other embodiments may be implemented within a personal computer environment with or without access to remote account management systems or to a transaction ordering management system.

Certain embodiments may be integrated with financial software products or packages, such as, for example, Quicken® (a product by Intuit Inc. 2535 Garcia Avenue Mountain View, Calif. 94043, USA) or Microsoft Money (a product by Microsoft® Corporation One Microsoft Way, Redmond, Wash. 98052-6399, USA) where the user of the financial product is also the operator of the system and portfolio data is taken from the data base used by these software products.

The following describes possible implementations of the invention with regard to accessing account information systems for retrieving account data (e.g. retrieving asset holdings and/or portfolio market value).

Certain embodiments of the invention may interface (or be connected) directly to one or more account management systems (including virtual accounts) in one or more financial institutions and may be authorized to retrieve account data. In certain cases, a system or a process according to some embodiments of the invention may be authorized to execute transactions or to submit orders by interfacing with ordering management systems.

A system or a method according to certain embodiments may use a graphical user interface in order to allow users to input account data into the system manually. In some embodiments, software such as the one provided by Yodlee®, Inc. (Redwood City 3600 Bridge Parkway, Suite 200, Redwood City, Calif. 94065, USA.) may be used in order to access account information in a plurality of financial institutions.

A system or a method according to some embodiments of the invention may access account data by interfacing with internal accounting databases. According to other embodiments of the invention, data may be retrieved from personal financial products such as the above mentioned Microsoft Money by Microsoft® Corporation or Quicken® by Intuit Inc., or from portfolio tracking services such as those provided by Yahoo! Finance® (Registered trademark of Yahoo! Inc. 701 First Avenue Sunnyvale, Calif. 94089, USA),

A system or a method according to some embodiments of the invention, may mix the above data sources and allow account data to be retrieved from various financial institutions, internal databases, financial portals, personal finance web-sites, desktop computer software packages or may be received via a manual (keyed in) input.

The following describes possible implementations of the invention with regard to possible ways for enabling execution of transactions.

In some embodiments, the system may interface with (or be connected to) a transaction ordering management system within a financial institution. The system according to some embodiments of the invention may interface with one or more ordering systems residing in one or more financial institutions.

In some embodiments, suggested transactions may be sent for execution automatically (in an “automatic pilot” mode of operation), while in other embodiments, an operator has to approve a suggested transaction (through the use of a user interface) before the suggested transaction is sent for execution. In some embodiments, the operator is allowed to change/edit the transactions before they are sent for execution. According to still further embodiments, suggested transactions may not be sent for execution at all; rather an operator may get a report of the suggested transactions and may call a broker or use another system for submitting transactions for execution. Some embodiments may include a mix of some or all of the abovementioned alternatives. For example some suggested transactions which are related to certain strategies may be automatically sent for execution, whereas other suggested transactions may be sent for execution only after approval by a user (and possible editing by a user), and whereas still further suggested transactions may only be reported. The suggested transactions may be sent to the user for approval before execution and/or after execution (for notification) via plurality of channels such as email, cellular message (sms), letter or via a notification within a web site. In some embodiments of the invention, certain conditions may proactively trigger the execution of certain transactions. For example, a margin call may trigger a cash generation process and the automatic selling of certain assets.

The following describes possible implementations of the invention with regard to the choice of strategies.

According to some embodiments of the invention, a limit may be introduced, according to which the set of potential investment strategies with which an investment portfolio may be associated, may be restricted. In some embodiments, a portfolio may be associated with a fixed set of investment strategies. According to further embodiments, a limited choice of strategies is available for being associated with a portfolio and a user of the system may select a subset of the available strategies for associating the portfolio therewith.

In other embodiments, the addition of a practically unlimited set of investment strategies is allowed. In accordance with certain implementations, any Internet (World Wide Web) user may create one or more investment strategies and may manage position recommendations for these strategies on an on-going basis in an explicit or implicit way. Thus, the strategy set (e.g., an investment strategy catalogue) that is available may be open-ended and may grow without any practical limits. In according with certain embodiments, this approach may create an open market for strategies, where strategy providers may offer their recommendations and investors may make use of these recommendations by associating their portfolio with any set of strategies as they wish. Certain embodiments implement a strategy catalogue which may be either open ended or closed for addition of new strategies. The user may browse through the strategies within the catalogue, view information regarding the individual strategies (e.g. past performance, returns, risk, sharp ratio, price, etc.), select one or more investment strategies with which the portfolio is to be associated and assign proportions for these strategies in order to follow them while reducing imbalances. The user may receive suggested recommendations on an on-going basis based on his/her selection.

The following describes possible implementations of some embodiments of the invention with regard to the number of investment portfolios. According to some embodiments, a single portfolio may be maintained with a single set of associated strategies with proportions between the strategies. Other embodiments contemplate maintaining more than one portfolio, and each portfolio may be associated with one or more strategies and with proportions amongst the strategies. It is thus possible, in accordance with some embodiments, for multiple portfolios to be associated with a single investment strategy. Some embodiments allow a single user to utilize the system while other embodiments may include allowing a plurality of users to manage plurality of investment portfolios and a plurality of investment strategies. The following describes possible implementations of some embodiments of the invention with regard to the way by which strategy changes may be entered. In accordance with some embodiments, a user is allowed to maintain an investment portfolio or an account and publish it as a strategy so that recommended position weights are derived from the portfolio based upon transactions within the portfolio and based upon the asset holdings within the portfolio. In accordance with some embodiments, orders to buy or sell assets may be interpreted as changes to a strategy (e.g., buying an asset as a percentage of the available cash, selling an asset as a percentage of current holding of that security, change the weight of a security within a strategy, etc.). In other embodiments, the actual transactions within a portfolio or an account are interpreted as strategy changes. Some embodiments allow a strategy change based on an executed transaction (e.g. as reported by an exchange or financial institution). Further embodiments allow order entry, but consider a strategy change only if the order may be executed hypothetically (e.g., as in a market simulation environment). Still further embodiments consider transactions entered within an account as a source of strategy changes without necessarily checking its validity or execution feasibility.

Some embodiments enable the direct maintenance of a model portfolio based on weighted holdings (e.g. where percentage is allocated for each security including cash). A user or an automatic process may be responsible for performing changes to the model portfolio and those changes may be interpreted as strategy changes.

In some embodiments of the invention, a strategy may contain one or more asset classes (e.g. Bonds, US domestic stock, Real estate, Commodities, Emerging markets, etc.). Each strategy may recommend positions in products (such as ETFs-Exchange Traded Funds, Index Funds etc. . . . ) that are relevant to a one or more asset classes associated with the strategy.

Some embodiments of the invention may use any combination of the implementation options above.

It would be appreciated that the above implementations are provided by way of example only, and that other embodiments of the invention may not be limited to the implementations discussed hereinabove.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

While certain features of the invention have been illustrated and described herein, many modifications, substitutions, changes, and equivalents will occur to those skilled in the art. It is therefore to be understood that the appended claims are intended to cover all such modifications and changes as fall within the true scope of the invention.

What is claimed is:

1. A system for managing an investment portfolio that is associated with at least two investment strategies, at least one of said investment strategies providing a strategy change in respect of a non-cash position by explicitly or implicitly specifying a recommended change value for the non-cash position, said system comprising:
a portfolio management processor, said portfolio management processor is responsive to said strategy change in respect of said non-cash position for calculating a cash allocation for a cash position of an investment strategy providing said change, wherein said cash allocation is based upon:
a recommended relative weight for said cash position, said relative weight is provided explicitly or implicitly by said investment strategy providing said change,
a relative weight of at least one other cash position, said relative weight is provided explicitly or implicitly by at least one other investment strategy with which said investment portfolio is associated,
a specified proportion between said two or more investment strategies with which said investment portfolio is associated, and
a value of a cash holding within said investment portfolio; and
said portfolio management processor is further responsive to said investment strategy providing said change for calculating a suggested transaction based upon said change value specified explicitly or implicitly by said strategy providing said change in respect of said non-cash position, and based upon said cash allocation calculated for said cash position of said investment strategy providing said change.

2. The system according to claim 1, wherein said portfolio management processor is adapted to calculate said cash allocation based at least on a proportion between at least ideal values of at least two cash positions, and wherein the ideal value of each one of said at least two cash positions is based on a recommended relative weight of that cash position as provided explicitly or implicitly by a respective investment strategy with which said portfolio is associated, and said proportion between ideal values is based on said specified proportion between said at least two said investment strategies with which said portfolio is associated.

3. The system according to claim 2, wherein said portfolio management processor is adapted to calculate said cash allocation based upon a ratio between an ideal value calculated for a cash position provided by said investment strategy providing said change and based upon a sum of ideal values of cash positions provided by said at least two investment strategies with which said investment portfolio is associated, and wherein an ideal value for a position is based upon at least the following:
said specified proportion between said two or more investment strategies with which said investment portfolio is associated;
a recommended relative weight provided explicitly or implicitly in respect of that position by an investment strategy with which said portfolio is associated.

4. The system according to claim 3, wherein said portfolio management processor is adapted to:
calculate an ideal transaction value in respect of said non-cash position to which said strategy change relates based upon said recommended change value specified explicitly or implicitly by said strategy providing said change with respect to said non-cash position; and
determine said suggested transaction based upon at least said ideal transaction value and said cash allocation calculated for said cash position of said investment strategy providing said change.

5. The system according to claim 2, wherein:
said portfolio management processor is further adapted to determine an actual value for a position that is provided by an investment strategy with which said investment portfolio is associated based upon at least a value of a portfolio holding within said portfolio in an asset with which said position is associated, and
wherein said portfolio management processor is further adapted to calculate an ideal value for a position that is provided by an investment strategy with which said investment portfolio is associated based upon at least the following:
a value of said investment portfolio;
said specified proportion between said two or more investment strategies with which said investment portfolio is associated;
a recommended relative weight for that position provided explicitly or implicitly by one of said two or more investment strategies.

6. The system according to claim 5, wherein said portfolio management processor is adapted to calculate said suggested transaction based upon a difference between an ideal value and an actual value of said non-cash position to which said strategy change relates or based upon a comparison between an ideal value and an actual value of said non-cash position to which said strategy change relates.

7. The system according to claim 4, wherein said recommended change value explicitly or implicitly specified by said strategy providing said change with respect to said non-cash position relates to a certain portion or fraction of a model portfolio suggested explicitly or implicitly by said strategy, and wherein said portfolio management processor is adapted to calculate said ideal transaction value based upon said portion or fraction and based upon a value of said investment portfolio and further based upon said specified proportion between said two or more investment strategies with which said investment portfolio is associated.

8. The system according to claim 2, wherein said recommended change value specified by said strategy providing said change with respect to said non-cash position relates explicitly or implicitly to a certain portion or fraction of a cash position provided by said investment strategy providing said change, and wherein said portfolio management processor is adapted to calculate said suggested transaction based upon said portion or fraction and further based upon either said cash allocation calculated for said cash position provided by said investment strategy or an ideal value of said cash position provided by said investment strategy providing said change, and wherein said ideal value for said cash position is based upon at least the following:
a value for said investment portfolio, wherein said value for said portfolio is based upon a totaling of values of each asset holding within said investment portfolio;
said specified proportion between said at least two investment strategies with which said investment portfolio is associated; and
a recommended relative weight provided explicitly or implicitly for said cash position by said strategy providing said change.

9. The system according to claim 2, further comprising:
a strategy manager, said strategy manager is adapted to monitor investment strategies with which said investment portfolio is associated for detecting said strategy change with respect to a non-cash position provided by a strategy with which said investment portfolio is associated, and wherein said portfolio management processor is responsive to said strategy manager detecting said strategy change, for calculating said cash allocation and said suggested transaction.

10. The system according to claim 9, wherein said portfolio management processor is responsive to said strategy manager detecting said strategy change for determining the following:
an actual value for said non-cash position to which said strategy change relates, said actual value calculation is based upon at least a value of an asset holding that is associated with said non-cash position;
an ideal value of said non-cash position to which said strategy change relates, said ideal value is based upon at least the following:
a value of said investment portfolio,
said specified proportion between said two or more investment strategies with which said investment portfolio is associated;
a recommended relative weight for said non-cash position to which said strategy change relates as provided explicitly or implicitly by said investment strategy providing said change;
and wherein said portfolio management processor is further responsive to said strategy manager detecting said strategy change for determining whether said strategy change with respect to said non-cash position is consistent with a recommendation to buy said non-cash position, wherein said strategy change is determined to be consistent with a recommendation to buy said non-cash position when said ideal value of said non-cash position is greater than said actual value of said non-cash position.

11. The system according to claim 10, wherein said portfolio management processor is responsive to said strategy manager detecting one or more strategy changes which relate to at least a first and a second non-cash positions and which are consistent at least with a recommendation to sell a first non-cash position and with a recommendation to buy a second non-cash position, for:
providing a suggested sell transaction in respect of said first non-cash position;
calculating effects of executing said suggested sell transaction over a value of a cash holding within said investment portfolio;
calculating a cash allocation for a cash position of an investment strategy providing the change in respect of said second non-cash position based on a value of the cash holding within said investment portfolio after calculating said effects of executing said suggested sell transaction;
calculating a suggested buy transaction in respect of said second non-cash position based upon said change value specified explicitly or implicitly by said strategy providing said change in respect of said second non-cash position, and based upon said cash allocation calculated for said cash position of said investment strategy providing said change with respect to said second non-cash position.

12. The system according to claim 5, wherein said portfolio management processor is adapted to calculate a reinvestment value either based upon a sum of one or more differences between respective ideal values and actual values of non-cash positions provided explicitly or implicitly by an investment strategy with which said investment portfolio is associated, or based upon a sum of a plurality of ideal values of cash positions provided explicitly or implicitly by said investment strategies with which said portfolio is associated, and wherein said portfolio management processor is further adapted to calculate said cash allocation further based on said reinvestment value.

13. The system according to claim 12, wherein said reinvestment value corresponds to a sum of differences between respective ideal values and actual values of non-cash positions whose ideal value is greater than those positions' respective actual value.

14. The system according to claim 12 wherein said reinvestment value corresponds to a difference between a value of a cash holding within said portfolio and a sum of a plurality of ideal values of cash positions provided explicitly or implicitly by said investment strategies with which said portfolio is associated.

15. The system according to claim 12, wherein said cash allocation is calculated based on the following:
a value of a cash holding within said investment portfolio;
a proportion among values that correspond to cash reservation needs, said cash reservation needs include ideal values of said cash positions and further include said reinvestment value.

16. The system according to claim 15, wherein said cash allocation calculation is based upon at least a ratio between an ideal value for said cash position provided by said investment strategy providing said change and the sum of said reinvestment value and a totaling of said ideal values of each one of said cash positions provided by an investment strategy with which said investment portfolio is associated.

17. The system according to claim 5, wherein as part of calculating an actual value for a non-cash position, said portfolio management processor is responsive to there being at least one more non-cash position that is provided by an investment strategy with which said portfolio is associated and which is associated with the asset with which the non-cash position for which the actual value being calculated is associated, for calculating said actual value based at least upon a value of said asset holding and upon a proportion amongst values related to each one of said non-cash positions that are associated with that asset.

18. The system according to claim 17, wherein said proportion amongst said values related to each one of said non-cash positions that are associated with that said asset, is a proportion amongst ideal values of each one of said non-cash positions.

19. The system according to claim 17, wherein each one of said values related to each one of said non-cash position that are associated with said asset is derived from one or more historical transactions associated with said non-cash position.

20. The system according to claim 19 wherein each one of said values related to a non-cash position associated with said asset is derived based upon a totaling of values associated with one or more historical suggested or executed or ordered transactions associated with said non-cash position.

21. The system according to claim 18, wherein said actual value is calculated based upon a ratio between an ideal value for said first non-cash position provided explicitly or implicitly by said strategy change and a totaling of ideal values calculated for each one of said non-cash positions.

22. The system according to claim 9, wherein:
said strategy manager is adapted to detect a strategy change consistent with a recommendation to buy a non-cash position, based upon one or more of the following recommended change values which are specified explicitly or implicitly by the said investment strategy providing said strategy change:
a relative weight recommended by said strategy in respect of said non-cash position;
a portion or fraction of an amount of cash recommended by said strategy for being allocated for a transaction with respect of said non-cash position or for a holding in said non-cash position; and/or
a portion or fraction of a strategy ideal value that is recommended explicitly or implicitly by said strategy for being allocated for a transaction with respect of said non-cash position; said strategy ideal value is calculated based upon a market value of said portfolio associated with said strategy and further based upon said proportion between said strategies with which the portfolio is associated.

23. The system according to claim 9, further comprising a strategy translator, said strategy translator being responsive to said strategy manager detecting a strategy change with respect to a non-cash position recommended by said strategy which is provided in a format other than a specified format for translating said strategy change into said specified format.

24. The system according to claim 9, wherein said strategy manager is configured to monitor at least one investment strategy with which a plurality of investment portfolios are associated, and in response to detecting a strategy change with respect to a non-cash position recommended explicitly or implicitly by said strategy, said strategy manager is adapted to notify each one of a plurality of portfolio management processors that are respectively associated with said plurality of investment portfolios.

25. The system of claim 24, further comprising a strategy allocation database adapted for storing data with respect to a plurality of investment portfolios which are each associated with investment strategies and for storing with respect to each one of said plurality of portfolio a specified proportion between the respective investment strategies with which that portfolio is associated.

26. A method of managing an investment portfolio that is associated with at least two investment strategies, at least one of said investment strategies providing a strategy change in respect of a non-cash position by explicitly or implicitly specifying a recommended change value for the non-cash position, said method comprising:
receiving a notification regarding said strategy change;
calculating a cash allocation for a cash position of an investment strategy providing said change, wherein said cash allocation is based upon:
a recommended relative weight for said cash position, said relative weight is provided explicitly or implicitly by said investment strategy providing said change,
a relative weight of at least one other cash position, said relative weight is provided explicitly or implicitly by at least one other investment strategy with which said investment portfolio is associated,
a specified proportion between said two or more investment strategies with which said investment portfolio is associated, and
a value of a cash holding within said investment portfolio; and
calculating a suggested transaction based upon said change value specified explicitly or implicitly by said strategy providing said change in respect of said non-cash position, and based upon said cash allocation calculated for said cash position of said investment strategy providing said change.

27. The method according to claim 26, wherein said calculating a cash allocation further comprises calculating said cash allocation based at least on a proportion between at least ideal values of at least two cash positions, and wherein the ideal value of each one of said at least two cash positions is based on a recommended relative weight of that cash position as provided explicitly or implicitly by a respective investment strategy with which said portfolio is associated, and said proportion between ideal values is based on said specified proportion between said at least two said investment strategies with which said portfolio is associated.

28. The method according to claim 27, wherein said calculating a cash allocation further comprises calculating said cash allocation based upon a ratio between an ideal value calculated for a cash position provided by said investment strategy providing said change and based upon a sum of ideal values of cash positions provided by said at least two investment strategies with which said investment portfolio is associated, and wherein an ideal value for a position is based upon at least the following:
said specified proportion between said two or more investment strategies with which said investment portfolio is associated;
a recommended relative weight provided explicitly or implicitly in respect of that position by an investment strategy with which said portfolio is associated.

29. The method according to claim 28, wherein said calculating a suggested transaction further comprises:
calculating an ideal transaction value in respect of said non-cash position to which said strategy change relates based upon said recommended change value specified explicitly or implicitly by said strategy providing said change with respect to said non-cash position; and
determining said suggested transaction based upon at least said ideal transaction value and said cash allocation calculated for said cash position of said investment strategy providing said change.

30. The method according to claim 27, wherein said calculating a cash allocation further comprises:
determining an actual value for a position that is provided by an investment strategy with which said investment portfolio is associated based upon at least a value of a portfolio holding within said portfolio in an asset with which said position is associated; and
calculating an ideal value for a position that is provided by an investment strategy with which said investment portfolio is associated based upon at least the following:
a value of said investment portfolio;
said specified proportion between said two or more investment strategies with which said investment portfolio is associated;
a recommended relative weight for that position provided explicitly or implicitly by one of said two or more investment strategies.

31. The method according to claim 30, wherein said calculating a suggested transaction further comprises calculating said suggested transaction based upon a difference between an ideal value and an actual value of said non-cash position to which said strategy change relates or based upon a comparison between an ideal value and an actual value of said non-cash position to which said strategy change relates.

32. The method according to claim 29, wherein said recommended change value explicitly or implicitly specified by said strategy providing said change with respect to said non-cash position relates to a certain portion or fraction of a model portfolio suggested explicitly or implicitly by said strategy, and wherein said calculating a suggested transaction further comprises calculating said ideal transaction value based upon said portion or fraction and based upon a value of said investment portfolio and further based upon said specified proportion between said two or more investment strategies with which said investment portfolio is associated.

33. The method according to claim 27, wherein said recommended change value specified by said strategy providing said change with respect to said non-cash position relates explicitly or implicitly to a certain portion or fraction of a cash position provided by said investment strategy providing said change, and wherein said calculating a suggested transaction further comprises calculating said suggested transaction based upon said portion or fraction and further based upon either said cash allocation calculated for said cash position provided by said investment strategy or an ideal value of said cash position provided by said investment strategy providing said change, and wherein said ideal value for said cash position is based upon at least the following:
a value for said investment portfolio, wherein said value for said portfolio is based upon a totaling of values of each asset holding within said investment portfolio;
said specified proportion between said at least two investment strategies with which said investment portfolio is associated; and
a recommended relative weight provided explicitly or implicitly for said cash position by said strategy providing said change.

34. The method according to claim 27, further comprising:
receiving an indication relating to a strategy change with respect to a non-cash position provided by a strategy with which said investment portfolio is associated; and
triggering in response to receiving said indication at least said calculating a cash allocation and said calculating a suggested transaction.

35. The method according to claim 34, further comprising:
determining an actual value for said non-cash position to which said strategy change relates, said actual value is determined based upon at least a value of an asset holding that is associated with said non-cash position;
determining an ideal value of said non-cash position to which said strategy change relates, said ideal value is determined based upon at least the following:
a value of said investment portfolio,
said specified proportion between said two or more investment strategies with which said investment portfolio is associated;
a recommended relative weight for said non-cash position to which said strategy change relates as provided explicitly or implicitly by said investment strategy providing said change; and
determining whether said strategy change with respect to said non-cash position is consistent with a recommendation to buy said non-cash position, wherein said strategy change is determined to be consistent with a recommendation to buy said non-cash position when said ideal value of said non-cash position is greater than said actual value of said non-cash position.

36. The method according to claim 27, wherein said receiving an indication comprises receiving an indication relating to one or more strategy changes with respect to at least a first and a second non-cash positions and which one or more strategy changes are consistent at least with a recommendation to sell the first non-cash position and with a recommendation to buy the second non-cash position, and further comprising:
providing a suggested sell transaction in respect of said first non-cash position;
calculating effects of executing said suggested sell transaction over a value of a cash holding within said investment portfolio;
calculating a cash allocation for a cash position of an investment strategy providing the change in respect of said second non-cash position based on a value of the cash holding within said investment portfolio after calculating said effects of executing said suggested sell transaction;
calculating a suggested buy transaction in respect of said second non-cash position based upon said change value specified explicitly or implicitly by said strategy providing said change in respect of said second non-cash position, and based upon said cash allocation calculated for said cash position of said investment strategy providing said change with respect to said second non-cash position.

37. The method according to claim 30, further comprising calculating a reinvestment value either based upon a sum of one or more differences between respective ideal values and actual values of non-cash positions provided explicitly or implicitly by an investment strategy with which said investment portfolio is associated, or based upon a sum of a plurality of ideal values of cash positions provided explicitly or implicitly by said investment strategies with which said portfolio is associated, and wherein said calculating a cash allocation further comprises calculating said cash allocation further based on said reinvestment value.

38. The method according to claim 30, wherein said calculating a reinvestment value comprises calculating a sum of differences between respective ideal values and actual values of non-cash positions whose ideal value is greater than those positions' respective actual value.

39. The method according to claim 30, wherein said calculating a reinvestment value comprises calculating a difference between a value of a cash holding within said portfolio and a sum of a plurality of ideal values of cash positions provided explicitly or implicitly by said investment strategies with which said portfolio is associated.

40. The method according to claim 27, wherein said calculating a cash allocation further comprises calculating said cash allocation based on the following:
a value of a cash holding within said investment portfolio; and
a proportion among values that correspond to cash reservation needs, said cash reservation needs include ideal values of said cash positions and further include said reinvestment value.

41. The method according to claim 40, wherein said calculating a cash allocation further comprises calculating said cash allocation based on at least a ratio between an ideal value for said cash position provided by said investment strategy providing said change and the sum of said reinvestment value and a totaling of said ideal values of each one of said cash positions provided by an investment strategy with which said investment portfolio is associated.

42. The method according to claim 30, wherein said determining an actual value for a non-cash position further comprises:
determining whether there is at least one more non-cash position that is provided by an investment strategy with which said portfolio is associated, and which is associated with the asset with which the non-cash position for which the actual value is calculated, is associated; and
in response to determining that there is at least one more non-cash position which is associated with the asset with which the non-cash position for which the actual value is calculated, calculating said actual value based at least upon a value of said asset holding and upon a proportion amongst values related to each one of said non-cash positions that are associated with that asset.

43. The method according to claim 42, wherein said proportion amongst said values related to each one of said non-cash positions that are associated with that said asset, is a proportion amongst ideal values of each one of said non-cash positions.

44. The method according to claim 42, further comprising deriving each one of said values related to each one of said non-cash position that are associated with said asset from one or more historical transactions associated with said non-cash position.

45. The method according to claim 43, wherein said determining an actual value for a non-cash position further comprises determining an actual value for a non-cash position based upon a ratio between an ideal value for said first non-cash position provided explicitly or implicitly by said strategy change and a totaling of ideal values calculated for each one of said non-cash positions.

46. The method according to claim 43, wherein said determining an actual value for a non-cash position further comprises determining an actual value for a non-cash position based upon a ratio between an ideal value for said first non-cash position provided explicitly or implicitly by said strategy change and a totaling of ideal values calculated for each one of said non-cash positions.

47. The method according to claim 34, wherein said receiving an indication relating to a strategy change further comprises determining whether said strategy change is consistent with a recommendation to buy a non-cash position, based upon one or more of the following recommended change values which are specified explicitly or implicitly by the said investment strategy providing said strategy change:
a relative weight recommended by said strategy in respect of said non-cash position;
a portion or fraction of an amount of cash recommended by said strategy for being allocated for a transaction with respect of said non-cash position or for a holding in said non-cash position; and/or
a portion or fraction of a strategy ideal value that is recommended explicitly or implicitly by said strategy for being allocated for a transaction with respect of said non-cash position; said strategy ideal value is calculated based upon a market value of said portfolio associated with said strategy and further based upon said proportion between said strategies with which the portfolio is associated.

48. The method according to claim 34, further comprising translating a strategy change with respect to a non-cash position recommended by said strategy which is provided in a format other than a specified format.

49. The method according to claim 34, further comprising:
receiving an indication relating to a strategy change with respect to a non-cash position provided by at least one investment strategy with which a plurality of investment portfolios are associated;
performing at least said calculating cash allocation and said calculating a suggested transaction with respect to each one of said plurality each one of said plurality of investment portfolios which are associated with said at least one investment strategy.

50. A program storage device readable by machine, tangibly embodying a program of instructions executable by the machine to perform a method of managing an investment portfolio that is associated with at least two investment strategies, at least one of said investment strategies providing a strategy change in respect of a non-cash position by explicitly or implicitly specifying a recommended change value for the non-cash position, said method comprising:
receiving a notification regarding said strategy change;
calculating a cash allocation for a cash position of an investment strategy providing said change, wherein said cash allocation is based upon:
a recommended relative weight for said cash position, said relative weight is provided explicitly or implicitly by said investment strategy providing said change,
a relative weight of at least one other cash position, said relative weight is provided explicitly or implicitly by at least one other investment strategy with which said investment portfolio is associated,
a specified proportion between said two or more investment strategies with which said investment portfolio is associated, and
a value of a cash holding within said investment portfolio; and
calculating a suggested transaction based upon said change value specified explicitly or implicitly by said strategy providing said change in respect of said non-cash position, and based upon said cash allocation calculated for said cash position of said investment strategy providing said change.

51. A computer program product comprising a computer useable medium having computer readable program code embodied therein of managing an investment portfolio that is associated with at least two investment strategies, at least one of said investment strategies providing a strategy change in respect of a non-cash position by explicitly or implicitly specifying a recommended change value for the non-cash position, said computer program product comprising:
computer readable program code for causing the computer to receive a notification regarding said strategy change;
computer readable program code for causing the computer to calculate a cash allocation for a cash position of an investment strategy providing said change, wherein said cash allocation is based upon:
a recommended relative weight for said cash position, said relative weight is provided explicitly or implicitly by said investment strategy providing said change,
a relative weight of at least one other cash position, said relative weight is provided explicitly or implicitly by at least one other investment strategy with which said investment portfolio is associated,
a specified proportion between said two or more investment strategies with which said investment portfolio is associated, and
a value of a cash holding within said investment portfolio; and
computer readable program code for causing the computer to calculate a suggested transaction based upon said change value specified explicitly or implicitly by said strategy providing said change in respect of said non-cash position, and based upon said cash allocation calculated for said cash position of said investment strategy providing said change.

52. A computer system for determining an optimal asset selling or buying vector in respect of assets within an investment portfolio that is associated with a plurality of investment strategies according to a predefined proportion between the strategies, and each one of the plurality investment strategies providing explicitly or implicitly a recommended relative weight with respect to cash and/or non-cash positions, said system comprising:
a cash generating or reinvesting module adapted to obtain each one of the following:
an ideal value for each one of a plurality of positions recommended by at least one of said plurality of strategies, said ideal value is calculated based upon: a recommended relative weight for its respective position as provided explicitly or implicitly by at least one of said plurality of strategies and said predefined proportion between said plurality of strategies;
a needed cash amount for either cash generation or reinvesting;
an optimizer adapted to:
provide an objective function for scoring an asset selling or buying vector, said objective function is sensitive to a degree by which selling or buying transactions denoted by an asset selling or buying vector affect differences between actual values of a plurality of positions recommended by at least one of said plurality of strategies and corresponding ideal values of said plurality of positions, said objective function inducing an order relation which denotes a relationship between a set of possible asset selling or buying vectors according to their corresponding scores;
generate according to a predefined vector generation procedure one or more asset selling or buying vectors, each denoting one or more selling or buying transactions that if executed are estimated to generate or expend a total amount of cash which approximately matches said needed cash amount;
implement with respect of each generated asset selling or buying vector, a vector scoring and evaluation sequence, comprising:
calculate effects of selling or buying transactions denoted by said vector on asset holdings within said portfolio, to thereby provide an updated estimated value for said asset holdings;
compute an estimated actual value for each one of a plurality of positions recommended by at least one of said plurality of strategies, said estimated actual value for each one of said plurality of said plurality of positions is based at least on an estimated value for an asset holding associated with said position;
compute differences between said actual values of said plurality of positions and corresponding ideal values of said plurality of positions;
compute an overall score for that vector based on said predefined objective function;
determine according to said order relation whether that vector is better than any previously generated vector, and if that vector is better than any previously generated vector designate that vector and its overall score as best; and
said optimizer is adapted to determine whether a stop criterion is met, wherein in case said stop criterion is met, data related to an asset selling or buying vector designated as best is provided as output, and in case said stop criterion is not met, said optimizer is adapted to generate at least one more new asset selling or buying vector according to said predefined vector generation procedure and to repeat said vector scoring and evaluation sequence with respect to said new vector.

53. The system according to claim 52, wherein said optimizer further comprises:
an initial vector generator adapted to generate an initial asset selling or buying vector;
a repair vector generator adapted to search for an asset selling or buying vector which moderately modifies a previous asset selling or buying vector, to thereby provide an asset selling or buying vector that is better, according to said order relation, than a previous asset selling or buying vector.

54. The system according to claim 52, wherein said optimizer further comprises:
a stochastic vector generator adapted to generate an asset selling or buying vector by using at least a random number generation, said stochastic vector generator is configured to be triggered in response to said repair vector generator failing to provide an asset selling or buying vector that is better, according to said order relation, than a previous asset selling or buying vector.

55. The system according to claim 53, wherein said initial vector generator is adapted to generate a preliminary asset selling or buying vector and then to generate one or more additional vectors using iterative steps, and wherein said initial vector generator is adapted to search at each iterative step, for a set of one or more increments and/or decrements by a predefined value to one or more elements of a previously generated asset selling or buying vector, to thereby generate an asset selling or buying vector resulting from applying the a selected set of increments and/or decrements to a previously generated asset selling or buying vector; and also to determine whether a stop criteria for concluding an initialization of an asset selling or buying vector is met.

56. The system according to claim 55, wherein said stop criteria for concluding an initialization of an asset selling or buying vector includes a condition that said initial asset selling or buying vector denotes one or more selling or buying transactions that if executed generate or expend cash in an estimated total amount which approximately matches said needed cash amount.

57. The system according to claim 55, wherein said initial vector generator is adapted to select from a plurality of asset selling or buying vectors which are a result of applying a set of increments and/or decrements by a predefined value to one or more elements of a previously generated asset selling vector, that asset selling or buying vector which is best amongst said plurality of asset selling or buying vectors according to said order relation.

58. The system according to claim 53, wherein said repair vector generator is adapted to search for said asset selling or buying vector which moderately modifies a previous asset selling vector, based on incrementing one or more elements of said previous asset selling or buying vector by approximately a predefined quantity and/or decrementing one or more other elements of said asset selling or buying vector by approximately a predefined quantity.

59. The system according to claim 58, wherein said repair vector generator is adapted to select from a plurality of asset selling or buying vectors which moderately modify a previous asset selling vector, an asset selling or buying vector that is better amongst said plurality of asset selling or buying vectors according to said order relation.

60. The system according to claim 52, wherein said optimizer is adapted to compute an overall score for an asset selling or buying vector further based on an objective function that includes a measure of a volatility or variance related to differences between actual value and corresponding ideal value of positions recommended by at least one of said plurality of investment strategies, wherein said measure of a volatility or a variance is in respect of an asset selling or buying vector and is based on said updated estimated values for asset holdings calculated according to the effects of selling or buying transactions denoted by said vector.

61. The system according to claim 60, wherein said optimizer is adapted to compute an overall score for an asset selling or buying vector based on said objective function that includes a measure of a volatility or a variance, and a calculation of said objective function with respect to said asset selling or buying vector is further based upon an average of said differences between an actual value and a corresponding ideal value of said positions.

62. The system according to claim 61, wherein said objective function, that includes a measure of a volatility or a measure of variance, is based upon a totaling of a plurality of squares of distances, each one of said plurality of squares of distances is associated with a position and is calculated based upon a difference between an ideal value and a corresponding actual value of said position and said average of said differences between actual and ideal values of said positions.

63. The system according to claim 52, wherein said optimizer is adapted to compute an overall score for an asset selling or buying vector further based on an objective function that includes a measure of a degree of position imbalances related to a sum of squares or a sum of absolute values of differences between an actual value and a corresponding ideal value of positions that are associated with at least one of said plurality of investment strategies, wherein said degree of positions imbalances is calculated in respect of an asset selling or buying vector based on said updated estimated values for asset holdings calculated according to the effects of selling or buying transactions denoted by said vector.

64. The system according to claim 52, wherein said cash generating or reinvesting module is adapted to determine said needed cash amount based on a reinvestment value, and said reinvestment value is based on a totaling of a plurality of differences between an actual value and a corresponding ideal value of one or more non-cash positions that are recommended explicitly or implicitly by at least one of said plurality of investment strategies, and wherein said optimizer is adapted to generate said one or more asset buying or selling vectors, each denoting one or more asset buying or selling transactions which if executed are estimated to expend approximately said needed cash amount.

65. The system according to claim 64, wherein said reinvestment value is based on a totaling of a plurality of differences between an actual value and a corresponding ideal value of one or more non-cash positions, each of which said one or more non-cash positions has an ideal value that is greater than that position's corresponding actual value.

66. The system according to claim 52, wherein said cash generating or reinvesting module is adapted to determine said needed cash amount based on a reinvestment value, and said reinvestment value calculation is based upon a value of a cash holding within said portfolio and a totaling of one or more ideal values of one or more cash positions, each one of said one or more cash positions is recommended, explicitly or implicitly, by an investment strategy with which said portfolio is associated, and wherein said optimizer is adapted to generate one or more asset buying vectors, each one of said asset buying vectors denoting one or more asset buying transactions which if executed are estimated to expend approximately said needed cash amount.

67. The system according to claim 52, wherein said cash generating or reinvesting module is responsive to a suggested transaction or to a recommended change value that is provided in respect of one or more positions that are explicitly or implicitly recommended by at least one of said plurality of investment strategies with which said portfolio is associated, for determining said needed cash amount based on said suggested transaction or said recommended change value and further based on a value of a cash holding within said investment portfolio.

68. The system according to claim 53, wherein said stochastic vector generator is further adapted to generate said asset selling or buying vector using also one or more increments and/or decrements by a predefined value and with respect to one or more elements of a previously generated asset selling or buying vector.

69. A method of determining an optimal asset selling or buying vector in respect of assets within an investment portfolio that is associated with a plurality of investment strategies according to a predefined proportion between the strategies, and each one of the plurality investment strategies providing explicitly or implicitly a recommended relative weight with respect to cash and/or non-cash positions, said method comprising:
obtaining each one of the following:
an ideal value for each one of a plurality of positions recommended by at least one of said plurality of strategies, said ideal value is calculated based upon: a recommended relative weight for its respective position as provided explicitly or implicitly by at least one of said plurality of strategies and said predefined proportion between said plurality of strategies;
a needed cash amount for either cash generation or reinvesting;
providing an objective function for scoring an asset selling or buying vector, said objective function is sensitive to a degree by which selling or buying transactions denoted by an asset selling or buying vector affect differences between actual values of a plurality of positions recommended by at least one of said plurality of strategies and corresponding ideal values of said plurality of positions, said objective function inducing an order relation which denotes a relationship between a set of possible asset selling or buying vectors according to their corresponding scores;
generating according to a predefined vector generation procedure one or more asset selling or buying vectors, each denoting one or more selling or buying transactions that if executed are estimated to generate or expend a total amount of cash which approximately matches said needed cash amount;
implementing with respect of each generated asset selling or buying vector, a vector scoring and evaluation sequence, comprising:
calculating effects of selling or buying transactions denoted by said vector on asset holdings within said portfolio, to thereby provide an updated estimated value for said asset holdings;
computing an estimated actual value for each one of a plurality of positions recommended by at least one of said plurality of strategies, said estimated actual value for each one of said plurality of said plurality of positions is based at least on an estimated value for an asset holding associated with said position;
computing differences between said actual values of said plurality of positions and corresponding ideal values of said plurality of positions;
computing an overall score for that vector based on said predefined objective function;
determining according to said order relation whether that vector is better than any previously generated vector, and if that vector is better than any previously generated vector designate that vector and its overall score as best; and
determining whether a stop criterion is met, wherein in case said stop criterion is met, providing data related to an asset selling or buying vector designated as best as output, and in case said stop criterion is not met, generating at least one more new asset selling or buying vector according to said predefined vector generation procedure and repeating said vector scoring and evaluation sequence with respect to said new vector.

70. The method according to claim 69, wherein said implementing a vector scoring and evaluation sequence further comprises:
generating an initial asset selling or buying vector; and
searching for an asset selling or buying vector which moderately modifies a previous asset selling or buying vector, to thereby provide an asset selling or buying vector that is better, according to said order relation, than a previous asset selling or buying vector.

71. The method according to claim 70, wherein said implementing a vector scoring and evaluation sequence further comprises:
generating an asset selling or buying vector by using at least a random number generation, said stochastic vector generator is configured to be triggered in response to said searching for an asset selling or buying vector which moderately modifies a previous asset selling or buying vector failing to provide an asset selling or buying vector that is better, according to said order relation, than a previous asset selling or buying vector.

72. The method according to claim 70, wherein said generating an initial asset selling or buying vector further comprises:
generating a preliminary asset selling or buying vector and then to generating one or more additional vectors using iterative steps; and
searching at each iterative step for a set of one or more increments and/or decrements by a predefined value to one or more elements of a previously generated asset selling or buying vector, for thereby generating an asset selling or buying vector resulting from applying a selected set of increments and/or decrements to a previously generated asset selling or buying vector.

73. The method according to claim 72, wherein said determining whether a stop criterion is met, further comprises implementing a condition that said initial asset selling or buying vector denotes one or more selling or buying transactions that if executed generate or expend cash in an estimated total amount which approximately matches said needed cash amount.

74. The method according to claim 72, wherein generating a preliminary asset selling or buying vector, further comprises selecting from a plurality of asset selling or buying vectors which are a result of applying a set of increments and/or decrements by a predefined value to one or more elements of a previously generated asset selling vector, that asset selling or buying vector which is best amongst said plurality of asset selling or buying vectors, according to said order relation.

75. The method according to claim 70, where said searching for an asset selling or buying vector, further comprises searching for said asset selling or buying vector which moderately modifies a previous asset selling vector based on incrementing one or more elements of said previous asset selling or buying vector by approximately a predefined quantity and/or decrementing one or more other elements of said asset selling or buying vector by approximately a predefined quantity.

76. The method according to claim 75, further comprising selecting from a plurality of asset selling or buying vectors which moderately modify a previous asset selling vector an asset selling or buying vector that is better amongst said plurality of asset selling or buying vectors according to said order relation.

77. The method according to claim 69, wherein said computing an overall score, further comprises computing an overall score for an asset selling or buying vector based on an objective function that includes a measure of a volatility or variance related to differences between an actual value and a corresponding ideal value of positions recommended by at least one of said plurality of investment strategies, wherein said measure of a volatility or a variance is in respect of an asset selling or buying vector and is based on said updated estimated values for asset holdings calculated according to the effects of selling or buying transactions denoted by said vector.

78. The method according to claim 77, wherein said computing an overall score for an asset selling or buying vector based on an objective function, further comprises calculating said objective function based on a measure of a volatility or a variance, and further based upon an average of said differences between an actual value and a corresponding ideal value of said positions.

79. The method according to claim 78, wherein said computing an overall score for an asset selling or buying vector based on an objective function, further comprises totaling a plurality of squares of distances, each one of said plurality of squares of distances is associated with a position and is calculated based upon a difference between an ideal value and a corresponding actual value of said position and said average of said differences between actual and ideal values of said positions.

80. The method according to claim 69, wherein said computing an overall score, further comprises computing an overall score for an asset selling or buying vector further based on an objective function that includes a measure of a degree of position imbalances related to a sum of squares or a sum of absolute values of differences between an actual value and a corresponding ideal value of positions that are associated with at least one of said plurality of investment strategies, wherein computing an overall score for an asset selling or buying vector is further based on said updated estimated values for asset holdings calculated according to the effects of selling or buying transactions denoted by said vector.

81. The method according to claim 69, wherein said obtaining further comprises:
totaling of a plurality of differences between an actual value and a corresponding ideal value of one or more non-cash positions that are recommended explicitly or implicitly by at least one of said plurality of investment strategies giving rise to a reinvestment value;
determining said needed cash amount further based on said reinvestment value, and wherein
said generating one or more asset selling or buying vectors, further comprises generating according to a predefined vector generation procedure one or more asset selling or buying vectors, each de noting one or more selling or buying transactions that if executed are estimated to expend a total amount of cash which approximately matches said needed cash amount.

82. The method according to claim 81, wherein said totaling, further comprises totaling of a plurality of differences between an actual value and a corresponding ideal value of one or more non-cash positions, each of which said one or more non-cash positions has an ideal value that is greater than that position's corresponding actual value.

83. The method according to claim 69, wherein said obtaining further comprises:
calculating a reinvestment value based upon a value of a cash holding within said portfolio and a totaling of one or more ideal values of one or more cash positions, each one of said one or more cash positions is recommended, explicitly or implicitly, by an investment strategy with which said portfolio is associated;
determining said needed cash amount further based on said reinvestment value, and wherein,
said generating one or more asset selling or buying vectors, further comprises generating one or more asset buying vectors, each one of said asset buying vectors denoting one or more asset buying transactions which if executed are estimated to expend approximately said needed cash amount.

84. The method according to claim 69, further comprising:
detecting a suggested transaction or a recommended change value that is provided in respect of one or more positions that are explicitly or implicitly recommended by at least one of said plurality of investment strategies with which said portfolio is associated; and
in response to detecting said suggested transaction or said recommended change value, determining said needed cash amount based on said suggested transaction or said recommended change value and further based on a value of a cash holding within said investment portfolio.

85. The method according to claim 71, wherein said generating an asset selling or buying vector by using at least a random number generation, further comprises generating said asset selling or buying vector using also one or more increments and/or decrements by a predefined value and with respect to one or more elements of a previously generated asset selling or buying vector.

86. A program storage device readable by machine, tangibly embodying a program of instructions executable by the machine to perform a method of determining an optimal asset selling or buying vector in respect of assets within an investment portfolio that is associated with a plurality of investment strategies according to a predefined proportion between the strategies, and each one of the plurality investment strategies providing explicitly or implicitly a recommended relative weight with respect to cash and/or non-cash positions, said method comprising:
obtaining each one of the following:
an ideal value for each one of a plurality of positions recommended by at least one of said plurality of strategies, said ideal value is calculated based upon: a recommended relative weight for its respective position as provided explicitly or implicitly by at least one of said plurality of strategies and said predefined proportion between said plurality of strategies;
a needed cash amount for either cash generation or reinvesting;
providing an objective function for scoring an asset selling or buying vector, said objective function is sensitive to a degree by which selling or buying transactions denoted by an asset selling or buying vector affect differences between actual values of a plurality of positions recommended by at least one of said plurality of strategies and corresponding ideal values of said plurality of positions, said objective function inducing an order relation which denotes a relationship between a set of possible asset selling or buying vectors according to their corresponding scores;
generating according to a predefined vector generation procedure one or more asset selling or buying vectors, each denoting one or more selling or buying transactions that if executed are estimated to generate or expend a total amount of cash which approximately matches said needed cash amount;
implementing with respect of each generated asset selling or buying vector, a vector scoring and evaluation sequence, comprising:
calculating effects of selling or buying transactions denoted by said vector on asset holdings within said portfolio, to thereby provide an updated estimated value for said asset holdings;
computing an estimated actual value for each one of a plurality of positions recommended by at least one of said plurality of strategies, said estimated actual value for each one of said plurality of said plurality of positions is based at least on an estimated value for an asset holding associated with said position;
computing differences between said actual values of said plurality of positions and corresponding ideal values of said plurality of positions;
computing an overall score for that vector based on said predefined objective function;
determining according to said order relation whether that vector is better than any previously generated vector, and if that vector is better than any previously generated vector designate that vector and its overall score as best; and
determining whether a stop criterion is met, wherein in case said stop criterion is met, providing data related to an asset selling or buying vector designated as best as output, and in case said stop criterion is not met, generating at least one more new asset selling or buying vector according to said predefined vector generation procedure and repeating said vector scoring and evaluation sequence with respect to said new vector.

87. A computer program product comprising a computer useable medium having computer readable program code embodied therein of determining an optimal asset selling or buying vector in respect of assets within an investment portfolio that is associated with a plurality of investment strategies according to a predefined proportion between the strategies, and each one of the plurality investment strategies providing explicitly or implicitly a recommended relative weight with respect to cash and/or non-cash positions, said computer program product comprising:
computer readable program code for causing the computer to obtain each one of the following:
an ideal value for each one of a plurality of positions recommended by at least one of said plurality of strategies, said ideal value is calculated based upon: a recommended relative weight for its respective position as provided explicitly or implicitly by at least one of said plurality of strategies and said predefined proportion between said plurality of strategies;
a needed cash amount for either cash generation or reinvesting;
computer readable program code for causing the computer to provide an objective function for scoring an asset selling or buying vector, said objective function is sensitive to a degree by which selling or buying transactions denoted by an asset selling or buying vector affect differences between actual values of a plurality of positions recommended by at least one of said plurality of strategies and corresponding ideal values of said plurality of positions, said objective function inducing an order relation which denotes a relationship between a set of possible asset selling or buying vectors according to their corresponding scores;
computer readable program code for causing the computer to generate according to a predefined vector generation procedure one or more asset selling or buying vectors, each denoting one or more selling or buying transactions that if executed are estimated to generate or expend a total amount of cash which approximately matches said needed cash amount;
computer readable program code for causing the computer to implement with respect of each generated asset selling or buying vector, a vector scoring and evaluation sequence, comprising:
computer readable program code for causing the computer to calculate effects of selling or buying transactions denoted by said vector on asset holdings within said portfolio, to thereby provide an updated estimated value for said asset holdings;
computer readable program code for causing the computer to compute an estimated actual value for each one of a plurality of positions recommended by at least one of said plurality of strategies, said estimated actual value for each one of said plurality of said plurality of positions is based at least on an estimated value for an asset holding associated with said position;
computer readable program code for causing the computer to compute differences between said actual values of said plurality of positions and corresponding ideal values of said plurality of positions;
computer readable program code for causing the computer to compute an overall score for that vector based on said predefined objective function;
computer readable program code for causing the computer to determine according to said order relation whether that vector is better than any previously generated vector, and if that vector is better than any previously generated vector designate that vector and its overall score as best; and
computer readable program code for causing the computer to determine whether a stop criterion is met, wherein in case said stop criterion is met, providing data related to an asset selling or buying vector designated as best as output, and in case said stop criterion is not met, generating at least one more new asset selling or buying vector according to said predefined vector generation procedure and repeating said vector scoring and evaluation sequence with respect to said new vector.
